(19) United States
(12) Patent Application Publication
(10) Pub. No.: US 2024/0153016 A1
(43) Pub. Date: May 9, 2024

(54) MEMORIES BASED SYSTEM AND METHOD OF USE

(71) Applicant: FLUXUS, LLC, Oakton, VA (US)

(72) Inventor: Walter Edward GAWLAK, Oakton, VA (US)

(21) Appl. No.: 18/349,802

(22) Filed: Jul. 10, 2023

Related U.S. Application Data
(60) Provisional application No. 63/385,735, filed on Dec. 1, 2022.
(60) Provisional application No. 63/388,078, filed on Jul. 11, 2022.

(51) Int. Cl. G06Q 50/00

(52) U.S. Cl. CPC G06Q 50/01

(57) ABSTRACT

A memory based system and method relating to the improvement of human memory and communication and/or organization of life experiences through a software Timeline interface and accompanying user related profile, along with features providing the ability to selectively share and communicate information with other users. The system and method include organizing, storing, and/or enhancing memories for a user, including providing a plurality of views or selections of memory related content, wherein the plurality of views or selections includes a Timeline based view and a selection to add new content. The Timeline and memory-based components offer an automated process for prompting and/or correcting date related information that assists in the automatic or user positioning of added content relative to existing content based on date. The system and method thereby provide multiple features to improve user memory and cognitive order of events, as well as general organization of a Timeline.

This application claims priority to Applicant's co-pending U.S. Provisional Patent Application No. 63/388,078 titled “Memories Based System and Method of Use” filed Jul. 11, 2022, and claims priority to Applicant's co-pending U.S. Provisional Patent Application No. 63/385,735 titled “Memories Based System and Method of Use” filed Dec. 1, 2022, the entire contents of each of which are hereby incorporated herein by reference.

### FIELD OF DISCLOSURE

Aspects of the present disclosure relate to the improving of human memory and communication of life experiences through the creation of a personal website Timeline and accompanying profile.

### BACKGROUND AND SUMMARY

The world is filled with many important connections among all forms of life, human beings at the core of them all. True emotional connection is fostered with healthy introspection, which can be accentuated with journaling, note taking, and other means of self-exploration. Understanding oneself, and what we go through, allows for communication from a place of honesty, only made more possible with social media platforms. Unfortunately, not all demographics take reflection seriously, while other demographics do not grasp assisting technology, leaving a divergence of optimal modern connection. Important memories may be further buried, or lost, when connection platforms focus on the moment and not on the other 99% of time making us who we are. There remains an unmet need for a technological platform that allows introspective focus and fostering of lifelong representation, among other things, while bridging demographics through the documentation and sharing of all or many forms of memories.

One initial issue with existing online platforms is their focus on the “now,” epitomized through functions like in-the-moment status updates and “Stories,” on network-based places like Facebook or Instagram. Seemingly, the purpose of these aforementioned functions is to get as close to seeing each user in the moment as possible, as frequently content disappears after a period of time. However, an issue with sharing in-the-moment focused content is that this approach may discourage sharing anything that is not presently applicable, like valued memories, experiences, or thoughts that led us up to the “now.” The value of sharing the past, often catalogued through scattered files, like pictures, notes, journals, etc., is often lost on younger individuals frequenting social media. Younger users online are more likely to chase acclamation in the moment, rather than build a place of lasting value, as the focus on “likes” and elicited responses define modern platforms. The accumulation of moments shared for others, as opposed to the ultimate fulfilment of oneself, does not equate to an environment focused on overarching representation. These moments, however, can lend to sustained representation if brought into a place properly designed to assimilate such content, even where an optimal location does not currently exist.

When individuals are thinking of valued events they have been through, regardless of scope, they frequently are not thinking linearly or in a precise manner regarding the time component. In existing systems, for example, if an online user chooses to share a valued memory to catalogue, the user may have to share it for today and may be unable to place it on a true Timeline of their lives without technological hardship. Memory often comes with no concrete criteria, as one may only remember something like the weather, leading them to a season. There is not a Timeline platform in the existing art for sharing content that allows the user to input any date-related criteria they can think of, including simply text if they cannot think of anything at all.

In accordance, for example, with aspects of the present disclosure, with such features as a Timeline of loose date-criteria for memories, over time the dates in theory may be improved, helping with the memory and focus of the user and their Timeline. Improving the approximation of dates on a Timeline may encourage the creation of more memory content, expanding the utility exponentially over time. This discussed utility may improve with the connection of users online, filling in gaps of knowledge.

To address these needs as well as others, a platform along the lines of the present disclosure is needed to catalogue and refine memories on a Timeline, assisting users in connecting over content shared with themselves, or others. With a Timeline that encourages memory-sharing from start to finish, older and younger users can coalesce to help educate older users on technology, while also educating younger users on the value of introspective cataloging.

Aspects of the present disclosure address the above needs, as well as others, by providing a platform for, among other things, providing an interactive multimedia Timeline of memories, allowing for material content from any timeframe with any type of date information. Aspects of the present disclosure focus on building a Timeline (with automated and other assistance tools) and accompanying profile that, among other benefits, assists in the improvement of memories collected and overarching building and maintaining memory of events shared on the platform. With a platform to share true introspective experiences, or some or all the important memories regardless of scope or size, users may thereby be drawn closer to understanding themselves and others.

When recollecting meaningful moments or experiences, it is often rare to remember more than the year such moments or experiences occurred, if even that. Due to the inability to recall relevant date information, aspects of the present disclosure allow for entry of any suitable type of remembered date-criteria when creating a memories entry. Aforementioned date information may include, for example, any of the day, month, and year, or a season instead. It is noted that date-criteria within a system in accordance with the present disclosure may be capable of including a text section for content where users do not recollect a year, such as “Childhood” or “High School.” Users may optionally position memories (e.g., graphically or representatively) amongst previously-created ones, assisting in the chronology of life events. When relative positions of such memories are determined, automatically or otherwise, approximated dates may be placed on or otherwise associated with memories, helping the user hone-in on more likely dates of memories and improving user introspective understanding.

One example feature, in accordance with aspects of the present disclosure, referred to as “Creating a Timeline,” may include input of memory content working back until birth that includes a profile that also updates accordingly. Aspects of the present disclosure may offer a profile with many facets for representing the user, including but not limited to, multiple pictures and text descriptions. Users may include in or associate a picture or text-snippet with a section of their Timeline, to appear alongside memories, representing their thoughts and appearance overarchingly, for example. Since no one is able to provide actual memories for another, features may include sharing commentary about user Timelines to assist in clarifying memory and time frames.

When an entity such as an animal, location, or song appears across multiple memories, it may be identified and also appear in the profile of a Timeline, demonstrating the range of its appearance over the course of a user's life. From the profile, a user may open and view just the content corresponding to the selected entity, for example, showing a better image of how this content overlaps the corresponding Timeline.

Among other benefits, the usability of loose date-criteria, along with the inclusion of an adapting profile, may allow users the ability to build an entire introspective and connected view of themselves online. With the proper representation of individuals, users may view each other's content in respective newsfeeds of memories, accessible to each unique user, for example. The sharing of content through newsfeeds and sought-out connection may help improve the gaps of knowledge in a user's personal experiences with such a system.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

In the drawings:

FIG. 1a presents a first portion of three portions of a representative flow diagram of user access and interaction options for an example system, in accordance with aspects of the present disclosure.

FIG. 1B presents a second portion of the representative flow diagram of FIGS. 1a-1c.

FIG. 1c presents a third portion of the representative flow diagram of FIGS. 1a-1c.

FIG. 2 presents a sample login screen where the user must enter information for logging in, in accordance with the present disclosure.

FIG. 3 displays an example graphical user interface (GUI) login screen wherein a new user may input relevant identifying information, in accordance with aspects of the present disclosure.

FIG. 4 presents an example User Hub GUI screen for use by a user to access other selectable items, in accordance with aspects of the present disclosure.

FIG. 5 presents an example User Hub GUI screen containing two connected Social Media sites, in accordance with aspects of the present disclosure.

FIG. 6 presents a sample Notification module, displaying example Notifications for the accessing user, in accordance with aspects of the present disclosure.

FIG. 7 shows an example Settings module GUI screen, in accordance with aspects of the present disclosure.

FIG. 8a presents a first portion of two portions of a representative flow diagram of the Memory creation process, allowing the user to create a new Memory for their Timeline, in accordance with aspects of the present disclosure.

FIG. 8b presents a second portion of the representative flow diagram of FIGS. 8a-8b.

FIG. 9 presents an example Memory Creation module GUI screen, in accordance with aspects of the present disclosure.

FIG. 10 depicts a sample Memory Creation module GUI screen after an example picture is added, in accordance with aspects of the present disclosure.

FIG. 11 shows an example Memory Creation module GUI screen, with an added packaged URL preview as content, in accordance with aspects of the present disclosure.

FIG. 12 presents a sample Memory Creation module GUI screen with Tags open for interaction, in accordance with aspects of the present disclosure.

FIG. 13 presents an example Memory Collection submodule GUI screen, set to the creation of a new Bio, in accordance with aspects of the present disclosure.

FIG. 14 shows an example GUI screen including an example Memory Creation module with the Privacy menu displayed, in accordance with aspects of the present disclosure.

FIG. 15 presents a sample Timeline page GUI screen with a new post aligned to be positioned on Timeline after date selection is finalized, in accordance with aspects of the present disclosure.

FIG. 16 presents a representative flow diagram of Progressive Profile interactions, including creation of content, in accordance with aspects of the present disclosure.

FIG. 17 depicts a sample GUI Timeline page with an example where Progressive Profile content may be displayed, in accordance with aspects of the present disclosure.

FIG. 18 depicts an example GUI Expanded Progressive Profile, in accordance with aspects of the present disclosure.

FIG. 19 depicts an example Profile Creation module GUI screen, set to the Profile Picture section, in accordance with aspects of the present disclosure.

FIG. 20a presents a first portion of three portions of a representative flow diagram of example page interactions within an example system, in accordance with aspects of the present disclosure.

FIG. 20b presents a second portion of the representative flow diagram of FIGS. 20a-20c.

FIG. 20c presents a third portion of the representative flow diagram of FIGS. 20a-20c.

FIG. 21 depicts a sample Timeline page GUI screen, accessed by a visiting user, in accordance with aspects of the present disclosure.

FIG. 22 depicts an example GUI Friends module, opened from a Timeline, for example, while the accessing user owns the viewed Timeline, in accordance with aspects of the present disclosure.

FIG. 23 depicts an example GUI screen containing a Memory Chest page, for example, opened by selecting the Memory Chest button of a corresponding Timeline origin page pictured in FIG. 17, in accordance with aspects of the present disclosure.

FIG. 24 depicts an example Bio page GUI screen maintained within the Memory Chest of an accessed Timeline, in accordance with aspects of the present disclosure.

FIG. 25 depicts an example GUI Media Page, viewed by the owner, for example, as maintained in the Memory Chest of the corresponding user's Timeline, in accordance with aspects of the present disclosure.

FIG. 26 depicts a sample Newsfeed page GUI screen, for example, as accessed by an owning user, in accordance with aspects of the present disclosure.

FIG. 27a presents a first portion of two portions of a representative flow diagram of post interactions within an example system, including Standard View and Expanded View posts, in accordance with aspects of the present disclosure.

FIG. 27b presents a second portion of the representative flow diagram of FIGS. 27a-27b.

FIGS. 28-29 depict GUI screens representing interactions with posts throughout one or more interfaces, in accordance with aspects of the present disclosure.

FIG. 30 contains a representative diagram of an example computer system capable of carrying out various functionality described in example implementations of an example fluid delivery device, in accordance with aspects of the present disclosure.

FIG. 31 is a block diagram of various example system components, capable of being used in along the lines as described in example implementations, in accordance with aspects of the present disclosure.

FIG. 32 presents a representative flow diagram of a sample date creation, positioning, and further metadata refinement within an example system, in accordance with aspects of the present disclosure.

FIG. 33 presents a representative flow diagram of sample date selection options in an example system, in accordance with aspects of the present disclosure.

FIG. 34a presents a first portion of two portions of a representative flow diagram of sample user date entry options in an example system, in accordance with aspects of the present disclosure.

FIG. 34b presents a second portion of the representative flow diagram of FIGS. 34a-34b.

FIG. 35a presents a first portion of two portions of a representative flow diagram of a date approximation system with Timeline connected capabilities, implemented in accordance with aspects of the present disclosure.

FIG. 35b presents a second portion of the representative flow diagram of FIGS. 35a-35b.

FIG. 36a presents a first portion of two portions of a representative flow diagram of Potential Estimated Date Parameters creation, defining the range in which an approximated date can be placed, or furthering a system that can, in accordance with aspects of the present disclosure.

FIG. 36b presents a second portion of the representative flow diagram of FIGS. 36a-36b.

FIG. 37 presents a representative flow diagram of an example date variation of Potential Estimated Date Parameter creation, in accordance with aspects of the present disclosure, wherein the sample post has a year and month as date-criteria.

FIG. 38a presents a first portion of four portions of a representative flow diagram of further data creation, where Potential Date Range Parameters are created, defining a unique potential range in which an approximated date can be placed for Date Range posts, or furthering a system that can, in accordance with aspects of the present disclosure.

FIG. 38b presents a second portion of the representative flow diagram of FIGS. 38a-38d.

FIG. 38c presents a third portion of the representative flow diagram of FIGS. 38a-38d.

FIG. 38d presents a fourth portion of the representative flow diagram of FIGS. 38a-38d.

FIG. 39a presents a first portion of two portions of a representative flow diagram of an example date variation of Potential Date Range Parameter creation, in accordance with aspects of the present disclosure, wherein the sample post has a month and year Start Parameter ranging to a month and Section (no year) End Parameter as date-criteria.

FIG. 39b presents a second portion of the representative flow diagram of FIGS. 39a-39b.

FIG. 40a presents a first portion of three portions of a representative flow diagram of a positioning system for posts on a Timeline of the presented implementation of systems, in accordance with aspects of the present disclosure.

FIG. 40b presents a second portion of the representative flow diagram of FIGS. 40a-40c.

FIG. 40c presents a third portion of the representative flow diagram of FIGS. 40a-40c.

FIG. 41a presents a first portion of three portions of a representative flow diagram of a user positioning system for posts on a Timeline of the presented implementation of systems, wherein certain positions will be permitted or blocked, in accordance with aspects of the present disclosure.

FIG. 41b presents a second portion of the representative flow diagram of FIGS. 41a-41c.

FIG. 41c presents a third portion of the representative flow diagram of FIGS. 41a-41c.

FIG. 42a presents a first portion of three portions of a representative flow diagram of an example date variation user positioning system, for example, continued from a previous system like FIGS. 41a-41c, in accordance with aspects of the present disclosure, wherein the sample date variation of the post during positioning includes a year as example date-criteria, wherein a plurality of date-criteria is permitted in user positioning systems of the present disclosure.

FIG. 42b presents a second portion of the representative flow diagram of FIGS. 42a-42c.

FIG. 42c presents a third portion of the representative flow diagram of FIGS. 42a-42c.

FIG. 43a presents a first portion of nine portions of a representative flow diagram of an example date variation user positioning system, for example, continued from a previous system, such as the one outlined in FIGS. 42a-42c, in accordance with aspects of the present disclosure, wherein in the presented implementation, this representative flow diagram may set dates, checkpoints, notations, or particularly use the Timeline Start Date (or user birthdate) to assist in the positioning process.

FIG. 43b presents a second portion of the representative flow diagram of FIGS. 43a-43i.

FIG. 43c presents a third portion of the representative flow diagram of FIGS. 43a-43i.

FIG. 43d presents a fourth portion of the representative flow diagram of FIGS. 43a-43i.

FIG. 43e presents a fifth portion of the representative flow diagram of FIGS. 43a-43i.

FIG. 43f presents a sixth portion of the representative flow diagram of FIGS. 43a-43i.

FIG. 43g presents a seventh portion of the representative flow diagram of FIGS. 43a-43i.

FIG. 43h presents an eighth portion of the representative flow diagram of FIGS. 43a-43i.

FIG. 43i presents a ninth portion of the representative flow diagram of FIGS. 43a-43i.

FIG. 44a presents a first portion of twelve portions of a representative flow diagram of an example date variation user positioning system, for example, continued from a previous system, such as the one outlined in FIGS. 42a-42c, in accordance with aspects of the present disclosure, wherein in the presented implementation, this representative flow diagram may set dates, checkpoints, notations, or particularly use older-positioned post dates to assist in the positioning process.

FIG. 44b presents a second portion of the representative flow diagram of FIGS. 44a-44l.

FIG. 44c presents a third portion of the representative flow diagram of FIGS. 44a-44l.

FIG. 44d presents a fourth portion of the representative flow diagram of FIGS. 44a-44l.

FIG. 44e presents a fifth portion of the representative flow diagram of FIGS. 44a-44l.

FIG. 44f presents a sixth portion of the representative flow diagram of FIGS. 44a-44l.

FIG. 44g presents a seventh portion of the representative flow diagram of FIGS. 44a-44l.

FIG. 44h presents an eighth portion of the representative flow diagram of FIGS. 44a-44l.

FIG. 44i presents a ninth portion of the representative flow diagram of FIGS. 44a-44l.

FIG. 44j presents a tenth portion of the representative flow diagram of FIGS. 44a-44l.

FIG. 44k presents an eleventh portion of the representative flow diagram of FIGS. 44a-44l.

FIG. 44l presents a twelfth portion of the representative flow diagram of FIGS. 44a-44l.

FIG. 45a presents a first portion of ten portions of a representative flow diagram of an example date variation user positioning system, for example, continued from a previous system, such as the one outlined in FIGS. 42a-42c or FIGS. 43a-43i, in accordance with aspects of the present disclosure, wherein in the presented implementation, this representative flow diagram may set dates, checkpoints, notations, or particularly use newer-positioned post dates to assist in the positioning process.

FIG. 45b presents a second portion of the representative flow diagram of FIGS. 45a-45j.

FIG. 45c presents a third portion of the representative flow diagram of FIGS. 45a-45j.

FIG. 45d presents a fourth portion of the representative flow diagram of FIGS. 45a-45j.

FIG. 45e presents a fifth portion of the representative flow diagram of FIGS. 45a-45j.

FIG. 45f presents a sixth portion of the representative flow diagram of FIGS. 45a-45j.

FIG. 45g presents a seventh portion of the representative flow diagram of FIGS. 45a-45j.

FIG. 45h presents an eighth portion of the representative flow diagram of FIGS. 45a-45j.

FIG. 45i presents a ninth portion of the representative flow diagram of FIGS. 45a-45j.

FIG. 45j presents a tenth portion of the representative flow diagram of FIGS. 45a-45j.

FIG. 46a presents a first portion of seven portions of a representative flow diagram of an example date variation user positioning system, for example, continued from a previous system, such as the one outlined in FIGS. 43a-43i or FIGS. 44a-44l, in accordance with aspects of the present disclosure, wherein, in the presented implementation, this representative flow diagram may set dates, checkpoints, notations, or particularly use Timeline End Date (or Today's date of access) to assist in the positioning process.

FIG. 46b presents a second portion of the representative flow diagram of FIGS. 46a-46g.

FIG. 46c presents a third portion of the representative flow diagram of FIGS. 46a-46g.

FIG. 46d presents a fourth portion of the representative flow diagram of FIGS. 46a-46g.

FIG. 46e presents a fifth portion of the representative flow diagram of FIGS. 46a-46g.

FIG. 46f presents a sixth portion of the representative flow diagram of FIGS. 46a-46g.

FIG. 46g presents a seventh portion of the representative flow diagram of FIGS. 46a-46g.

FIG. 47a presents a first portion of two portions of a representative flow diagram of an example post position check system, for example, continued from a previous positioning system such as FIGS. 42a-42c, FIGS. 43a-43i, or FIGS. 44a-44l, in accordance with aspects of the present disclosure, wherein this system may permit the viability of a post position as implemented in the example system.

FIG. 47b presents a second portion of the representative flow diagram of FIGS. 47a-47b.

FIG. 48a presents a first portion of two portions of a representative flow diagram of an example post position check system, for example, continued from a previous positioning system such as FIGS. 42a-42c, in accordance with aspects of the present disclosure, wherein this system may permit the viability of a post position as implemented in the example system.

FIG. 48b presents a second portion of the representative flow diagram of FIGS. 48a-48b.

FIG. 49 presents a representative flow diagram of an example user positioning system where data is created to assist in the user positioning validation process for Timeline, for example, the creation of a date that helps define the earlier side of a possible range of date for the post position, in accordance with aspects of the present disclosure.

FIG. 50 presents a representative flow diagram of an example user positioning system where data is created to assist in the user positioning validation process for Timeline, for example, the creation of a date that helps define the later side of a possible range of date for the post position, in accordance with aspects of the present disclosure.

FIG. 51a presents a first portion of five portions of a representative flow diagram of an example system for checking the validity of data created on Timeline posts of the presented implementation, in accordance with aspects of the present disclosure, wherein this representative flow diagram outlines, for example, the replacement of metadata on improper or invalid posts on Timeline.

FIG. 51b presents a second portion of the representative flow diagram of FIGS. 51a-51e.

FIG. 51c presents a third portion of the representative flow diagram of FIGS. 51a-51e.

FIG. 51d presents a fourth portion of the representative flow diagram of FIGS. 51a-51e.

FIG. 51e presents a fifth portion of the representative flow diagram of FIGS. 51a-51e.

FIG. 52a presents a first portion of two portions of a representative flow diagram of an example system that sets an approximated date for a post, or continues to a system that is able to carry out this functionality, in accordance with aspects of the present disclosure.

FIG. 52b presents a second portion of the representative flow diagram of FIGS. 52a-52b.

FIG. 53a presents a first portion or three portions of a representative flow diagram of an example system that sets an approximated date for a post with a particular date variation, wherein this particular example post has a year of a plurality of date options, in accordance with aspects of the present disclosure, wherein this representative flow diagram continues from an assignment system, for example, represented in FIGS. 52a-52b of the present disclosure.

FIG. 53b presents a second portion of the representative flow diagram of FIGS. 53a-53c.

FIG. 53c presents a third portion of the representative flow diagram of FIGS. 53a-53c.

FIG. 54a presents a first portion of six portions of a representative flow diagram of an example system that sets an approximated date for a post with a particular date variation, wherein this particular example post has a month (no year) of a plurality of date options, in accordance with aspects of the present disclosure, wherein this representative flow diagram continues from an assignment system, for example, represented in FIGS. 52a-52b of the present disclosure.

FIG. 54b presents a second portion of the representative flow diagram of FIGS. 54a-54f.

FIG. 54c presents a third portion of the representative flow diagram of FIGS. 54a-54f.

FIG. 54d presents a fourth portion of the representative flow diagram of FIGS. 54a-54f.

FIG. 54e presents a fifth portion of the representative flow diagram of FIGS. 54a-54f.

FIG. 54f presents a sixth portion of the representative flow diagram of FIGS. 54a-54f.

FIG. 55 presents a representative flow diagram of an example system that sets an approximated date for a post that has a Date Range as date-criteria, or continues to a system that is able to carry out this functionality, in accordance with aspects of the present disclosure.

FIG. 56a presents a first portion of two portions of a representative flow diagram of an example system that sets an approximated date for a post with a particular Date Range variation, wherein this particular example post has a full date to a month with no year, in accordance with aspects of the present disclosure, wherein this representative flow diagram continues from an assignment system, for example, such as the one in FIG. 55 of the present disclosure.

FIG. 56b presents a second portion of the representative flow diagram of FIGS. 56a-56b.

FIG. 57a presents a first portion of three portions of a representative flow diagram of a sample date variation system that sets an approximated date for a Date Range post with a Section included in date-criteria, for example, altering placement of the approximated date based on post, Timeline, and other metadata factors, in accordance with aspects of the present disclosure.

FIG. 57b presents a second portion of the representative flow diagram of FIGS. 57a-57c.

FIG. 57c presents a third portion of the representative flow diagram of FIGS. 57a-57c.

FIG. 58a presents a first portion of two portions of a representative flow diagram of an example system that sets an approximated date for a post with a particular Date Range variation, wherein this particular example post has a full date to a month and year, in accordance with aspects of the present disclosure, wherein this representative flow diagram continues from an assignment system, for example, such as the one in FIG. 55 of the present disclosure.

FIG. 58b presents a second portion of the representative flow diagram of FIGS. 58a-58b.

FIG. 59 presents a representative flow diagram of an example system that ensures a post does not have an approximated date outside of its potential date range, in accordance with aspects of the present disclosure.

FIG. 60 presents a representative flow diagram of an example system that checks to ensure a post does not have an approximated date outside of its corresponding Timeline Start to End Date parameters, in accordance with aspects of the present disclosure.

FIG. 61a presents a first portion of four portions of a representative flow diagram of an example system that organizes posts on Timeline, wherein it is likely that approximated dates of posts will be redistributed, repositioned, or redetermined based on post proximity and relation, in accordance with aspects of the present disclosure.

FIG. 61b presents a second portion of the representative flow diagram of FIGS. 61a-61d.

FIG. 61c presents a third portion of the representative flow diagram of FIGS. 61a-61d.

FIG. 61d presents a fourth portion of the representative flow diagram of FIGS. 61a-61d.

FIG. 62a presents a first portion of two portions of a representative flow diagram of an example system that may assist the organization of posts of a separate system, such as FIGS. 61a-61d, for example, through the approval or disproval of individuals post reorganization based on approximated dates and other related data, in accordance with aspects of the present disclosure.

FIG. 62b presents a second portion of the representative flow diagram of FIGS. 62a-62b.

FIG. 63a presents a first portion of two portions of a representative flow diagram of an example system that may assist in the grouping of posts with text Sections in place of years based on the similarity of Sections, or other relevant metadata, for example, in accordance with aspects of the present disclosure.

FIG. 63b presents a second portion of the representative flow diagram of FIGS. 63a-63b.

FIG. 64a presents a first portion of two portions of a representative flow diagram of an example system that creates or updates metadata on Timeline posts, for example, to facilitate the creation of Profile content sections or ranges of dates for content section creation thereafter, in accordance with aspects of the present disclosure.

FIG. 64b presents a second portion of the representative flow diagram of FIGS. 64a-64b.

FIG. 65a presents a first portion of two portions of a representative flow diagram of an example system that creates or updates Profile content sections on Timeline, in accordance with aspects of the present disclosure.

FIG. 65b presents a second portion of the representative flow diagram of FIGS. 65a-65b.

FIG. 66 presents a key intended to describe, but not limit, the intended function and application of systems components in accordance with aspects of the present disclosure, wherein the referenced components may include an abbreviation or flow diagram box.

### DETAILED DESCRIPTION

The detailed description set forth below in connection with the appended drawings is intended as a description of various example configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

Throughout the disclosure, the term “approximately” may be used as a modifier for a geometric relationship among elements or for the shape of an element or component. While the term approximately is not limited to a specific variation and may cover any variation that is understood by one of ordinary skill in the art to be an acceptable variation, some examples are provided as follows. In one example, the terms approximately may include a variation of less than 10% of the dimension of the object or component. In another example, the term approximately may include a variation of less than 5% of the object or component. If the term approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the system and apparatus described herein are installed in an in-use orientation. In order to provide context to the current disclosure, a broad overview of the discovered deficiencies of various systems and an example implementation of the current disclosure and the advantages provided by the disclosure are described below. Further details of example implementations of the current disclosure are described in detail with reference to the figures below.

### Example Website Overview

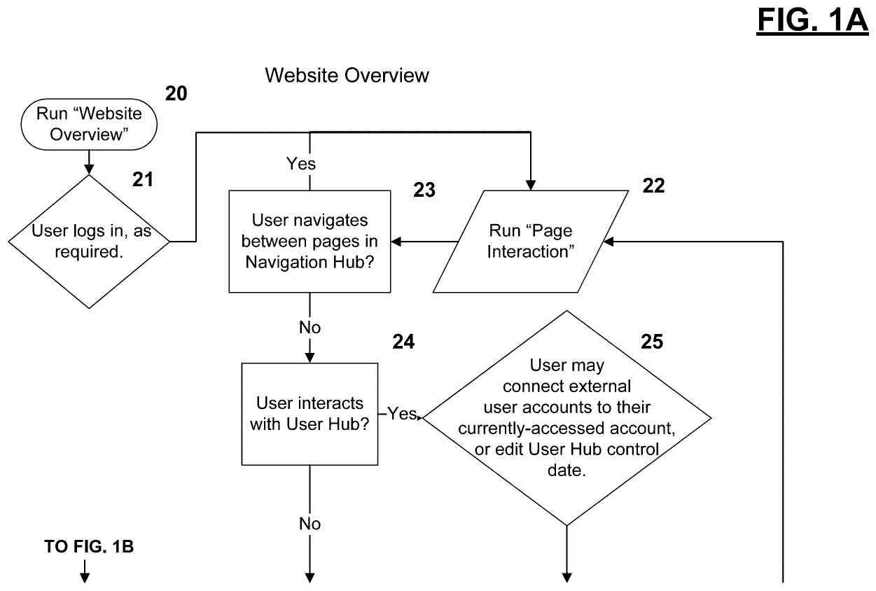

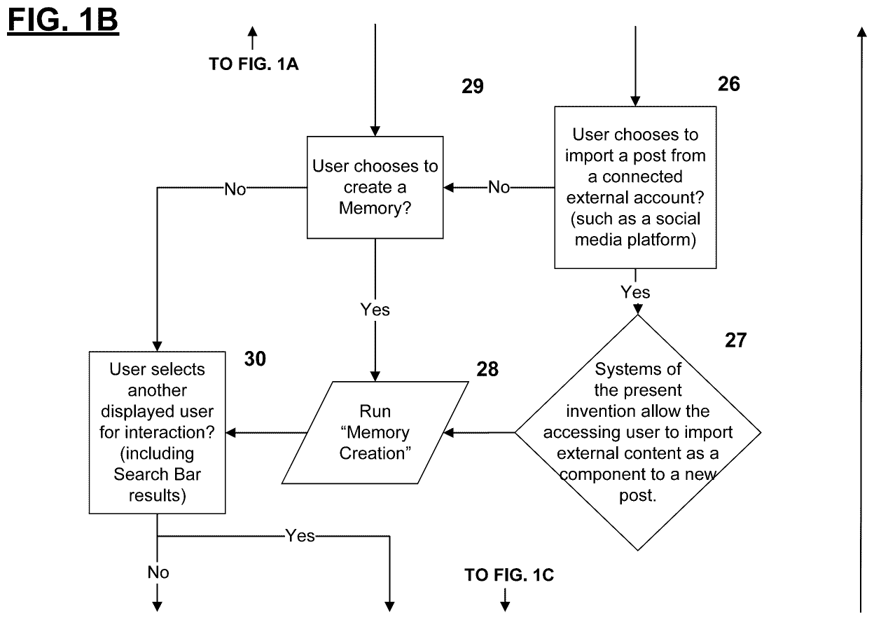

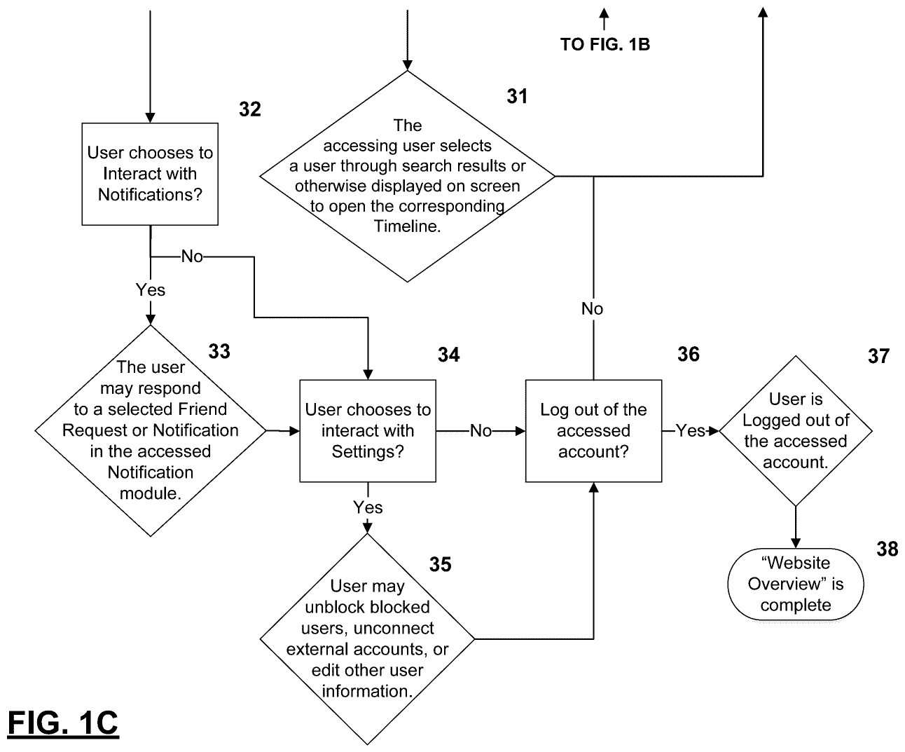

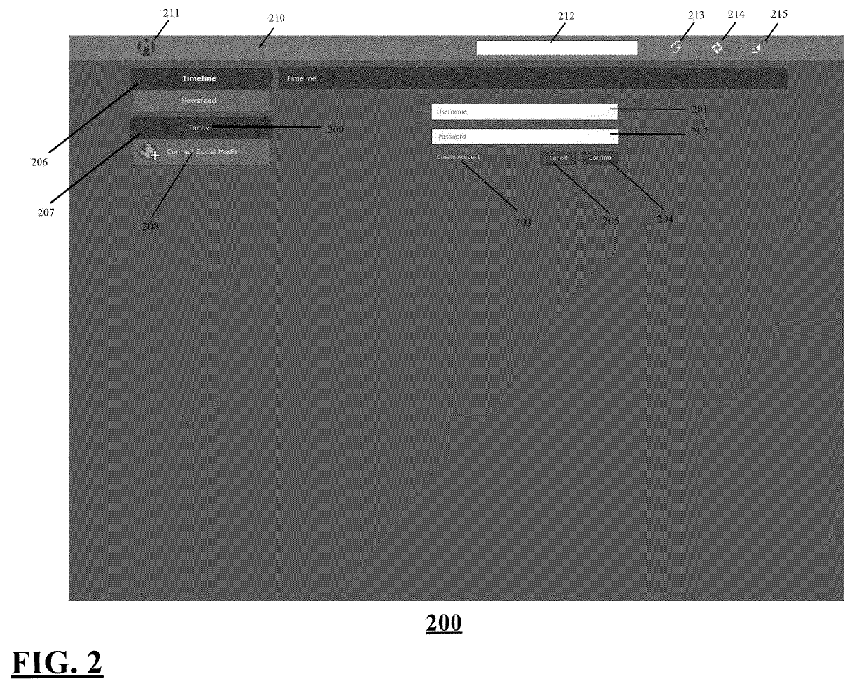

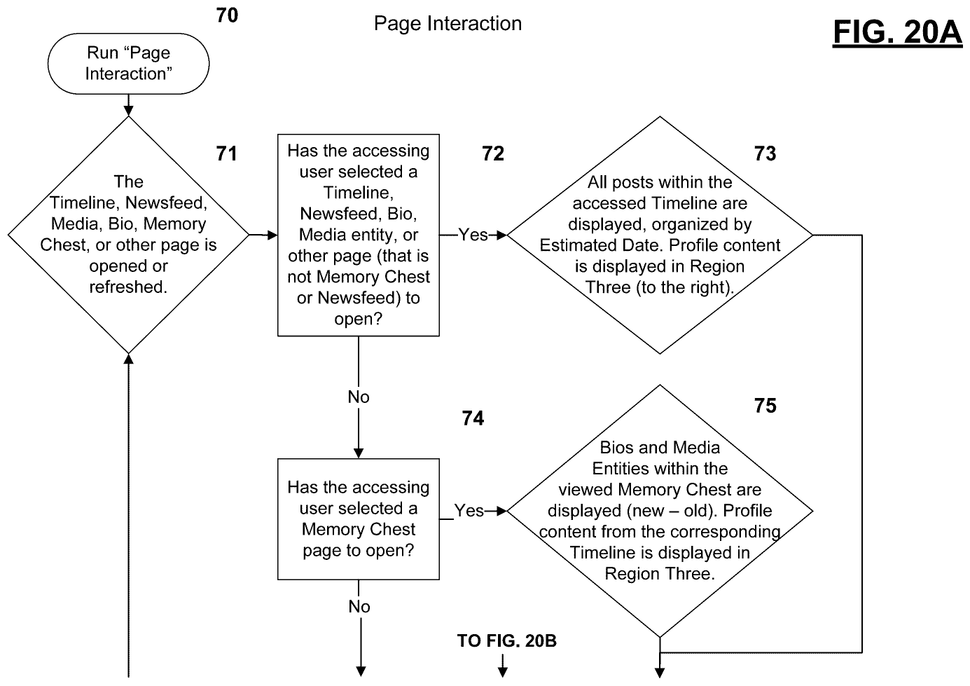

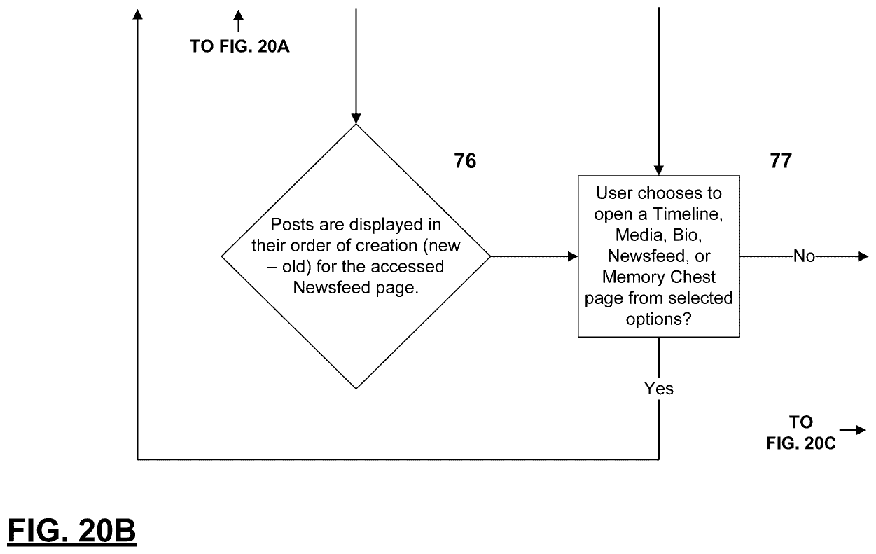

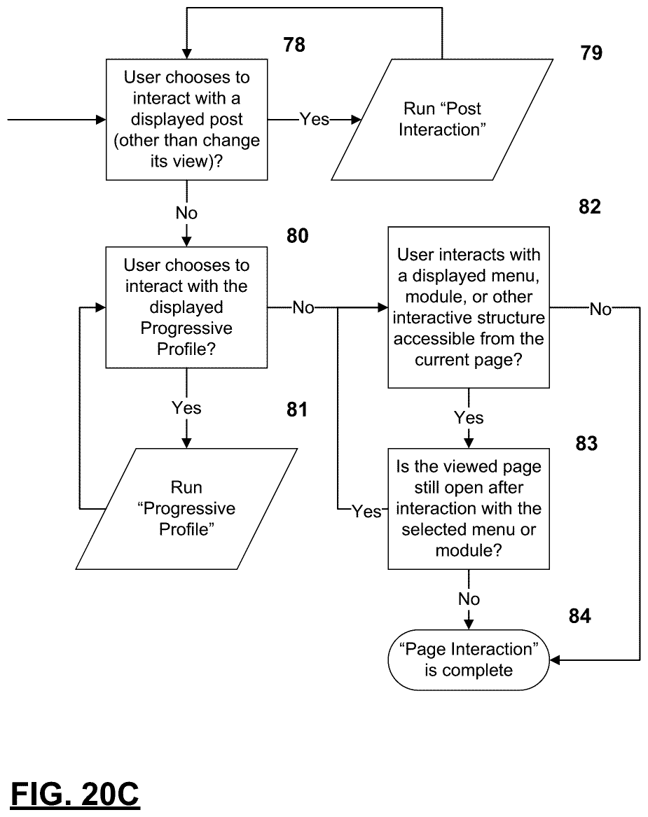

FIGS. 1a-1c present a representative flow diagram of various user access and interaction options for an example system, which may, for example, be housed at a website on a network, such as the Internet, and for which various features such as cataloguing and organizing user memory expression may be carried out (such system also interchangeably being referred to herein as a “memory system”). Firstly, typically prior to the process outlined in the representative flow diagram of FIGS. 1a-1c commencing, an interacting user may visit the home page at the website for the memory system. At 20, the user may visit the appropriate webpage, for example, and various features in the representative flow diagram may be initiated, thereby allowing the user to begin interacting with various features of the memory system, in accordance with aspects of the present disclosure. When the appropriate webpage is opened, the user may be presented a screen at 21 where they may be prompted to login to an existing memory system account or create a new one. Following the entering of proper credentials, various features within the system may be populated with the proper user data for their account. Then, at 22, among various options, the user may have the option to access their “Timeline” page, where they may first view the presented memory system from their personal view, wherein memories (also referred to as “posts,” or singularly “post” instead of “Memory”) and other content they have created may appear. It is to be made clear that interactions the user makes outlined in the processes of FIGS. 1a-1c may occur on any pages and/or using various features accessible within the system of the present disclosure. Example interaction 22 may represent example embodiments of page interactions in an example system in accordance with aspects of the present disclosure, as described further below in conjunction with the description of FIGS. 20a-20c. Shown at 23, the user may select to toggle between their Timeline and Newsfeed pages, opening the corresponding page in place of the one currently displayed. The unique Newsfeed page to each user may be used to view posts created by Friends of the accessing user, for example, as discussed further with regard to the description of FIGS. 20a-20c.

In an example when viewing a Timeline page or another page within the system of the present disclosure, users may have the option to connect externally owned Social Media websites to their account within a module structure referred to as a “User Hub.” In an embodiment in accordance with aspects of the present disclosure, the interacting user may choose to interact with the User Hub at 24, while the selection to connect one, or multiple, external account(s), such as social media, is shown at 25. With the selection to connect Social Media accounts, a process may be carried out to request the corresponding information for the appropriate website. Appropriately entered information may then connect the external web site to the user's account. The accessing user's User Hub may be unique to the user and appear, for example, to the left of displayed pages, in this example, in a Region hereinafter referred to as “Region One.” It is noted that, in this example implementation, the center, largest, section may be interchangeably referred to herein as “Region Two” and the rightmost section may be titled as “Region Three.”

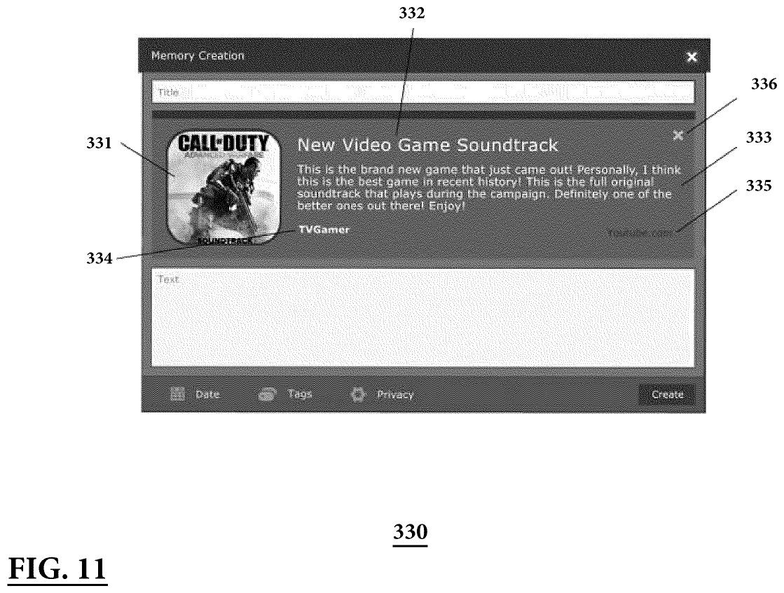

If the user has any Social Media websites connected through their User Hub, the user may selectively “import” a post from the associated website through selecting the appropriate option. The displayed content for import in User Hub may be based on the day and month combination the User Hub is set to, for example, and/or may only be displayed if these items were created on the combination, for example. If it is desired to change the displayed User Hub content, the user may change the aforementioned control date combination at will, where a following process filters to display only the corresponding connected content. When a user selects content from a connected Social Media website in User Hub, shown at 26, the user may begin to prepare for the creation of a new Memory. Then, at 27, the post from an external Social Media website, for example, may be prepared to be involved in the creation of a new post, and may be packaged and condensed with a resulting process. After content is prepared from User Hub, the user may be directed to create a new Memory, shown at 28, discussed further below in conjunction with the FIG. 11 description.

Shown at 29, the user may have a selectable option to create a new Memory from any suitable position on the presented website, such as via an accessible option from the Overhead Bar, for example; such a bar may sometimes or always appear at the top as shown in example screens of the present disclosure. Then, the user may be routed back to 28 to create the new Memory.

Continuing, for example, from any suitable page within the present example system, the accessing user may interact with the Search function of the Overhead Bar, shown at 30, to search some or all available users as may be enabled in accordance with aspects of the present disclosure. At 31, the accessing user may select another user from a menu of resulting users matching Search-criteria. The selected user's Timeline may be displayed as a new page after selection.

In one example embodiment of a system of the present disclosure, at 32, the user may select to interact with the Notification module, accessible, for example, from the Overhead Bar from any page having such Bar displayed. The Notification module may display all or some relevant user Notifications regarding posts and users Requesting Friendship, for example. At 33, the user may respond to Friend Requests or open content from a corresponding Notification relating to content, in accordance with aspects of the present disclosure.

Further, if the user chooses to interact with general website Settings in the present disclosure, the Settings module may be accessed from the Overhead Bar, for example, via the corresponding Settings button at 34. At 35, the Settings module may be opened, and the user may optionally edit their user information, and/or take other actions, such as to unblock blocked users, access Bios or Media entities, remove connected Social Media accounts, or select the option to delete their account based on their desired outcome. At 36, the user may choose to log out of their account or not, which log out may end their interactions with the system. If the user chooses not to log out of their account, they may be routed, for example, back to functionality allowing the user to interact with the displayed page at 22. At 37 the user is shown as logged out of their account, after which a process gathering relevant data to be stored until the next login may then be carried out if necessary. Then, at 38, processes and system functionality of the system may cease for that user interaction.

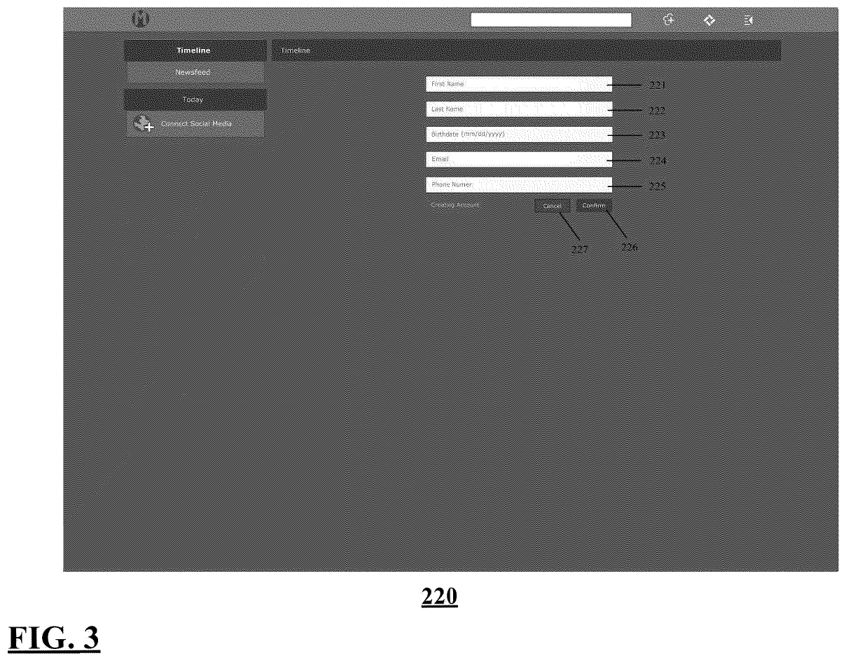

FIGS. 2-7 illustrate example GUI screens accompanying interactions described above in FIG. 1. When beginning interaction with the presently disclosed processes, a user may (or may be required to) start by navigating to the proper webpage and entering login credentials, for example, or by creating an account. FIG. 2 presents a login screen 200 where the user may (or may be required to) enter information for logging in, in accordance with aspects of the present disclosure, as mentioned in box 21 of the representative flow diagram of FIGS. 1a-1c. The user may enter their name into the name entry field 201 and their password in the password entry field 202. If the user does not have an account, they may select the Create Account button 203, which may open the account creation screen, as discussed further in conjunction with the FIG. 3 description.

After inputting user information, selecting the Confirm button 204 may result in submission of the user-entered login credentials, which may, for example, be processed through a functionality to open the proper user account and content. Authorized users may then be logged into their account, while improper login credentials may result in the user being informed of inauthentic information entered in the corresponding fields. When desired by the user, selecting the Cancel button 205 may clear the name and password search fields of entered text.

Following the login process, accessing the Navigation Hub 206 in Region One may allow for the signed-in user to select, and navigate to, a page from any place on the website, for example. In the example embodiment shown, the main pages available to be accessed by the user are “Timeline” and “Newsfeed.” Navigation Hub appears on every page within this example implementation.

The user, once signed-in, may connect their external social media, or other content related accounts, with User Hub 207, appearing in Region One, for example, to simplify the import of content from these content websites into new Memories. By selecting the Connect button 208, the user may prompt that they desire to connect an external web site to their account. Then, a process may occur whereby the user signs-in to the appropriate website externally from the present system, for example, allowing access to relevant connected content within the local user account. The User Hub Date button 209 may allow for the controlling date of displayed User Hub content to be changed when it is edited by a user. The user may select to change the day and month combination, causing a process to run, for example, resulting in connected Social Media content reflecting the changed date-criteria in User Hub.

The Overhead Bar 210 that appears over the top of every page within the shown example implementation presents vital options for the accessing user after login. In an embodiment in accordance with the present disclosure, the icon 211 to the far left of the Overhead Bar (or other selectable feature) may function to route the user back to their Timeline page, similar to as if they had selected the “Timeline” option from Navigation Hub. A logged-in user may enter search-criteria in the Overhead Search Bar 212 to filter through aspects, or the entirety, of the present system for relevant users, for example. This approach allows users to, among other things, seek and find other users that have accounts within a system, such as may be facilitated through a search algorithm.

Once logged in, users may desire to initiate creation of a Memory for their Timeline, which may, for example, be done from any page. Selecting the Memory Creation button 213 may open a module to facilitate the creation of the new post on Timeline, an example implementation of which is discussed in further detail below.

Another feature that users who are logged-in to their account may select is to check all Notifications they receive. Notifications for a user may be accessed through the Notification module, for example, opened from the Notification button 214, which may be located in the right side section of the Overhead Bar, as shown in the figures of the example implementation. When viewing Notifications, the user may select users, posts, pages, or other content to link to the corresponding location within the system. The user may also be able to edit account information through the Settings module, opened from the Settings button 215, appearing, for example, at the far right of the Overhead Bar. The Settings module may allow the accessing user, for example, to log out of their account at will and end interactions with the system.

Following the selection to create a new account, FIG. 3 displays an example GUI login screen 220 wherein a new user within the system may input relevant identifying information. For the system to create a new account for the user, for example, the user may be required to enter certain defining information in the presented fields. The creating-user may input their first name in the first-name entry field 221; their last name in the last-name entry field 222; their birthdate in the birthdate entry/selection field 223; their email in the email entry field 224; and their telephone number in the phone number text entry field 225. It is noted that, in the presently disclosed embodiment, the accessing user may enter (or, for example, may be required to enter for certain implemented system needs) either an email or telephone number, but may not be required to enter both to create an account.

When completed, selecting the Confirm button 226 may result in submission of the user-entered credentials for system authorization and an email or text message may, for example, be transmitted to the user for confirmation of their credentials. Selecting the Cancel button 227 may clear all text entry fields and return the user to the login screen discussed above in conjunction with the FIG. 2 description.

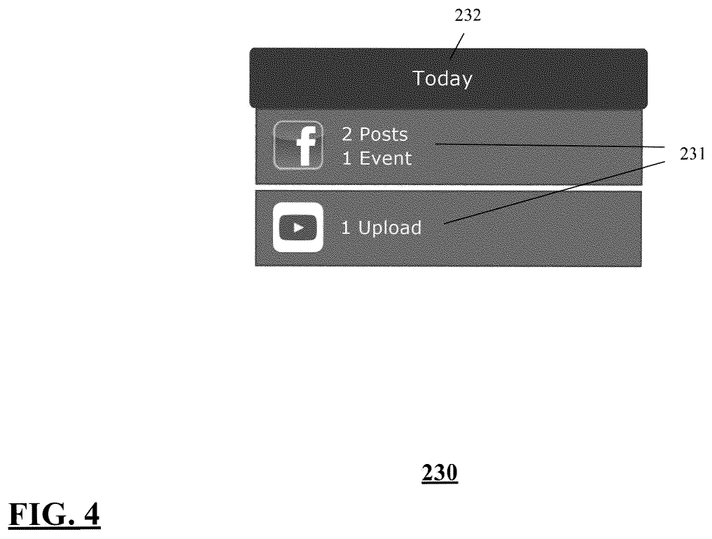

FIG. 4 presents an example User Hub GUI screen 230, as it may appear on a page, following a user's interactions after logging in. The user may interact with the displayed User Hub in accordance with box 24 of FIG. 1. The accessing user in this example has two presented connected social media sites, displaying a categorized count 231 of what the user has done, interacted with, or created on the corresponding external website over the years of the account existence (e.g., based on the day and month that the User Hub is set to). When viewing User Hub, the Control Date 232 may be edited or selected to change the date affecting displayed content. It is to be noted that in this example implementation, the User Hub Control Date will be set to “Today,” which is representative of the current date of access for the accessing user.

If selected, the User Hub Control Date may open a graphic calendar used to facilitate the date selection of User Hub. Within the calendar interface of User Hub, the selected day and month combination may appear in a noticeable selector “box,” or outline. Like other calendars used in the field of this example implementation, the presented calendar may have arrows to the left and right of the month, allowing for cycling of the selected month. Each month may have a noticeable display change for days that will have content accessible, or fetchable from connected accounts, on the corresponding day. For example, if January 15^{th} is a day that is visually notated for potential selection, one would be able to infer that there is content from a connected User Hub account that was created on, or fetched in relation to, that specific day. In contrast to days with content, the days on calendar with no connected relevant content may appear in a darker, unselectable form, for example. To view the content within a connected Social Media website, the user may select the corresponding website bar, along the lines as discussed further below.

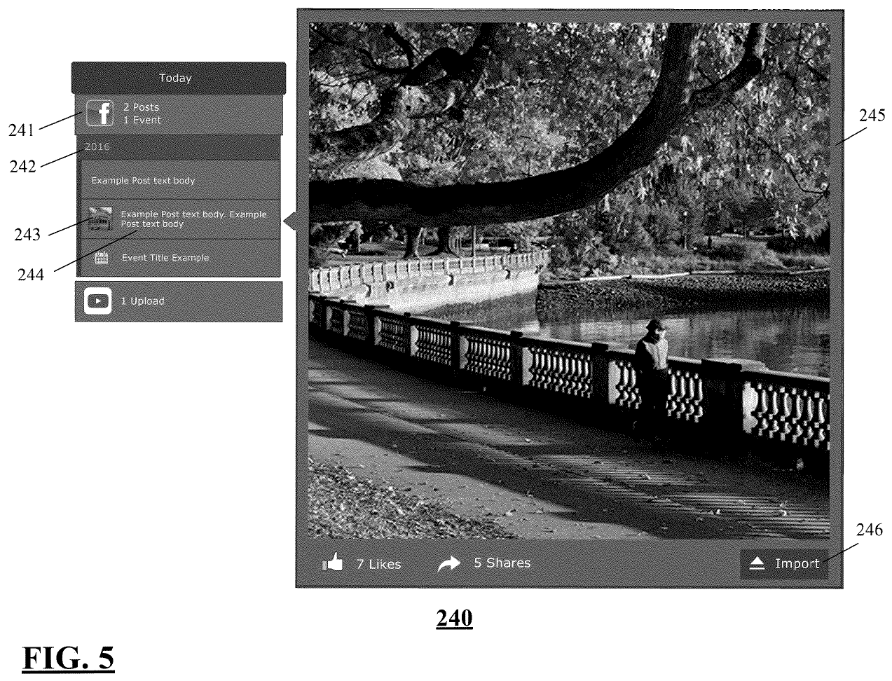

FIG. 5 presents an example User Hub GUI screen 240 containing two connected external websites, one open and displaying relevant content that may be imported into this example system. The depiction of FIG. 5 continues example interactions with the logged-in user's User Hub of FIG. 4, where the user is now viewing connected Facebook content. This interaction with connected content falls in accordance with box 26 of the representative flow diagram of FIGS. 1a-1c. Selecting an external social media account, such as the example connected Facebook account 241, may open a corresponding content section and display relevant information. “Relevant information” as it is used in this example implementation refers to posts, events, or other content created or choreographed on the connected external User Hub accounts on, or around, the day and month combination in which the User Hub Control Date is set. When a User Hub account content section is opened, it may be positioned at the top of the User Hub, underneath the main Heading Bar, for example.

Appearing at the top of the opened User Hub content section in this example implementation is a Subheading Bar with the most recent year 242 displayed, including relevant information on the User Hub Control Date. As seen in the presented interface, the user has a Facebook User Hub section opened with the year 2016 as the most recent year displayed. Directly beneath the Subheading Bar are all posts, events, and other relevant information connected to the corresponding Social Media account. Each item of relevant information may take different forms of presentation in this example system, though for the example shown, the typical post made on a social media website has the fetched thumbnail picture 243 to the left and associated fetched text 244 to the right. It is to be made clear that the presented iteration is only one of many possible for how social media content, or other connected account content, may be formatted in the User Hub display.

To view content that the user may wish to import in this example implementation, they may select a relevant-information entity to open a pop-up Import window 245 to the right of the User Hub, unique to each type of entity and related external website. Typically, interactions or other designating characteristics from the associated website may appear in the Import window. One commonality among entities in the pop-up Import window in this example implementation is that they may contain the Import button 246, which packages the associated content for the Memory creation process, along the lines as discussed in conjunction with the FIG. 11 description.

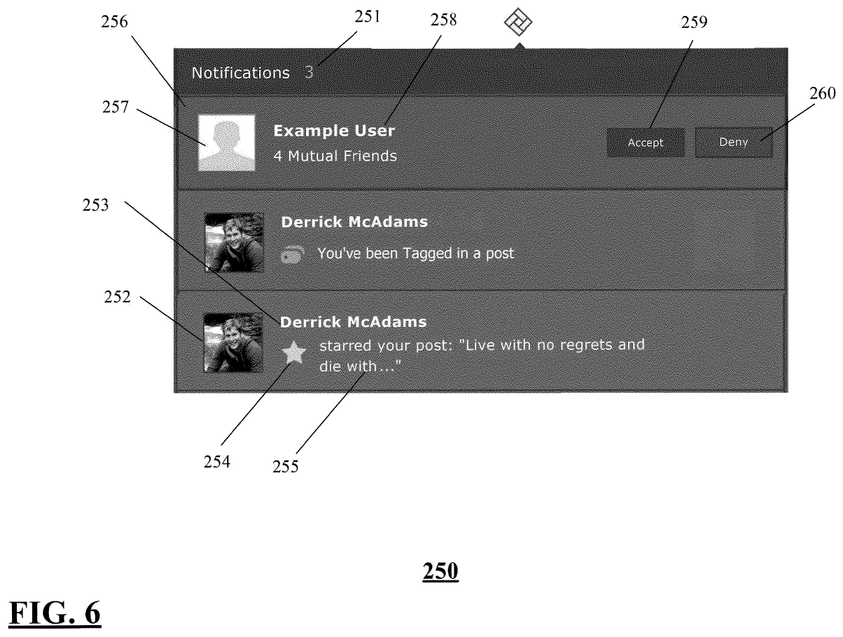

Next, FIG. 6 presents a sample Notification module 250, as it may appear over a page in accordance with box 33, displaying example Notifications for the accessing user. The user in the example shown has selected the Notification button 214 of FIG. 2 to view relevant information deemed a Notification, determined by the system in accordance with aspects of the present disclosure. Notifications may include any sort of item to be viewed by, addressed by, or communicated to by the accessing user, including Friend Requests by other users. The user in this example is informed of the amount of total unread Notifications with a numerical count 251 at the top of the Notifications module.

Selecting a Notification in this example results in a process being initiated to route the user to the corresponding post, page, user, or entity. Non-Friend-Request Notifications appear with a relevant picture (for example, the most recent Profile Picture of the user) 252, the enacting user's name 253, representative icon 254, and a description of the Notification 255 for user reference. Friend Requests 256 in this example appear with the requesting user's most recent Profile Picture 257, along with display of the name 258, the Confirm button 259, and the Deny button 260. Confirming or denying in the displayed example either adds the requesting user to the accessing user's Friends list or not, while removing the Notification. It is noted that Notifications in the example shown may or may not change their visual depiction based on if they have been viewed or selected by the user.

The Search Bar may be accessed from the Overhead Search Bar button 212 of FIG. 2, beside the Notification button (or other selectable feature) that accesses the module as shown in FIG. 6. The depicted Search Bar allows for the searching of a plurality of information, content, and entity types. In the example manifestation shown, the Search Bar allows for the user to enter text that may have the capacity to search for Users, content, and other potential entities within the accessible aspects of the disclosed system example. The interface may allow for a drop-down menu that displays the list of search results with potential relevant criteria, such as the number of mutual friends a user may have in relation to the searching user.

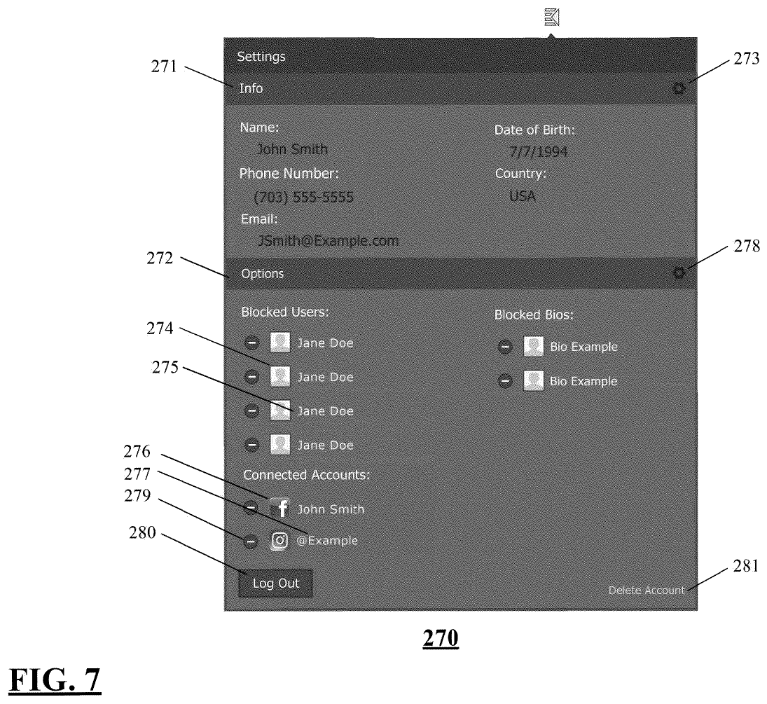

Continuing an interaction from FIG. 2, the accessing user of the example screens shown has selected the Settings button 215 to interact with account information in FIG. 7, presenting an example Settings module GUI screen 270 displayed as it may appear over a page. The Settings module as shown is broken into the Info subsection 271 and the Options subsection 272 for categorizing user options.

Within the Info subsection of the Settings module for this example are the Name; Date of Birth; Country; Email; and Phone Number titles designating each corresponding text field of related information. The name, birthdate, country, email, or phone number displayed in each appropriate field may correspond to the information entered when the user created their account or updated it thereafter. Selecting the Options button 273 on the Info Subheading Bar in this example allows the user to edit any displayed informational fields when selected, and to finalize any changes by selecting the “Enter” key or the Options button a second time. Making any user-entered “changes” to the user information displayed in the Info subsection of the Settings module may send a confirmation email and/or text message, to whichever communications method has been provided, before the change may be made and the system updated accordingly.

Other functions of the Settings module of this example may include allowing for the user to make changes to entities Blocked. If they exist, Blocked users, Blocked Bios, and connected external accounts, such as a social media account, may appear under corresponding subheadings in the Options subsection of the Settings module, for example. Blocked entities in this example are specifically designated to have their content not appear in any form or fashion to the user. As shown in this example, blocked users appear with a representative picture 274 to the far left of their corresponding name 275, appearing in a descending list above connected Social Media accounts. In the shown example system, the picture used to represent Blocked users may be their newest Profile Picture. Blocked Bios appear directly to the right of any Blocked Users, or a blank corresponding area may be presented if no blocked users exist, in a similar fashion to the displays of non-blocked users. Beneath Blocked users, or in place of Blocked users if none exist, may appear a list of connected external accounts, with the representative logo image 276 to the left, and the corresponding account name 277 designation to the right, in this example. Following viewership, the user may Unblock user/Bios and unconnect accounts through the selection of the Settings Option button 278, appearing in this example implementation at the far right of the Options Subheading Bar. Selecting the Settings Option button may cause all displayed Blocked users/Bios and connected accounts to move slightly to the right, displaced in relation to the Remove button 279, which may be used to Unblock or unconnect the corresponding user, Bio, or Social Media account accordingly.

While interacting with the Settings module, the user may access the Log Out button 280, which signs the user out of their account, typically returning to the Login page, as discussed further in conjunction with the FIG. 2 description. If the user selects to erase their account, the Delete Account button 281 may also send an email or text message to the user, for example, based on the communication method available, with instructions on deleting their account, which instructions may change depending on the exact situation or circumstances as determined by the appropriate system settings.

### Memory Creation

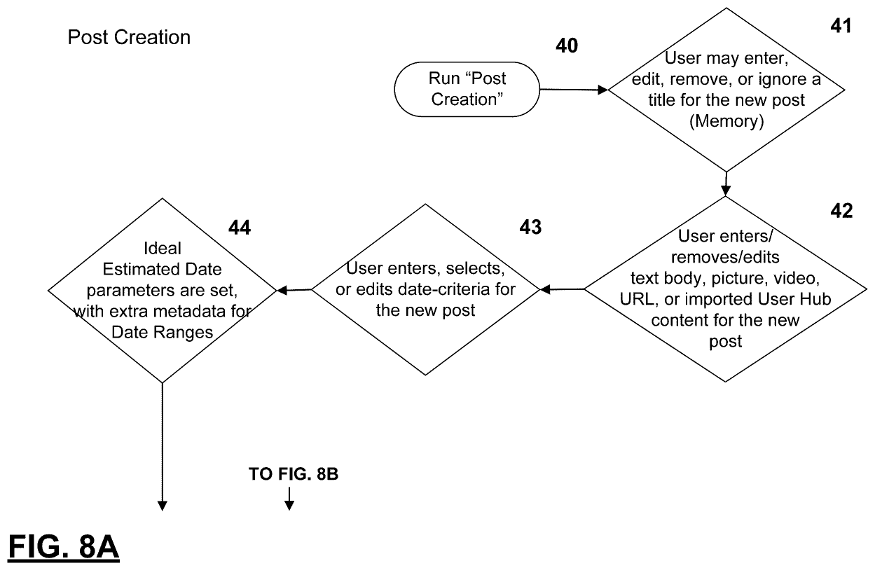

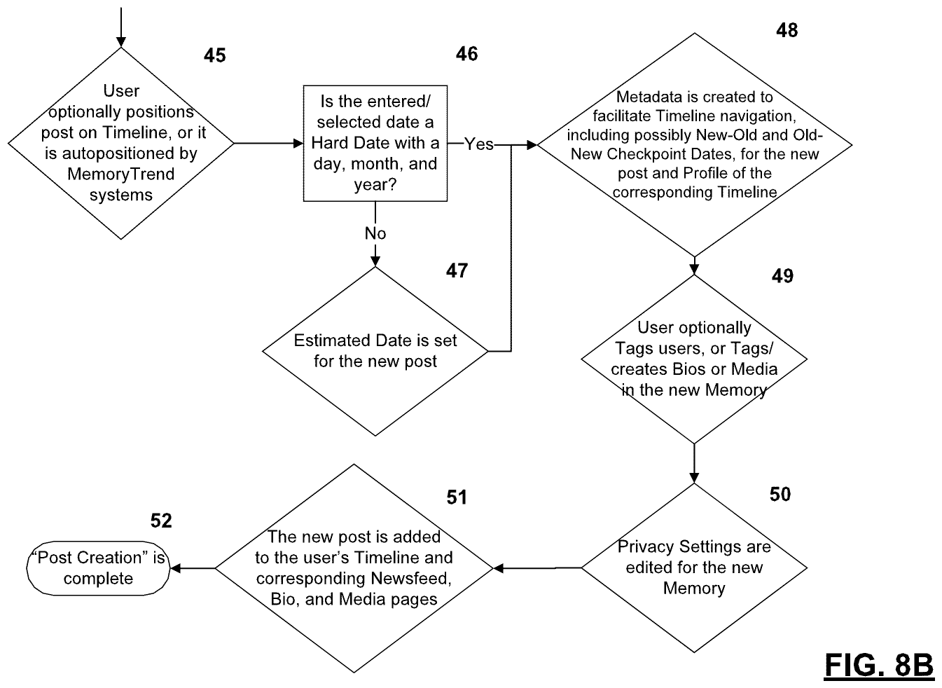

In the example system shown, a user's main page, where a user accumulates all their memory content, is referred to as that user's representative “Timeline,” opened in one method from user selection of the corresponding Navigation Hub button of FIG. 2. FIGS. 8a-8b present a representative flow diagram of the Memory (also interchangeably referred to herein as a “post”) creation process, allowing the user to create a new Memory for their Timeline, and all other accompanying places the Memory may appear thereafter. It is to be made clear that all terms used during the Memory creation process are only examples and are not intended to limit the scope or application of their represented function or entity to only as shown in this example implementation. The representative flow diagram of FIGS. 8a-8b continues interactions of a logged-in user, carried from the Memory Creation button of FIG. 2. At 40, the user selects the corresponding Memory Creation button from the interactive Overhead Bar. Over the top of the currently viewed page (as shown in this example) the “Memory Creation module” is opened, where the user is able to input necessary information for the creation of the new post.

At 41 the user enters an optional title for the new post, or removes any existing title text. It is noted that titles in this example implementation are not mandatory for the creation of new posts, but are merely options provided for additional designation of posts. Continuing from optional title entry, at 42 the user is able to enter or edit an optional text description, or picture/video content, for the new post. A URL may be entered by the user to link features assigned to the fetchable content for the post, if available. In this example implementation, it may be a mandatory step to include either text or picture/video content for the new Memory.

Following content input, the user has many options in this example system for selecting, or entering, date-criteria specifications for a new post at 43. Having a wide array of date input options assists with the reality that memories frequently, if not typically, are not communicated through the lens of exact date information, online or otherwise. When recalling date information for post user input in the present example system, users do not have to select a full year, month, and day. This said, Memories may be created in this example system with any portion of a full date, while foregoing the other components, allowing even a season, for example, in place of a month and day.

In the example of system shown in these figures, when a year is not entered by the creating user, they also have the option to enter a unique text “Section” to represent the corresponding portion of their lives, such as “Childhood” or “School Days.” The ability for Sections to be created allows, among other things, for the continuation of user interaction through lapses of human memory, facilitating further processes of the shown example system. It is to be made clear that Sections in this example may require as little as one character of user-entered text to be approved for a user Timeline. Furthermore, the user may enter a date range of date-criteria for memories that the user is notably unsure of dates for, or that lasted more than a single day, such as over a multiday vacation.

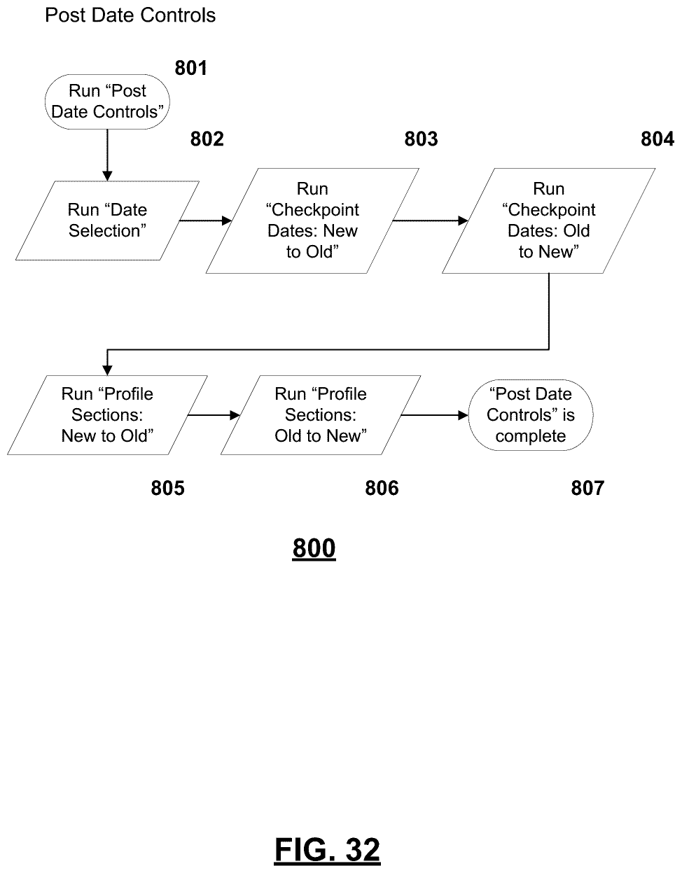

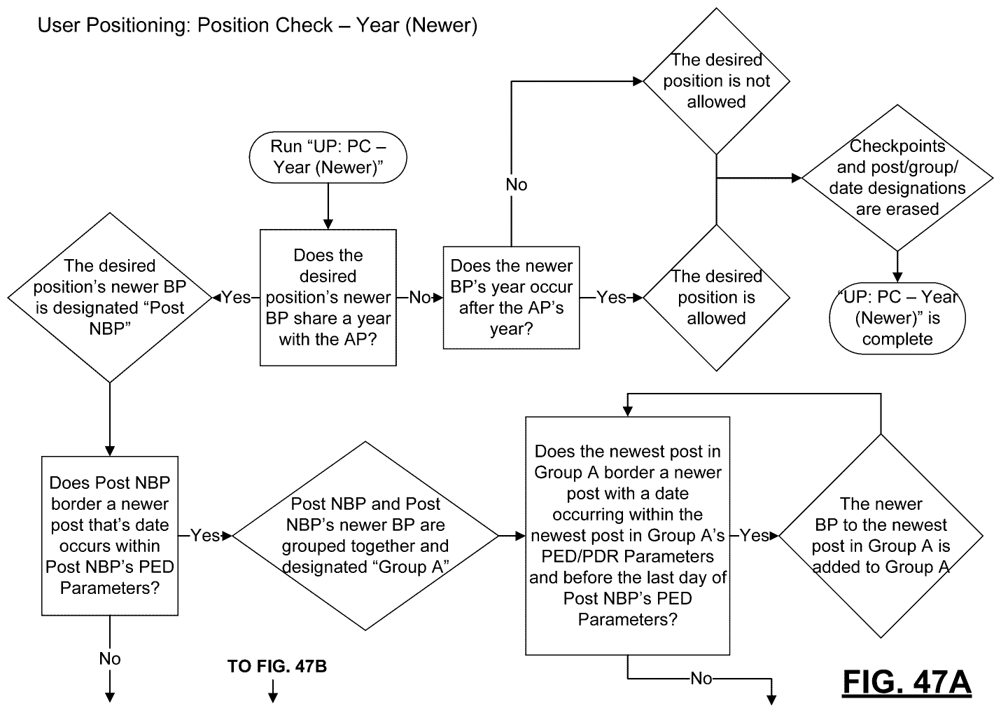

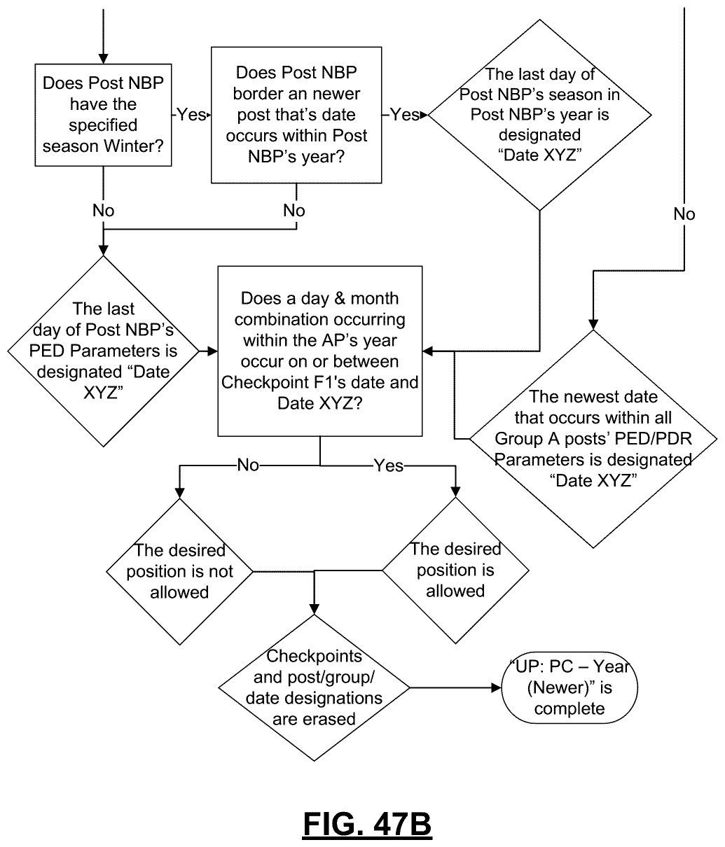

In continuation of the presented flow diagram of FIGS. 8a-8c, after the user inputs date information for the Post, metadata that assists in placing it on Timeline may be set at 44 with an algorithm, or series of connected algorithms, for example. For an example manifestation of the metadata creation system, refer to Date Approximation Detailed Example Description section below, in conjunction with description relating to FIGS. 32-65b. The Date Approximation Detailed Example Description demonstrates a method of processing date-criteria selected, or entered, by the user to provide an approximated date output and other results in accordance with aspects of the present disclosure. Furthermore, the referenced Date Approximation Detailed Example Description in this example implementation allows for user positioning of posts on the corresponding Timeline structure, which may improve date approximation. One example of useful metadata created is a set of parameters to show what the earliest and latest possible post existence dates may be, as input by the user. For example, a post with a “January 2010” date-criteria may have potential parameters set from 1/1/2010-1/31/2010.

Following receipt of user selected date-criteria, after all appropriate algorithms and processes may be carried out (including, for example, run by automated system features) in response and are completed, at 45 the system may allow the user to drag and position the new post on their Timeline, which may, for example, be temporarily opened upon selection. The opened Timeline may display the inhabiting posts in a unique view, including, for example, the option of presenting an icon representing the approval status of the presented position on the Timeline. Then, the user may select an allowed position, which may also be defined by a determining algorithm.

Continuing the processing of user input, it may be determined at 46 if the new post has a sufficiently complete date, or not, as posts with a day, month, and year may not typically require an Estimated Date set to be generated, for example, in this implementation. At 47 the Estimated Date for the new Memory may be placed, based on an array of components that may include, but are not limited to, Timeline location, Timeline parameters, and metadata of surrounding posts. In one example implementation, as a Timeline may be filled out and/or interpreted by algorithms of the system, the associated Estimated Dates may become more accurate approximations of the theoretical “exact” dates of the memories, or other entities, they represent.

Continuing the example metadata creation, at 48 relevant metadata, such as Checkpoint Dates, may be created by an algorithm for one or more of the user's 1) new post, 2) entire Timeline of posts, or 3) corresponding Timeline Profile. Checkpoint Dates may be used, for example, to assist with displaying content for, or surrounding, Timelines and associated Profiles.

Following the date selection and surrounding user interactions for the creation of the new memory, at 49, the user may Tag any number of users, or other example entities, such as Media entities, or Bios, in their new Memory. For the sake of representing the intent and scope of the entity type, these aforementioned “Bios” may, for example, represent animals, hobbies, other entities, or even humans that do not hold a presence online. Bio examples could include, for example, the user's dog, house, car, drawing hobby, etc. A Media Entity may be representative of a form of fetchable or other media, such as a musical artist or television show, unless it is manually input by the user, for example. In some example implementations, the user may have the option to create collective entities, such as Bios or Media, directly from the Tagging stage of post creation. Tags for a post may, for example, dictate where it will appear or who will be notified of its creation. If the Estimated Date of the new Memory is outside of the Start and End Date range of the associated Bio or Media, the system may extend the date range to accommodate the change.

After selecting Tag options, the creating user may select Privacy Settings for their new post at 50, with options to select if they may prefer the new post to only be visible, for example, to 1) Them alone, 2) Their Friends, 3) selected other lists or organizations; or 4) The entire “world” of accessors. It is to be made clear that, as used herein, “Privacy” is referred to broadly to explain groups of users within an example implementation. Following the selection of Privacy Settings, the user may enter another user's name to exclude them in the Privacy Settings (e.g., to selectively exclude one or more users from a new post). Alternatively, if it is desired that the new post appear to only a select user or a few users, the creating user may enter each such user's username to include them from the Privacy Settings of the new post.

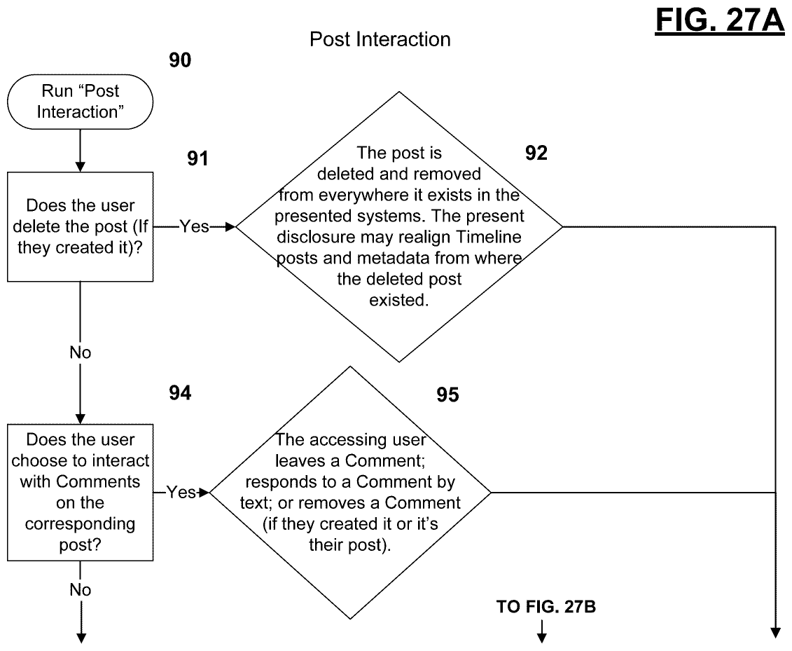

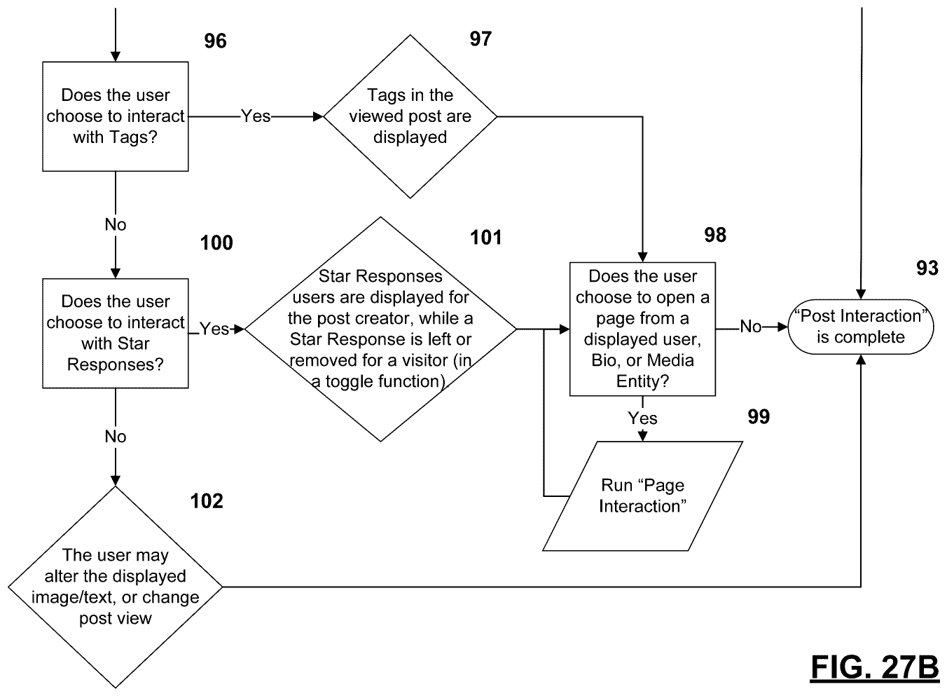

While editing the Privacy Settings of a selected post, the user may also choose if they want the new post to appear on other user's pages, as determined by the appropriate system settings (for example, on a page like Newsfeed, shown and described further in relation to FIG. 26). In addition, for example, the creating user may limit interaction functionality amongst the users that will view the post. The user may determine to allow “Star Responses” or Comments on the new posts, which are two example post interaction methods discussed below (see, e.g., Post Interaction, shown in the representative flow diagram of FIGS. 27a-27b and accompanying descriptions).

Continuing the Memory Creation process from Privacy selection, the user may select to complete the new Memory at 51, allowing the system add it to the creating user's Timeline, as well as any Tagged Bio and Media Entity pages owned by the creating user, or Newsfeeds of Friends the user has. Final post locations after creation may vary depending on specific system features discussed herein. Then, Tagged users may be Notified of their Tag when the new Memory is created. Further, at 52, the Memory Creation module process may close, the new Memory finalized, and the Memory creation process thereby completed.

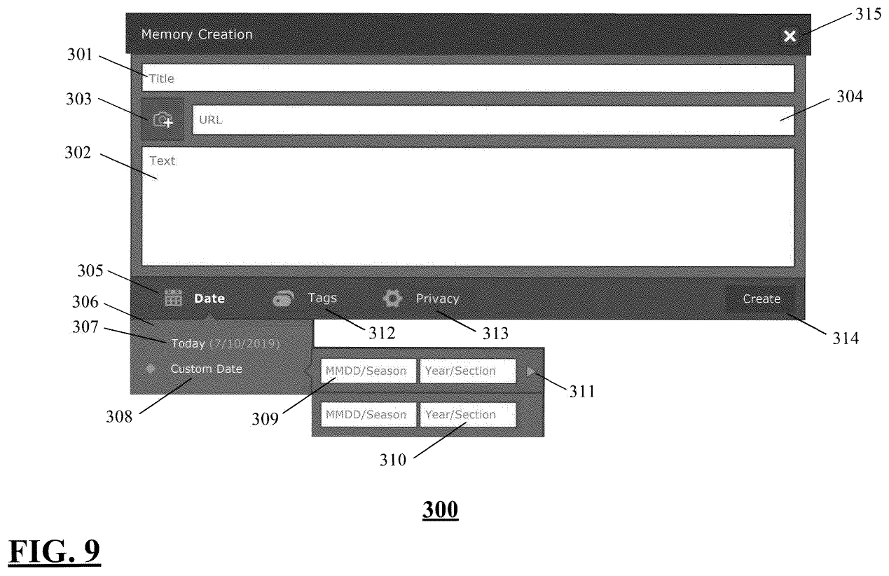

FIGS. 9-15 illustrate example GUI screens accompanying interactions described above in the representative flow diagram of FIGS. 8a-8b. Following the Selection of the Memory Creation button of FIG. 2, FIG. 9 presents an example Memory Creation module GUI screen 300 as it may appear on a page. A plurality of content types may be entered or selected for the new post in accordance with this example implementation, as referenced in box 42. The user may enter an optional text title in the Title entry field 301, for example, similar to how Text body may be entered for the post in the Text Body entry field 302. Then, the user may add Picture(s) or video(s) to the new post, such as by selecting the New Picture button 303. The creating user may also enter a URL in the URL entry field 304 of the Memory Creation module, for example, if a picture or video has not already been added to the new post. It is noted that if the URL does not link to a picture or video, the URL may be removed. Also, it is noted that, if a picture or video has already been added to the new post, the URL entry field may automatically not appear. In some implementations, of all combinations of content types, the creating user may be required to enter at least one of a text character, picture, video, or URL.

After opening the Memory Creation module, the user may select the Date button 305, thereby opening the Date Selection menu 306. The Date Selection menu may display options to select, for example, the date of the Memory through its corresponding Today's Date button 307, enter a custom date with its corresponding Custom Date button 308, or select the date of a picture or imported content's creation if imported content exists to be fetched (which provides another Import Date button, similar to the Custom Date button). The date selection outlined functions in accordance with aspects of the present disclosure as referenced in box 43 of the representative flow diagram of FIGS. 8a-8b. In an example implementation, the Today button may appear with the current date of creation beside it, while the Imported Content Date button may appear directly below (when relevant) with the relevant date to the right. Selecting Today's Date, Custom Date, or imported Content Date button may result in a selector icon appearing to the left of the selected date option, designating the choice.

While entering date-criteria, entering a custom date into the Month/Day/Season text entry field 309 and Year/Section text entry field 310 may result in the Custom Date option appearing for entry of the date-criteria of the new post. Then, if desired by the user, selecting the Date Range button 311, for example, may allow for an Ending Parameter to be submitted, through entry in its corresponding text entry fields, appearing there below (as shown in this example implementation).

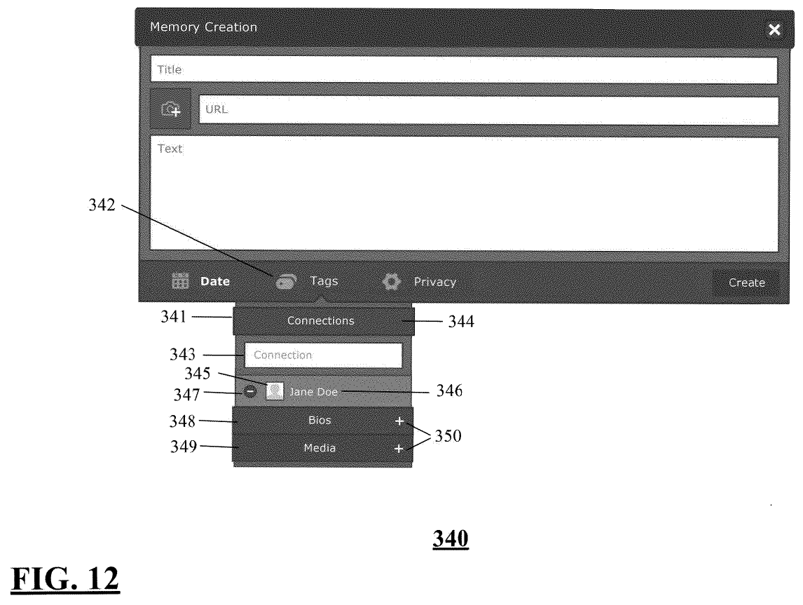

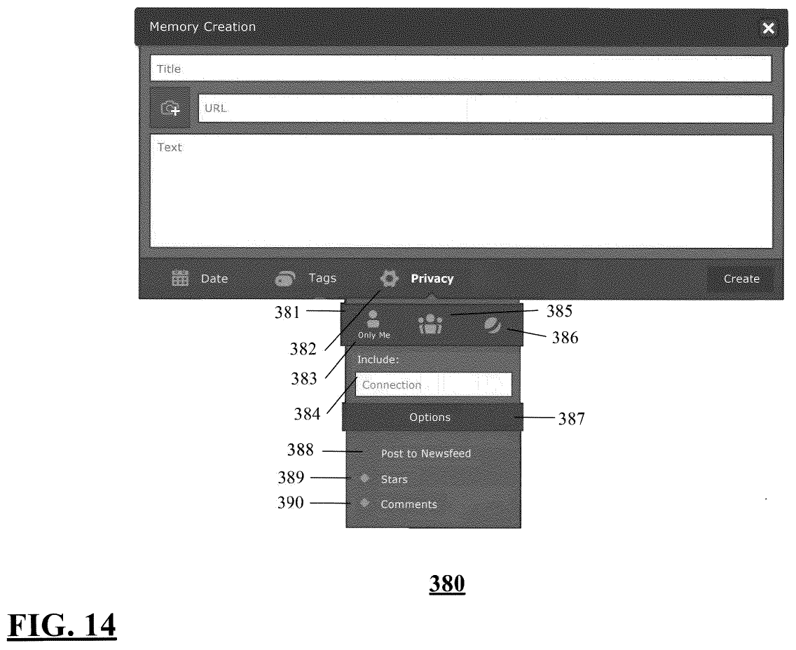

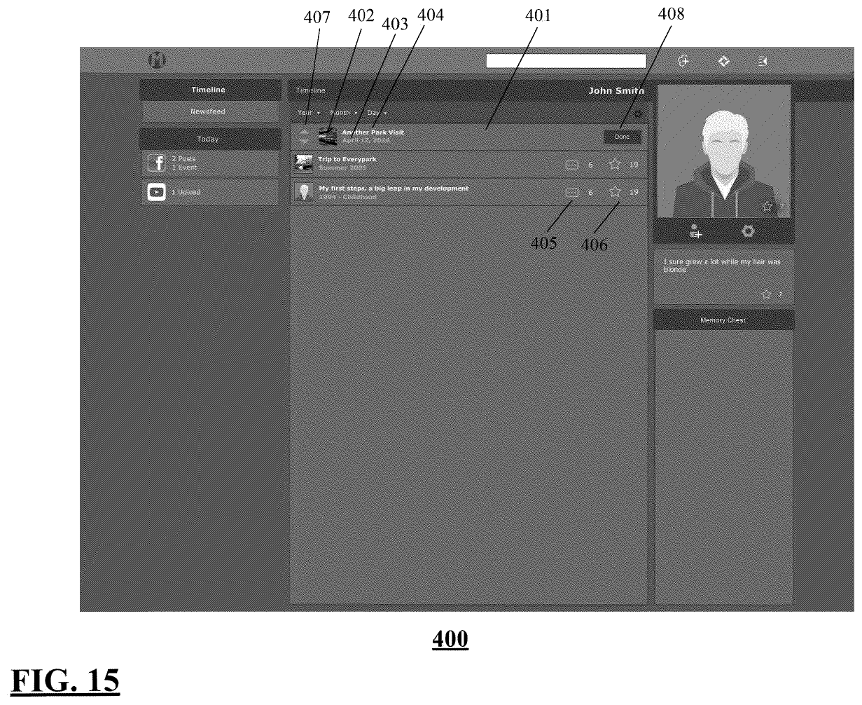

Following date selection, the user may select the Tags button 312, resulting in opening of the Tags menu to allow for the Tagging of users, Bios, and Media in the post, as discussed in more detail below in relation to FIG. 12. Then, similar to the Tags button, the Privacy button 313 may open its corresponding menu when selected, as discussed further in relation to FIG. 14, thereby allowing the user to edit the Privacy options of the post. Continuing the example creation of a Memory, selecting the Create button 314 may finalize the new post. The finalization may include, for example, the system selectively or automatically confirming valid date-criteria and at least a character of text or one picture/video being included. Following finalization, the page the Memory Creation module may return to displaying the screen displayed before the Memory creation process began. If the user desires at this point to cancel the creation of the new Memory, the Close button 315, for example, may be used to cancel the creation process and close out of the Memory Creation module, thereby resulting in display of the page as it was prior to opening the Memory Creation module process occurring.

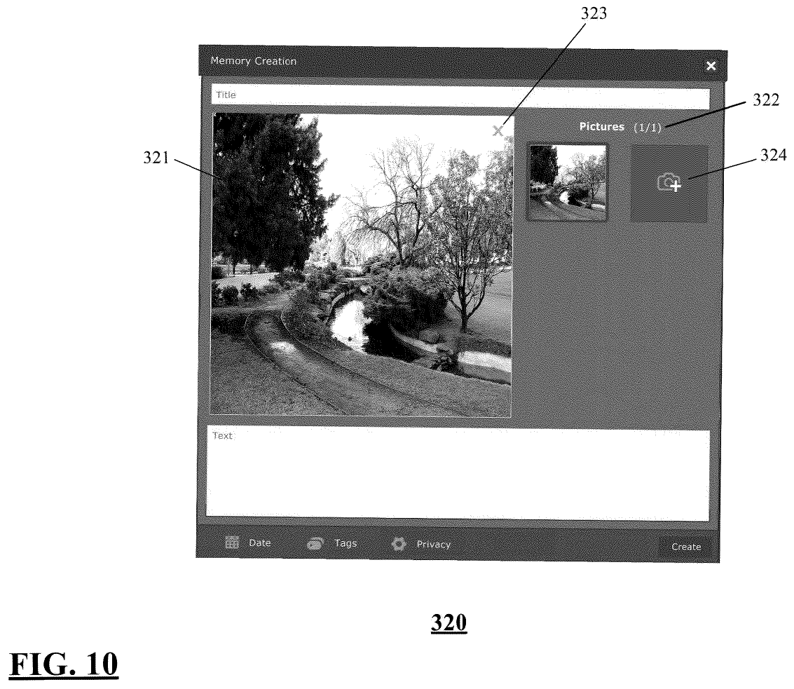

Continuing the interactions, as shown in FIG. 9, following the selection of the New Picture button, or the linking of a picture from the URL entry field, FIG. 10 depicts a sample Memory Creation module GUI screen 320, as it may thereby appear on a page, wherein one example picture 321 is shown as added. To the right of the displayed expanded picture in this example screen is a descending list of pictures/videos within the corresponding post. Pictures/videos may appear from oldest to newest, with a thick selector outline, for example, extending around the selected picture, designating that it is the expanded picture. It is noted that a designation fraction 322 may optionally appear in order to display the exact position of the selected expanded picture over the total number of pictures/videos in the corresponding post.

Continuing interactions with the example added picture, the user may remove the picture from the corresponding post by selecting the Remove Picture button 323, which selection feature may appear as overlaid on top the selected picture. After a picture is removed, the next-added picture may become the selected expanded picture. If another picture or video does not exist in the new Memory when a picture is removed, the Memory Creation module may revert back to its initial form when it is opened, as shown and described with respect to FIG. 9. Continuing the process of addition of pictures and videos, the user may select to add an additional picture or video from their networking device or Timeline, for example, to the new post by selecting the corresponding new picture button 324, which may allow creation from the user's Internet connected device, for example.

Alternatively, forward from FIG. 9, if the user links packageable URL content in the URL entry field, an example Memory Creation module GUI screen 330, as shown in FIG. 11, may be opened and displayed with an added URL packaged preview, as presented in the example screen of FIG. 11. For example, a video thumbnail, article picture, or other representational image 331 may appear to the left of the packaged URL preview, as shown in FIG. 11. If a fetchable title exists for the packaged URL content, for example, the corresponding title 332 may appear (e.g., directly to the right of the representational image as shown in the FIG.), if it exists, or, for example, may be shown as aligned left if no representational image exists. A text preview 333 of the packaged URL content, or related text description, may be displayed directly beneath the title, for example, or in place of the title if one does not exist. The author/creator 334 of the packaged URL content may appear directly beneath the title and text description, aligned left, near the representational image or imported content area if an image does not exist, for example.

While viewing an imported content preview screen, selecting the creator of the packaged URL content may open the hosting platform, which may be routed directly to the corresponding user's related page in a new window, if accessible, for example. However, if a user's page is not accessible from the URL preview, the related packaged URL content may be opened on its original platform, for example, in a new window, such as when the creator/author is selected. The hosting platform 335 may be displayed, for example, in the bottom right of the imported URL content preview, which may show the opened corresponding site in a new window when selected. It is noted that selecting the representational image, title, or text content of a packaged URL preview may open the corresponding packaged URL content on its original website, but shown as opened in a new window.

After adding the imported content preview and interacting with linked content, the user may remove the packaged URL content via use of the overlaid remove button 336, when selected. If a packaged preview is removed, the Memory Creation module may revert back to its initial form when it is opened, along the lines as discussed in conjunction with the FIG. 9 description.

Continuing the creation of content from the three content types of FIGS. 9, 10, and 11, FIG. 12 presents a sample Memory Creation module GUI screen 340 with the Tag menu 341 opened and displayed through the selection of the Tag button 342. When open, the Tag menu may be separated into three sections, as shown in this example implementation: Connections, Bios, and Media. Continuing the Tagging interactions functionality, the user may Tag other users in the new Memory from the Connection text entry field 343 in the corresponding Connections section 344 of the Tag menu, for example. Connections Tagged in a post may appear in the Connections section with a representative picture 345 to the left of their name 346, for example, as shown. It is noted that the representative picture may, for example, be the most recent Profile Picture for displayed Connections. To remove a Tag, as desired by the user, the user may select the corresponding Remove button 347 appearing, for example to the left of each Tag, as shown in FIG. 12, which may then remove the Tag from the post when selected. It is to be noted that the process of displaying Tags occurs in accordance with the present disclosure as referenced in box 49 of the representative flow diagram of FIGS. 8a-8b.

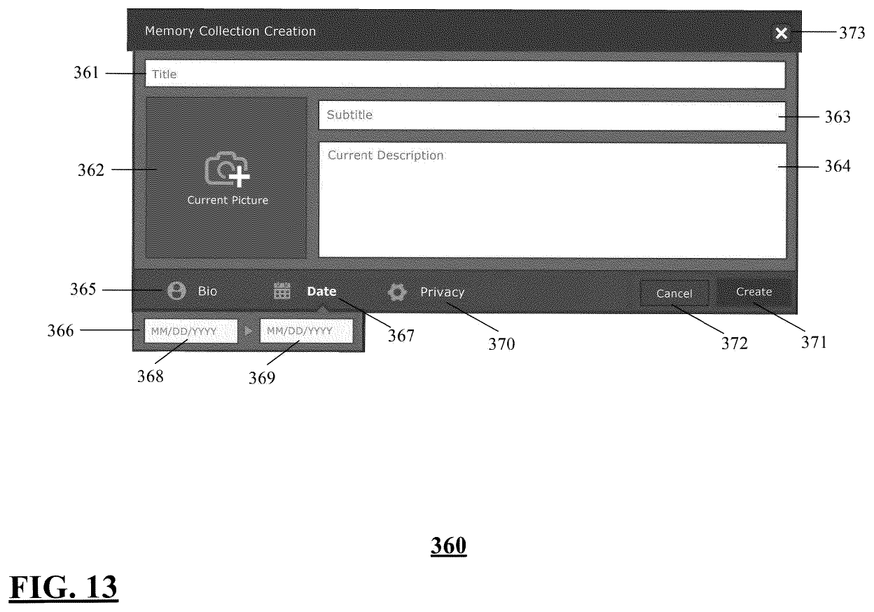

Continuing from the selection of Tagged Connections, the user may select the Bios section 348 or the Media section 349, for example, thereby opening the selected section and displaying the associated text entry field for Tagging Bios or Media entities. The text entry field for Bios and Media may appear and function similarly to the Connection text entry field functionality, except the entities in question may include Bios or Media instead of Connection. Tagged Bios and Media pictures may appear similarly to Tagged Connections, with the title of the Bio or Media being displayed in place of the user's name, for example. Following the Tagging process, if the user is adding Bio or Media Tags and does not have an entity available they wish to Tag, they may be provided with the option to create a new Bio or Media Entity by selecting the corresponding Memory Collection Creation button 350, for example, which may open the Memory Collection submodule, as shown and described further in reference to FIG. 13.

Following the selection of the Memory Collection Creation button of FIG. 12, FIG. 13 presents an example Memory Collection submodule GUI screen 360 that may appear, set to the creation of a new Bio as desired by the user. The user may then enter a title for the Bio in the corresponding title text entry field 361, for example, as well as provide an optional accompanying subtitle in its respective subtitle text entry field 362. Continuing the example creation of the new Bio functionality, a representative Profile Picture may be entered with the Bio Picture button 363, while a text Profile Description may be entered in the Bio Description text entry field 364. It is noted that in this example implementation, Bio Profile Pictures and Descriptions are optional steps that may be taken by the user.

Following, for another function connected to the creation process of the new Bio, the user may optionally select to toggle between the Bio and Media section of the Memory Collection Creation module. For example, the user may toggle through Bios and Media with the selection of the Memory Collection button 365, representing the selected Memory Collection being created. In accordance with the present disclosure, if a Bio is being created, the Memory Collection button may display the Bio icon and the text “Bio” to designate the new Bio being created. When selected, the Memory Collection button may open the Media Creation section of the Memory Collection module, toggling the Memory Collection button to the Media icon and text equivalent.

Following the creation process of the new Bio, the user may typically, but not necessarily, enter a range of dates to define the parameters of the new Bio. To define date parameters for the new Bio, the user may select to open the Date menu 366 for the Memory Collection submodule through selection of the Date button 367, for example. The Date menu may facilitate an optional step to add a Start Date in the Start Date text entry field 368 and End Date in the respective End Date text entry field 369 for the new Bio being created. In the example implementation shown, the creating user may have the option to select “Present” for the End Date of the new Bio, for example. A Bio with a Present End Date may have its End Date updated regularly to stay up to date with the current date. The user may also have the option to edit the Privacy Settings of the new Bio to include or exclude connections or other users based on relevant preferences, similar to the process of new posts, discussed further in relation to FIG. 14. The user may open the Privacy Menu from the Privacy button 370, for example, whereby the Privacy Settings of the new Bio may be edited. It is noted that there may be no advanced Privacy Options within Privacy Settings for the new Memory Collection, as there may be for a new post, described further in relation to FIG. 14.

When completed, the user may select the Create button 371 to finalize the new Bio, close the Memory Collection Creation module, and Tag the new Bio in the new Memory. If the user desires to discard the new Bio, the Cancel button 372 may be used to cancel the creation of the Memory Collection and close out of the Memory Collection Creation module. The new Memory may be cancelled during this step of Bio creation if desired, through the selection of the Close button 373, which closes the Memory Creation module and cancels the creation of the new post.

Following the selection of the Memory Collection button, the Media section of the Memory Collection Creation module may be opened for the parallel Memory Collection Creation function. The new Media creation process may have a similar title entry process to that of a Bio, though the system may attempt to auto-complete the entered text as an existing Media Entity selected from a system database. If the Media Entity is selected from the system, and the relevant content is available to be fetched by further systems, the representative picture and/or text description of the new Media Entity may be filled in automatically. Furthermore, in one example implementation, the creating user may become a “Linked” user under the new Media on all corresponding existing Media pages when the Tag is created. An optional representative Media Picture and text description may be added or selected, similar to that of a Bio. It is to be noted that Media Entities do not have the ability to add a Subtitle along the lines of a Bio in the manifestation of the presented sample module shown in this figure.

Following the Media Creation process, Media may have a Category Selection button in place of the Date and Privacy buttons of the Bio Creation submodule. The user may, or the system may automatically, select a category for the new Media Entity, each represented in the Category menu. This Category menu is opened following the selection of the corresponding Category button. When Media category selection is facilitated by the user, the Category may allow the creating user to select the category, or multiple categories, of the Media Entity they are creating manually.

FIG. 14 continues the Memory creation process from the Privacy button selection of FIG. 9, presenting an example Memory Creation module GUI screen 380 with the Privacy menu 381 displayed. The multiple Privacy options accessible to the user function in accordance with relevant aspects of the present disclosure, as referenced in box 50 of the representative flow diagram of FIGS. 8a-8b. The Privacy menu may be displayed beneath, or beside, the Privacy button 382 within the Memory Creation module, for example, when selected by the user. In an example implementation, the user may then be presented with three privacy options within the Privacy menu. The user may select the “Only Me” button 383 to designate the creator as the only user who may see the new post, unless they add Connections to be included in the new post Privacy Settings. The user may include a Connection in post Privacy Settings by entering their name in the Include text entry field 384, ensuring the included user(s) are able to view the corresponding post.

Continuing the Privacy selection of the Privacy Settings menu, the “Connections” button 385 may be selected by the user, resulting in opening a corresponding section such that only Friends of the user may be selected and enabled to view the new post once it is created. The terminology “Friends” is not meant to be limited to the grouping of users discussed in the example of this section of this Detailed Description. The Connections section of the Privacy Settings menu may function similarly to the “Only Me” section of the Privacy Settings menu, though the Connections section version may have an additional Exclude text entry field, for which Connections may be excluded from the Privacy of the new post (similarly to how they may be added to the Include text entry field discussed above).

Alternatively, the user desiring to share their post with all users may select the “World” button 386 to open the corresponding section of the Privacy Settings menu so that all users may view the new post. The “World” section of the Privacy Settings menu may function similarly to the “Only Me” section of the Privacy Settings menu, though instead of an Include text entry field, an Exclude text entry field may be present, such that users may be excluded from the Privacy of the new Memory.

After selecting a Privacy Setting, the user may interact with the Advanced Privacy Options 387 to utilize functionality for editing Privacy options surrounding the corresponding post, including cancelling corresponding systems from adding the new post to any Newsfeed (or similar) pages where such feed may appear otherwise. Newsfeed pages and their related content are discussed further in relation to FIG. 26. The user may select the option to remove allowance to post to Newsfeeds through a corresponding Post-to-Newsfeed button 388, for example.

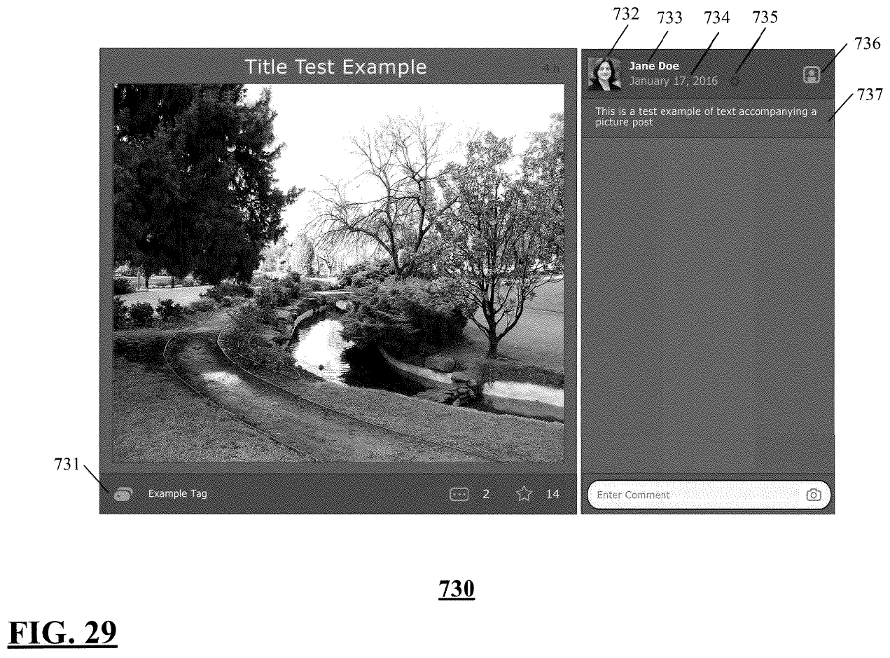

Further, the user may select from two other Privacy options for the post, through their corresponding Allow Stars button 389 and Allow Comments button 390. The Allow Stars button allows the user to remove the ability for the post to receive Star Responses, discussed further in relation to FIG. 29, and the Star Responses that already exist on the post, if any, may thereby be removed. The Comment button may allow the user to remove the ability for the post to receive Comments and may remove Comments that already exist on the post, if any.

Continuing the Memory creation process of FIGS. 8a-8b, FIG. 15 presents a sample Timeline page GUI screen 400 with a new post 401 aligned to be positioned on the Timeline after date selection is finalized. As a default, after date selection is completed and the Timeline is opened, the new post may be automatically positioned within its potential date range criteria, as discussed above in relation to FIGS. 8a-8b, allowing the user to reposition it amongst posts that also occur within the corresponding criteria. Posts in this accessed form of Timeline may display a picture thumbnail 402 or representative picture, for example, such as a Profile Picture, along with date-criteria 403. As shown in this example, above the relevant date-criteria may appear the title 404, text preview from content, or nothing if neither exist. For posts surrounding the positioning post, Comments 405 and Star Responses 406 may be displayed for user guidance, as well.

In an embodiment of the present disclosure, the positioning post may have a positioning icon 407 that appears, for example, to the left of its information, as shown, displaying that it may be repositioned, or that the position does not work with the entered date-criteria, based on bordering posts, for example. In the example implementation shown, icon 407 is displayed, showing that the position is viable, but also representing the ability for movement. If the position is not suitable, the positioning icon may display an alternate form icon.

The user may then position the post with displayed relevant information to finalize and create the post in its position. Finally, the user may select the Done button 408, creating the post in the exact determined position for the placement of an Estimated Date.

### Progressive Profile

In an example implementation in accordance with aspects of the present disclosure, viewing a Timeline by scrolling through displayed Memories may trigger an accompanying profile, hereinafter referred to as “Progressive Profile,” which may appear alongside its corresponding Timeline. As the user scrolls through Timeline, Profile Pictures, and Profile Descriptions in Progressive Profile, for example, two types of entities representing the viewed Timeline user may appear as being relevant to the appropriate range on the Timeline during Timeline navigation. In the context of this aspect of the present application, the “appropriate” range may be determined, for example, based on Estimated Date systems and ranges created amongst posts on the Timeline.

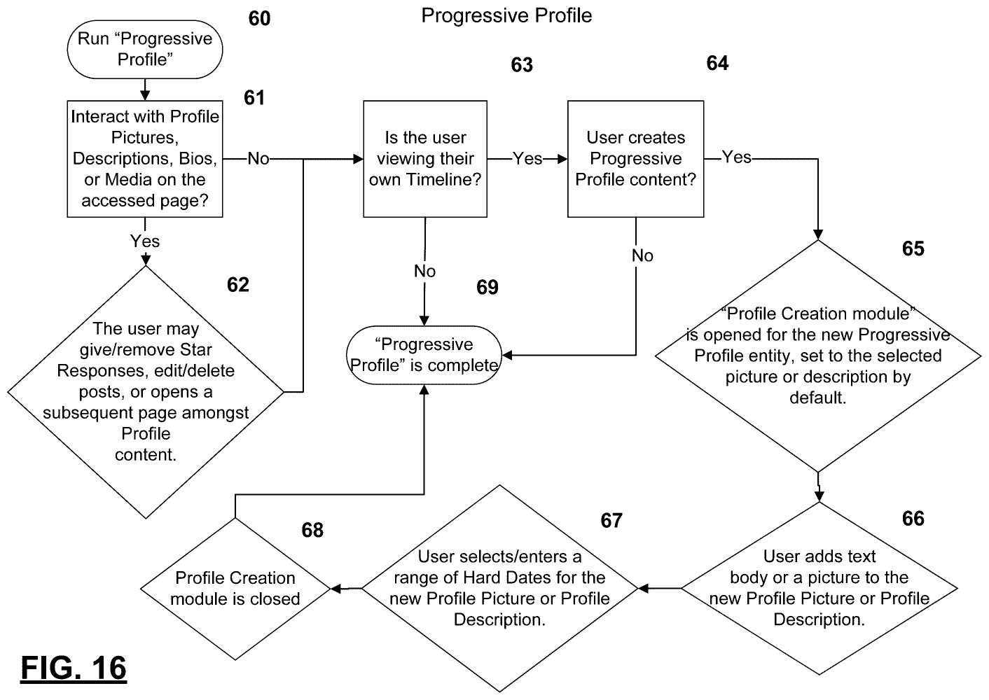

For example, within the process of Page Interaction of FIGS. 20a-20c, opened from the representative flow diagram of FIGS. 1a-1c, Progressive Profile interactions, including creation of content, may occur, such as along the lines shown in the example implementation of the FIG. 16 flow diagram. In FIG. 16, at 60, the user may begin interaction with a displayed Progressive Profile accompanying a Timeline. “Beginning interaction” may include the viewing of content or modules contained within Progressive Profile with intent to select, create, edit, or otherwise leave a response or noted interaction, for example. The user may display intent (or not) to give, or remove, Star Response acknowledgements, edit post status, or open pages at 61. Following the aforementioned intent, the desired user interaction(s) is(are) carried out at 62, which may be manifested in many ways as explained further below.

In one example implementation, the user may leave or remove an interactive Star Response, or other notation for “liked” content, for Profile Pictures, text Profile Descriptions, Media entities, or other content type displayed within the accessed Progressive Profile, for example. Continuing interactions on Progressive Profile content, user Comment creation and editing of posts may be facilitated. Further, for example, as shown at 62, pages may also be opened from users, Bios, or Media Entities displayed in the Progressive Profile, which may display a new Progressive Profile to continue allowance of Progressive Profile interaction.

Continuing interactions with a displayed Progressive Profile, at 63, Profile content may be created by the user, which may vary depending on, for example, whether they are viewing their own Timeline, or not, at 64. The user may select the option to create new Profile content on their Timeline; then at 65, the Profile Creation module may be utilized, where options to create new Profile Pictures or Profile Descriptions may be displayed for the user, among other functions. Continuing the creation of Profile content for the user's Timeline, at 66, the user may add a picture from their networking device for the new Profile Picture, or the user may add a text body for the new Profile Description, respectively.

Continuing the creation of new Profile Pictures or Profile Description, the creating user may (or must in some implementations) enter or select a range of dates at 67 to define where the corresponding new entity aligns alongside its corresponding Timeline, between the Timeline's Start and End Dates. It is noted that, for example, the dates entered by the user for the Profile entity may have full dates with day, month, and year included. Then, the user may select to finalize the creation of the new Profile Picture or Description, triggering at 68 closing of the Profile Creation module, or other open Profile modules. Finally, the Progressive Profile interaction may be completed at 69, finalizing user interactions, including the creation of new Profile content.

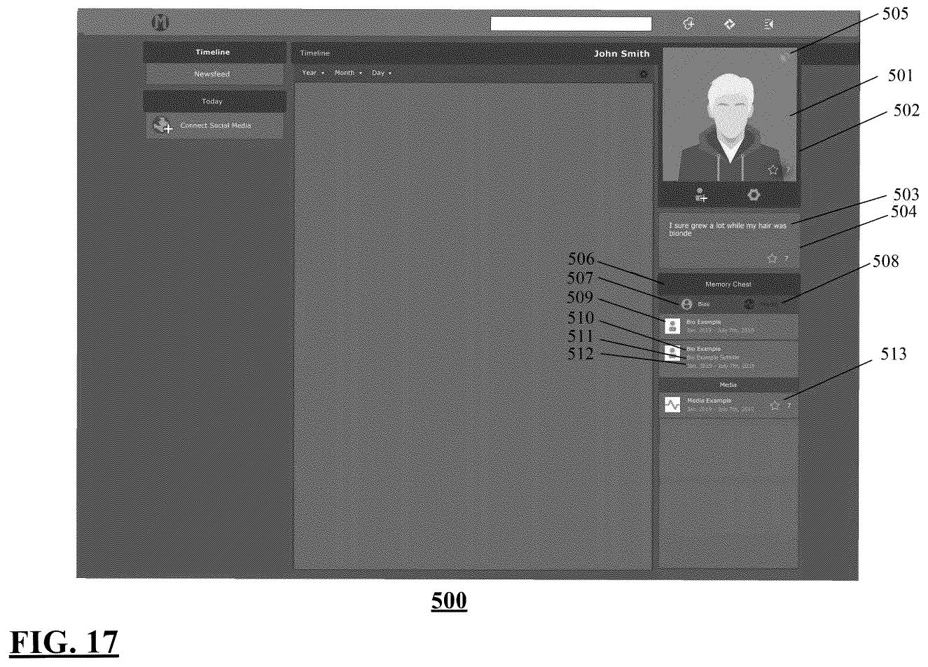

FIGS. 17-19 illustrate example GUI screens accompanying interactions described above in FIG. 16. Opened from the Progressive Profile box 81 of the representative flow diagram of FIGS. 20a-20c, FIG. 17 depicts a sample GUI Timeline page 500 where example Progressive Profile content is displayed in Region Three. The system may determine what content appears on the Timeline page in its initial position upon opening. It is noted that in an example implementation, posts on the Timeline may set corresponding Checkpoint Dates, which in turn may determine what Progressive Profile content appears alongside the associated Timeline. A user Profile Picture 501 for the viewed Timeline appears in the Profile Picture module 502. Profile Pictures may be displayed when the Profile Picture Date Range criteria align with a determining algorithm, for example, such as in relation to posts on the viewed Timeline.

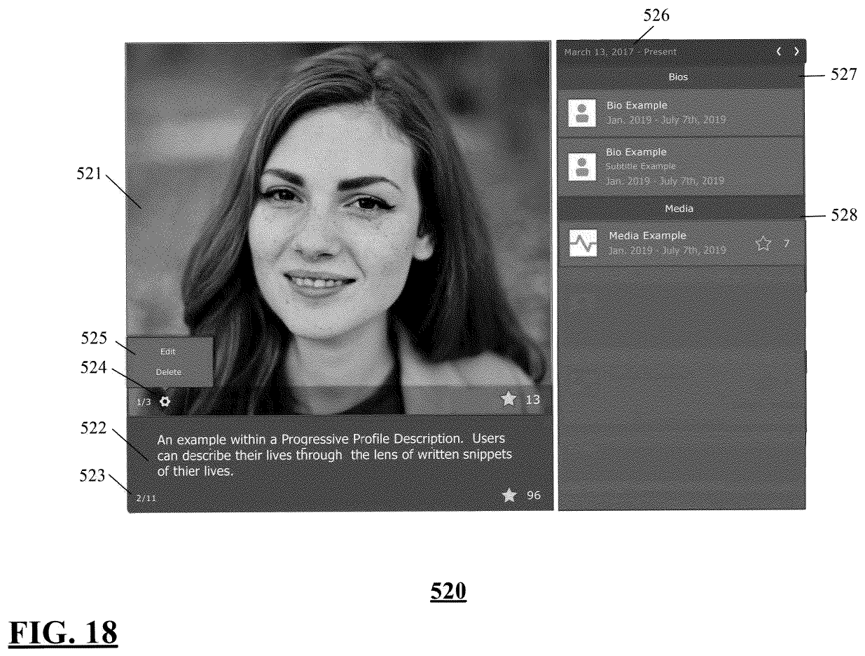

Continuing the systematic display of content, a Profile Description 503 for the viewed Timeline may be displayed in the Profile Description module 504. Multiple Profile Pictures or Descriptions may appear in one position on the Timeline, where they may be cycled through or selected in order to open the expanded Progressive Profile. When an expanded Progressive Profile is opened, it may be routed to the section that overlaps the selected picture/description date range, discussed further in relation to FIG. 18.

Following the display of Profile Pictures and Descriptions, if there are multiple Profile Pictures in the Profile Picture module, or multiple Profile Descriptions in the Profile Description module, the Multiple Entity icon 505 may appear, for example, in the upper right-hand corner of the corresponding module. The user may select a picture/description while there are multiple items to cycle through them. The user may also, for example, double click a Profile Picture or Description to open the expanded Progressive Profile. In this example implementation, the user may edit or delete Profile Pictures/Descriptions from the expanded Progressive Profile.

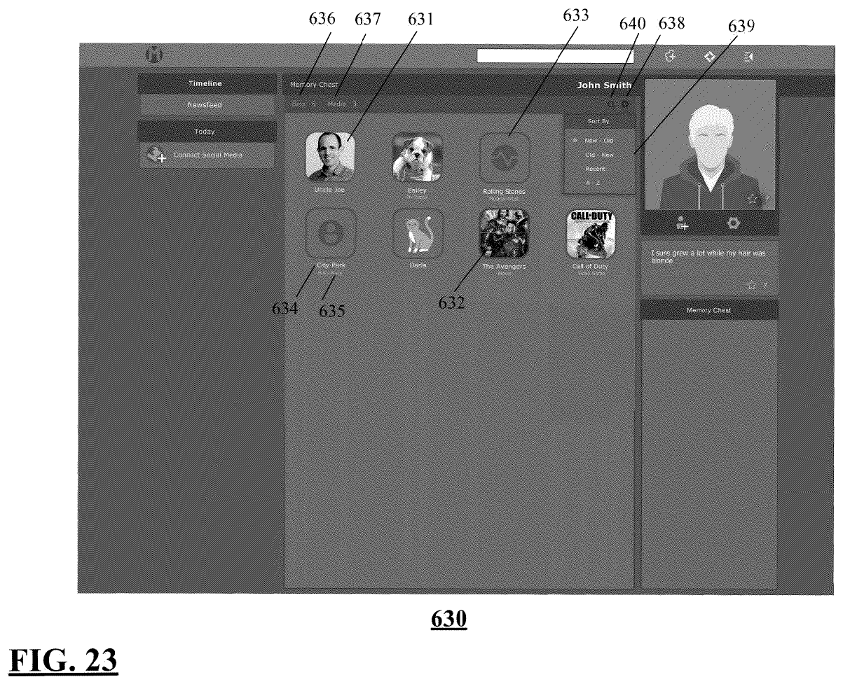

Further, the Timeline may have a Memory Chest module 506 that sorts and displays Memory Chest entities, such as Bios and Media, alongside the Timeline navigation. In this example implementation of the present disclosure, the Memory Chest module may function as a selectable button, opening the corresponding Memory Chest page when selected by the user, discussed further in relation to FIG. 23. In this example, this Memory Chest module is broken into two subsections, which may, for example, appear directly beneath the Memory Board Heading Bar. The primary subsection of Memory Board may be for Bios, accessible by selecting the Bios Section button 507. The Media subsection of Memory Board may be accessible by selecting the Media Section button 508, thereby moving a list of the Media Entities in the viewed Progressive Profile Section to the top of the Memory Board, for example. If no Bios have date-criteria overlapping the date range of the viewed Progressive Profile Section, but Media entities do, the Media subsection may open by default. It is noted that below the final Bio displayed in the Bio subsection of Memory Board there may be the beginning of the Media subsection for this example.

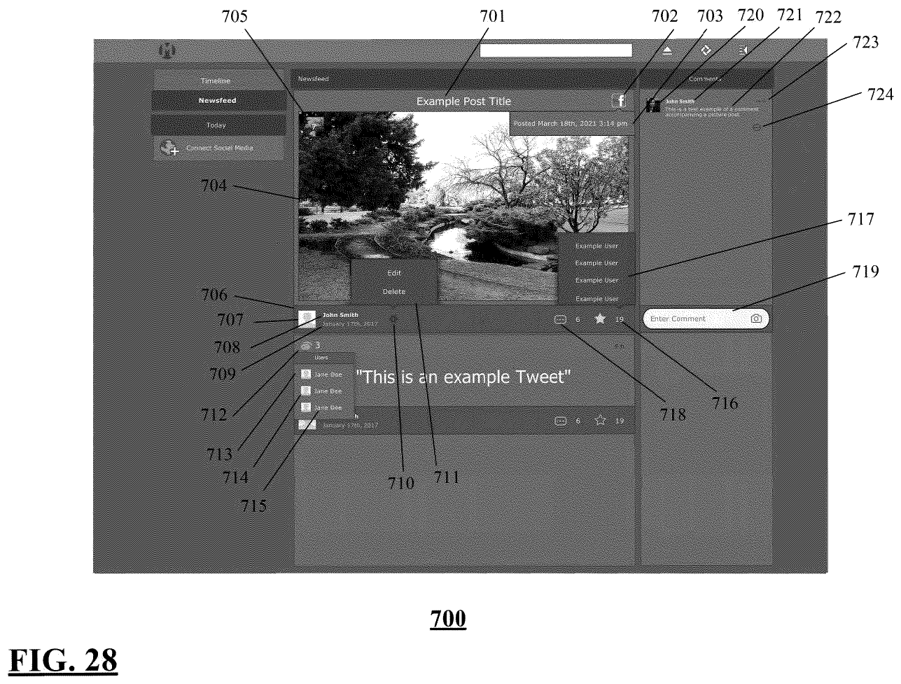

Continuing the loading of content within Progressive Profile, Bios may be displayed in the Bio subsection, with each corresponding Bio Picture 509 to the far left, for example, as shown. Directly to the right of the representative picture for each Bio, for example, may be the corresponding title 510, Subtitle (if it exists) 511, and the range of dates 512 between the Start and End Dates of the Bio. In the depicted example Progressive Profile in Region Three, a Media entity is shown as available to be viewed, so it appears beneath the displayed Bios, under a Media Subheading Bar. Media Entities may be systematically displayed like Bios, with their corresponding Media Picture to the far left, as shown for example, and appearing beside the Media title and Media date range, to the right. Continuing the display of Progressive Profile content, on the far right of each displayed Media entity, as shown, is the Star Response button 513 and a numerical count of Star Responses the corresponding Media Entity has received. The Star Response button and its general functionality is discussed further in relation to FIG. 28. The user may select displayed content, such as a Profile Picture, Profile Description, Bio, or Media entity within the accessed Progressive Profile.

Continuing user interaction from the selection of a Profile Picture or Description of FIG. 17 Timeline Profile, FIG. 18 depicts an example GUI Expanded Progressive Profile 520. The Expanded Progressive Profile may, for example, display the corresponding Profile Picture 521 and Profile Description 522 that was displayed on Timeline when the Expanded Progressive Profile was opened from user selection. It is also a possibility that the Profile Picture and Description displayed correspond to an Expanded Post from which it is opened, as discussed further in relation to FIG. 29. A positioning fraction 523 may exist for both pictures and descriptions in corresponding corners, for example, showing the total number of corresponding pictures or descriptions and which one is displayed currently for viewership. Following the display of the expanded pictures and descriptions, for example, the user may be cycled through Profile Pictures and Descriptions in the displayed section, such as if multiple exist in the displayed Progressive Profile Section, by hovering over the entity and selecting the corresponding left or right arrow that may appear.

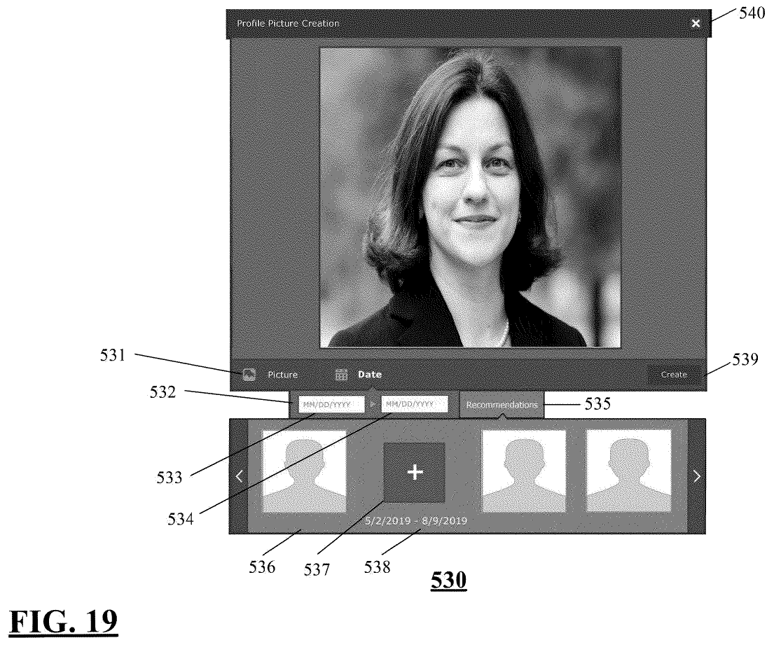

In the example implementation shown, if the user is hovering over a picture or description, the Profile Options button 524 may appear directly to the right of the corresponding positioning fraction, for example, which when selected may open the Options menu 525. Following the selection of the Profile Options button, the user may have options for various selections, depending on whether they are viewing their own Progressive Profile or not. In the example shown, the accessing user is viewing their own Progressive Profile Section, as they have the options to edit the displayed Profile Picture or delete it with the corresponding buttons, which may both be accessible from the Options menu for Profile/Current Pictures and Descriptions, for example. Editing Profile Content may reopen the proper Profile Creation module of FIG. 19 description.

Following the opening of the Options menu, for example, the user may delete one of their Profile Pictures or Descriptions, triggering the system to remove it from the corresponding Progressive Profile and Profile Section, thereafter updating the Expanded Progressive Profile to display the next-oldest corresponding Profile Picture or Description in the displayed section, for example. In the example presented Progressive Profile, the Picture or Description that appears after the deleted one may expand if only one entity type exists, for example. Following the deletion of a Profile Picture or Description, if no Profile Pictures or Descriptions exist to be viewed, the system may determine if a new Progressive Profile Section may be displayed or created. Also, if a new Progressive Profile Section is not displayed or created, it is possible the Expanded Progressive Profile may be closed, based on, for example, what entities still exist on the corresponding Timeline to be viewed by the user.

Following the opening of the Options menu, a user viewing a Progressive Profile they do not own may have the selection option to Report the Profile Picture or Description, such as via use of a corresponding text button. The Options menu functions similarly for Profile Pictures and Profile Descriptions.

The Progressive Profile Section date range 526 is shown in this example as displayed at the top of the Memory Board subsection of the Expanded Progressive Profile. Continuing user interactions with Progressive Profile, the user may select the Progressive Profile Heading Bar arrows to cycle to the next-oldest and next-newest Profile Sections.

If a Bio is present in the Expanded Progressive Profile Section, a Bio Subheading Bar 527 may appear, and Bios may be displayed directly therebeneath, for example, similarly to the Memory Chest module of FIG. 17. If a Media Entity is present in the Expanded Progressive Profile Section, a Media Subheading Bar 528 may appear, for example, underneath the Bio Subheading Bar, if it exists, with Media Entities displayed beneath. Bios and Media Entities may be scrolled through as one descending list. The user then may interact with, or navigate through Progressive Profile entities.

Continuing Progressive Profile interaction with selection of the Profile Options button 524 of FIG. 18, FIG. 19 depicts an example Profile Creation module GUI screen 530, as it may appear on a page, set to the Profile Picture section. The depicted Profile Creation begins functionality in accordance with aspects of the present disclosure, as referenced in box 65 of FIG. 16. The user may select the Profile Creation Type button 531 to switch between Profile Pictures and Profile Descriptions to create various content, for example. Following the selection of the Profile Creation Date button, the Profile Picture Date menu 532 may be opened and displayed, offering similar functionality for Profile Pictures and Descriptions. The user may continue creation of the new Profile entity by adding a Hard Date Start Date in the corresponding text entry field 533 and End Date in its corresponding text entry field 534, as also referenced in box 67 of FIG. 16. The date parameters may assist the new Profile Entity being created, to clearly designate when the corresponding Profile Picture or Profile Description overlaps its associated Progressive Profile and Timeline, for example. In an example implementation, if the current date is entered in the End Date text entry field, the creating user may have the option to select “Present” for the End Date of the new Profile Picture or Profile Description. A Profile Picture or Profile Description with a present End Date may have its End Date updated regularly to stay up to date with the current date.

The user may select the Recommended Ranges button 535 to toggle open the Recommended Ranged submenu 536, for example. The Recommended Ranges submenu may display ranges of dates between existing Profile Pictures, if the user is creating a Profile Picture, or between Profile Descriptions if the user is creating a Profile Description, for example. Recommended Ranges may also just be displayed as years along the Timeline if little content exists. In one example implementation, the Recommended Ranges submenu may be used to assist users in filling the space between existing Progressive Profile entities on their Timeline.

Continuing creation of a Profile Entity, the user may select a Recommended Range 537, and the system may fill in the Start and End Date date-criteria for the new Progressive Profile entity from the displayed recommended date range criteria 538. It is noted that Profile Pictures may not overlap the date ranges of other Profile Pictures, while similarly, Profile Descriptions may not overlap the date ranges of other Profile Descriptions. If the user chooses dates that may cause overlap, the dates of the existing Progressive Profile content may be changed to reflect the new dates entered. If a Profile Picture or Description may be totally overlapped, it may be deleted (e.g., automatically) when the Profile Entity is finalized.

Appearing to the far left and right of the Recommended Ranges submenu, as shown in this example implementation, are Left and Right arrow buttons, which may, for example, allow cycling through the Recommended Ranges submenu when selected, such as left and right, respectively, to display newer and older ranges for additional selection. If there are not enough Recommended Ranges to fill the submenu, the Left and Right arrow buttons may not appear to the user. When finished, the user may select the Create button 539 to finalize the new profile entity, with the Close button 540 being usable to cancel the creation and close the creation module, for example.

Following the selection of the Profile Creation Type button, the Profile Creation module may be opened to the Profile Description section. Profile Description creation functions similar to that of Profile Pictures, except there is a text entry field for the text description instead of a picture selection function. Further, the dates used to form recommended and occupied date ranges may only be related to Profile Descriptions on the user's Timeline, instead of Profile Pictures.

### Page Interaction

In an example implementation, user interactions with the system may start from an overarching page, or a component routed to from a hub page.

FIGS. 20a-20c present a representative flow diagram of example page interactions within an example system, in accordance with aspects of the present disclosure. It is to be made clear that the presented and discussed page types are example in nature and are not intended to limit all possible pages and display options within the present disclosure. Starting at 70, a page may be queued to be opened or refreshed by the accessing user. The page selected by the user, prior to opening in the representative flow diagram of FIGS. 20a-20c, is opened, or refreshed if it is already open, at 71 to be displayed and interacted therewith. Then at 72, the system checks what page type the user is accessing. Continuing page display and interaction, posts may be displayed, for example, in order of their Estimated Date, newest first, at 73 for many page types. For corresponding pages, Profile Pictures, Profile Descriptions, Commentary Posts, Bios, and Media Entities may be displayed based on system determinations, for example, with newer items appearing over top of older ones. It is noted that posts and content, in this example implementation, may only appear for viewing users that are included in the corresponding Privacy settings of the displaying user.

Shown at 74, the system may check to see if the accessed page is a Memory Chest page, which may, for example, be opened from an accessed Timeline. Then at 75, if the accessed page is a Memory Chest page, the system may order (e.g., by date) all Bios and Media contained within the accessed Memory Chest, newest to oldest (by End Date). In the example implementation shown, the newest Progressive Profile Section may display the accessed Timeline during viewership of the Memory Chest page.

At 76, the system may determine that the accessed page is a Newsfeed page, thereby further determining (assuming relevant user selectable settings are set) to display all Memories made by Friends of the accessing user, ordered by recency of creation, for example. From displayed pages, the user may be given the option to open a page from the corresponding page title, button or icon, such as a Timeline from a selected (other) user's name. The user may then open a page at 77, rerouting the user to step 71 in the accompanying representative flow diagram.

In this illustrative example, a post is displayed with accessible interactions for the accessing user, for which they have the option to interact with one of the corresponding posts at 78. Embodiments of direct post interaction in accordance with aspects of the present disclosure, as described further in relation to the representative flow diagram of FIGS. 27a-27b, are represented at 79. Then, at 80 the user may interact with a Progressive Profile if it is present and accessible, therein routing to 81 for interaction. If the user chooses to interact with a page, or related component, other than a contained post or a Progressive Profile, they may be given the option at 82 in which, if the accessed page is still open, the user may initiate further interactions at 83 until they conduct an operation to change access to the page or other potential variables change. Page interactions may next be completed at 84.

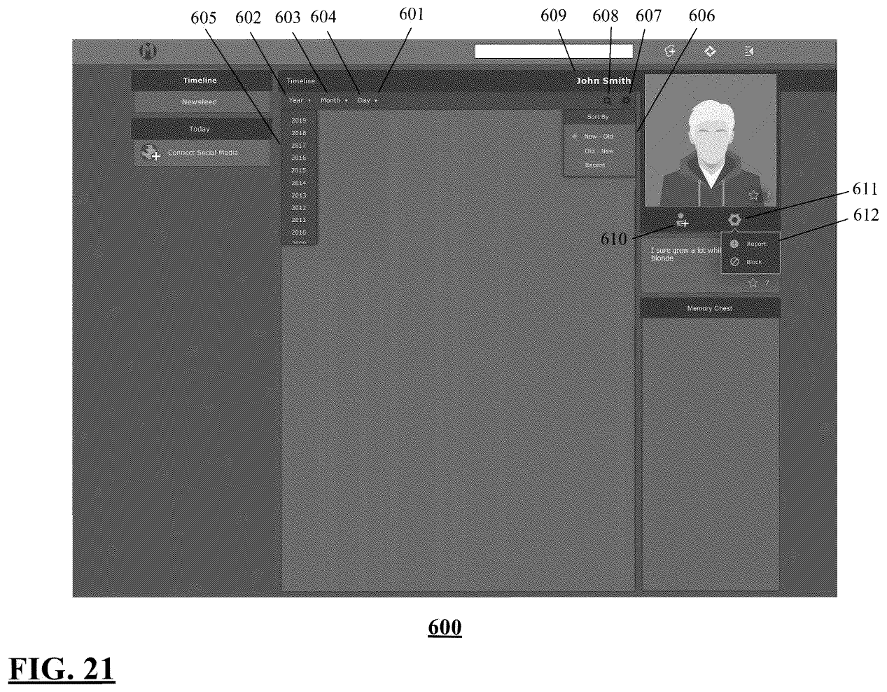

FIG. 21-26 depict example GUI screens representing interactions with pages throughout an example system in accordance with aspects of the present disclosure.

FIG. 21 depicts a sample Timeline page GUI screen 600, accessed by a user that is not the Timeline owner, nor Friends with them. Timeline pages in this example implementation of a system may be opened from the selection of Timeline from the Navigation module of FIG. 2 or via selection of (another) user by an accessing user. The user may then navigate the viewed Timeline posts with selection, for example, of the Date Navigation module 601 (potentially integrated into Timeline Subheading Bar), comprised of three buttons in this example, opening corresponding menus: the Year button 602, Month button 603, and Day button 604. Once the selection is made, each button may display the corresponding selection date information. The user may open the Year menu 605, accessed through selection of the Year button, for example, which may then allow the user to select a listed year to navigate the viewed Timeline. It is noted that in this example implementation, Timeline navigation may be based on selected date-criteria and available metadata of posts on the corresponding Timeline, as determined by various system functions. Aforementioned metadata may include Estimated Dates of posts, Checkpoint Dates determined from Estimated Date systems, and all date ranges of Progressive Profile content.

Next, the user may select and interact with the Month menu in a similar fashion to the Year menu described above, displaying, for example, months and seasons for the user to choose from, opened through selection of the Month button. The Day menu may function similarly to the year and month menus, for example, displaying a list of days to choose from to navigate the viewed Timeline, opened through selecting the Day button when a year and month are selected from the Date Navigation module. It is noted that, in the example implementation shown, if a season has been selected, a day may not be selected.

Continuing user interaction, the user may select to display the Display Options menu 606, opened from selection of the Display Options button 607. The Display Options menu may, for example, allow the displayed Timeline posts to be organized “New-Old,” “Old-New,” or “Recent.” “New-Old” and “Old-New” referencing the Estimated Dates of corresponding displayed Posts, where “Recent” references the creation date of the displayed posts. It is noted that, in the example system shown, a selection may be designated with a Selector icon to the left of the selection.

The Search button 608 may appear for selection in the Subheading Bar, such as in this example implementation, when the user is hovering a cursor over the Subhead Bar with the mouse or other selector/input device. Selecting the Search button may open a text entry field in place of the Search button, such as to the left of the Display Options button. When selected, the opened text entry search field may allow the user to search the corresponding Timeline, filtering all displayed post content by search-criteria, for example. In the example implementation shown, the name 609 of the viewed Timeline appears to the far right of the Heading Bar for designation of the Timeline.

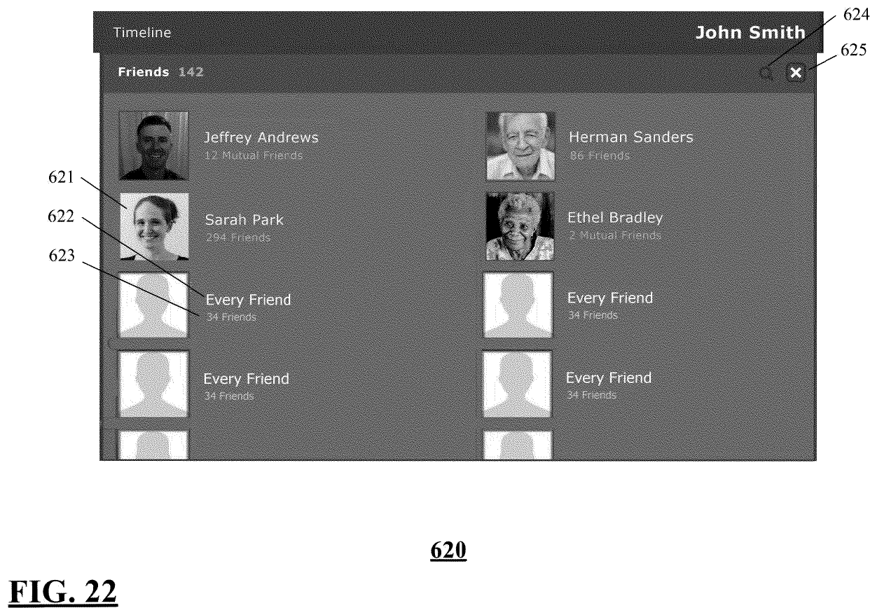

The Connection button 610 that appears in the example depiction shown may have different manifestations based on the accessing user's relationship to the viewed Timeline. In this example, 610 Connection button is shown in a “Request” manifestation, which may send a Friend Request when selected, appearing to users that are not current Friends with the Timeline owner, for example. The Connection button in its “Connected” manifestation, not shown, but having a differing icon format from button 610 may alternatively be displayed when the accessing user has been categorized by the system as Friends with the viewed Timeline owner. The user may select the Connection button (Connected Form) to remove the Friendship (pending or completed). The Connection button in its “Owner” manifestation, not shown, but having a differing icon format from button 610, may be displayed when the accessing user is the viewed Timeline owner. The user may select the Connection button (Owner Form) to open the Friends module, discussed further in relation to FIG. 22.

Continuing Timeline interaction, the Profile Options button 611 may appear to the right of the Connection button, as shown, for example, in this illustrative implementation, with varying functions depending on the accessing user's relation to the accessed Timeline. If a user is viewing their own Timeline, for example, selection of the Profile Options button may open the Profile Creation module to enable creation of a new Profile Picture or Description, for example, as discussed further in relation to FIG. 19. If the user is viewing another user's Timeline, in this example implementation, the Profile Options menu 612 may be opened from the selection of the Profile Options button, thereby displaying the options to Report or Block the Timeline. Selecting the Report or Block options may send a report for appropriateness or block the Timeline content, thereby logging the “Block” in the user's settings, for example, based on the selected button.

Continuing Timeline interaction, FIG. 22 depicts an example GUI Friends module 620, accessed, for example, through selection of the Connection button (Owner Form) of FIG. 21, while the accessing user is accessing their Timeline. Friends of the accessing user may typically be displayed in descending order (e.g., by date order of when they became Friends (in this example, Friends are displayed in rows of two, organized alphabetically, a-z). Above the appearing Friends in this example is a Subheading Bar with the title “Friends,” followed by a count of Friends the accessing user has. Friends may be displayed with a representative picture 621 (e.g., the newest Profile Picture), name 622, and numerical count of Friends 623, or mutual Friends they share with the user.

The user may then select the Search button 624, which as shown in this implementation appears to the far right of the Subheading Bar of the Friend module, which may then open a Search text entry field. When the user enters search criteria, the system may filter the displayed users by Search term relevance in the Friends module. The user may select the Close button 625 to close the Friends module, for example, and return the viewed Timeline to the way it appeared prior to opening the module.

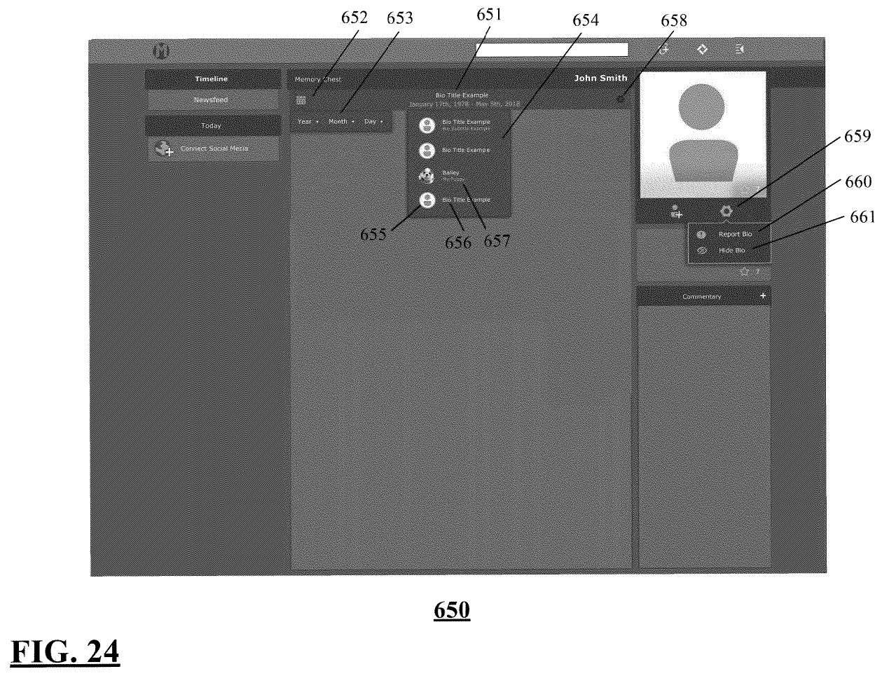

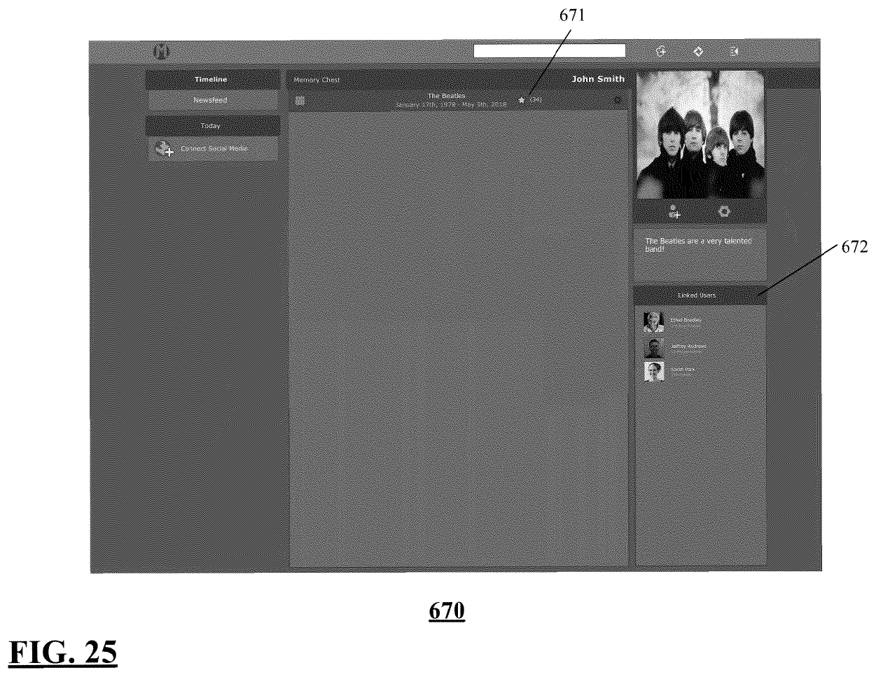

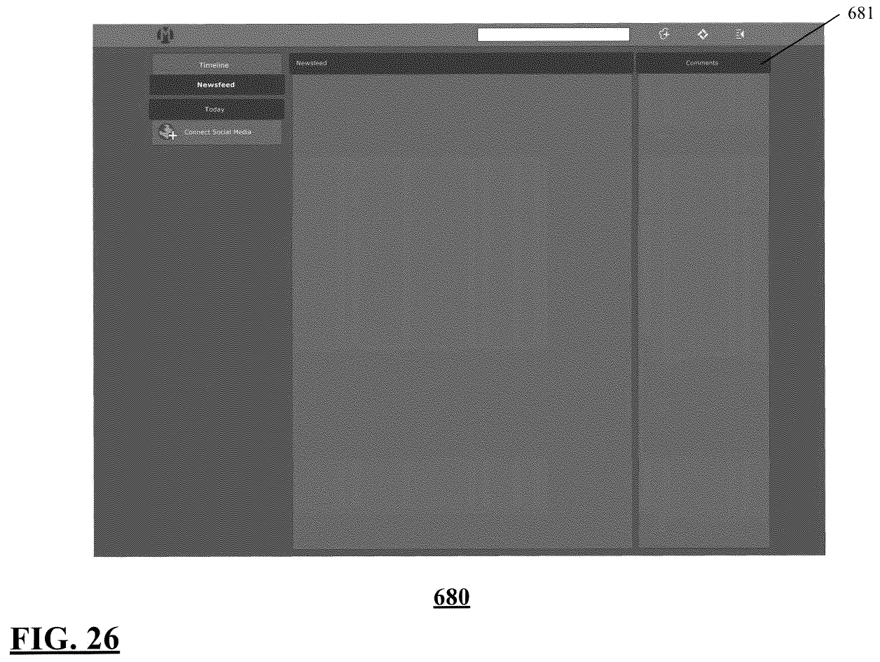

A sample Memory Chest page 630 is depicted in FIG. 23, as it may appear in this example implementation when opened by selecting the Memory Chest button of a corresponding Timeline origin page, as depicted in FIG. 21. When opened, the system may display, for example, all Bios and Media Entities within the viewed Timeline chronologically, with the most recent End Dates shown first in this illustrative GUI screen. The displaying of Memory Chest entities may involve a process that could occur in one of many different possible implementations in accordance with related aspects of the present disclosure at box 75 of the representative flow diagram of FIGS. 20a-20c. In this example, Bios have a representative picture 631 (e.g., a corresponding Bio Profile Picture), while Media entities may display the representative Media Picture 632. If a picture does not exist to be displayed, a placeholder image 633 may be displayed in lieu of a picture (e.g., a single icon may be used for each user not having a picture; or different icons can be selected for each user without a picture). Beneath each Bio and Media entity may be shown the corresponding title 634, and subtitle 635, if such exists. The user may select any suitable Bio or Media entity to open the corresponding Bio or Media page, along the lines as discussed further in relation to FIGS. 24 and 25.

Continuing Memory Chest interaction as shown, the Subheading Bar beneath the main Heading Bar of the viewed Memory Chest page displays a Bio Section button 636 to the far left, with a count of Bios in the viewed Memory Chest visible to the accessing user (as long as there is at least one). To the right of the Bios Section button the Media Section button 637 is shown, with a numerical count of the amount of Media entities in the viewed Memory Chest visible to the accessing user, for example, as long as there is at least one. In this example, the user may select the Bios or Media section to filter the page and view only the selected entity type.

The Display Options button 638 may, for example as shown, appear to the far right of the Subheading Bar on the displayed Memory Chest page. Selecting the Display Options button may open the Display Options menu 639 with selections to organize the viewed Bios and Media Entities: “New-Old,” “Old-New,” “Recent,” or “A-z” [Alphabetical]. The New-Old organizational selection may sort the viewed entities by the recency of their End Dates, newest first, for example, while the Old-New selection may organize the viewed entities by their Start Dates, oldest first. The user may also select to organize entities by their recency of creation through the selection of the Recent sorting selection or by title alphabetical order (a-z) through the selection of the A-z [Alphabetical] button, for example. If there are “ties” in the order of any entity regarding their organizational method, ties may be broken, for example, by recency of creation (Post Creation Date). A Selector icon may appear, as shown in this example, to the left of the selected organizational method, representing a selection being identified. Typically, the New-Old sorting option may be selected by default, as described above. It is noted that the Display Options menu may function similarly to how Bios and Media are displayed on this example implementation, as it may when only one entity type is available. To the left of the Display Options menu as shown, the Search button 640 may appear, functioning similarly to as it may on Timeline, allowing the user to search the displayed entities by text search-criteria, for example.

Continuing the selection of a Bio from a previous screen, such as shown in FIG. 17, FIG. 24 depicts an example Bio page GUI screen 650 maintained within the Memory Chest of an accessed Timeline. The Bio title 651 is displayed in this example in the center of the Subheading Bar of the displayed page, with its subtitle appearing directly below, if one exists. Beneath the title, and subtitle, if it exists, the full date range parameters of the Bio may appear, either as set by the creating user through FIG. 13 functions or as determined by the Estimated Dates of the oldest and newest posts in the viewed Bio, for example, which constitute the Bio Start and End Dates.

Continuing Bio interaction, appearing to the far left of the Subheading Bar as viewed in the Bio page of this example in FIG. 24, is the Date Navigation button 652, which may open the Date Navigation module 653 when selected, functioning similarly to as functions on the Timeline when opened, as discussed in relation to FIG. 21.

The user may select the Bio title to open the Bio Navigation menu 654, displaying other Bios in the displayed Memory Chest, organized by recency of End Date, newest first. Each Bio Navigation Bio may have a representative picture 655 (e.g., a corresponding Bio Profile Picture) to the left as shown in this example implementation, with the Bio title 656 to the right and displaying subtitle 657, if such exists. It is noted that if the accessed Bio shown is the only one in its Memory Chest, the Bio Navigation menu may not be opened.

Next, to the far right of the Subheading Bar, as shown, is the Display Options button 658, which may function similarly as it may for Bios as on Timeline, as discussed further in relation to FIG. 21. In this example implementation, hovering the cursor using a mouse or other selector tool/input device, in the space directly to the left of the Display Options button, may bring up the Search button, functioning similarly to as it does on Timeline, also discussed in FIG. 21 description. It is to be noted that in some embodiments, the Search button may appear without need for hovering, or any other interaction. The user may select the Bio Options button 659 to open the Bio Options menu when selected by the user, in this case appearing as a drop down. The Bio Options menu may give the visiting user the option to either Report the Bio, through the selection of the corresponding Report button 660, or Hide the Bio through the selection of the Hide button 661. The Report button 660 may function similarly as it does for user Timeline functions when selected, where a report is sent for appropriateness to a manual or automated management process for the system of the present disclosure. Continuing, the Hide button provides a selectable option to hide the Bio, and any posts the Bio are Tagged as from the user when selected, removing them from anywhere they currently may be viewed. It is to be noted that selecting the Hide button may result in removal of any Comments, Tags, or other interactions the user has had with the viewed Bio or any posts within the viewed Bio.

The user, if they are a Bio owner, may have similar options to add Profile Pictures and Descriptions from the Bio Options menu as they may have for their own Timeline; however, in the example implementation shown, only one Profile Picture and one Description may be set at any time for the Bio. An additional option may appear for the Bio owner in the Bio Options menu, which may be to “delete” the Bio, thereby removing it from everywhere it appears and Untagging it from every post it is Tagged in, for example. Other functions of Bio pages may be similar to the function of corresponding features in Timeline, except, for example, Bios may not have a Progressive Profile in this example implementation. It is noted that Bios may function with the addition of a Progressive Profile, following the structure of the Timeline, similar to as discussed above.

Continuing, the selection of a Media entity from a previous screen, such as from the screen shown in FIG. 17, FIG. 25 depicts an example GUI Media Page 670, as viewed by the owner, maintained in the Memory Chest of the corresponding user's Timeline, for this example implementation. The Media Subheading Bar as shown may function similarly to Bio pages, as it may likewise display the Date Navigation button, Display Options button, title of the viewed entity page, date range of the viewed entity, and the Search button, similar as components discussed in relation to FIG. 24. Two differences in this example implementation are that Media entities: 1) may not have subtitles, in which case they do not appear below the title, as shown, and 2) selecting the title may not open a menu. Also, another function of the Subheading Bar that may be unique to Media entities in this example implementation, is they may have the Star Response button 671 with a count of Star Responses shown directly to the button's right. The user may leave Star Responses to Media, as the Star Response button may function similarly for Media Entities as it does for posts, as discussed in relation to FIG. 28, except Media Entities may here refer to owners instead of creators, in contrast to as discussed in the text description for FIG. 28.

Next, the Links module 672 may appear as shown, in place of the Timeline Memory Chest module, in Region Three of Media pages. The Media Links module in this example may display users that have the same or similar depicted Media appearing in their Memory Chest. In this example, Linked users may appear in order of addition, as one or more Links, newest first. A representative image, such as the newest Profile Picture, and name may appear to represent each corresponding user, opening their Timeline if such name is selected.

Following selection of the Newsfeed option from Navigation Hub of FIG. 2, shown in FIG. 26 is as depiction of a sample Newsfeed page GUI screen 680 accessed by an owning user. Newsfeed pages, accessed from the Navigation Hub, may be unique to the accessing user in this implementation, such that no user may view another user's Newsfeed. As shown in this example, a Newsfeed page may display a new to old chronological feed of posts created by each user with whom the accessing user is a Friend, based on post creation date. It is noted that the content as choreographed in Newsfeed may vary in other example implementations. Continuing, the Comments module 681, discussed more in relation to FIG. 28, appears in Region Three by default in this example screen, accompanying the posts that appear in Region Two.

### Post Interaction

Interactions regarding created posts in this example implementation are discussed in the following section, as they appear on the indicated sample pages.

FIGS. 27a-27b present a representative flow diagram of post interactions within this example system, including Standard View and Expanded view posts. At 90, a post is shown that has been accessed to provide interactions to the accessing user. The system may then check if the accessed post contains content created by the accessing user, or not, at 91, to then prompt if the accessing user wishes to delete it. Then, following receipt of a selection to delete the post at 92, the accessed post may be deleted and removed from where it appears within the screen on which it was located (see further discussion below with regard to FIGS. 28-29), and the system may reorganize posts, edit pages, and restructure metadata accordingly with regard to the corresponding post. Next, when a post is removed from a Timeline, Bio, or Media page (e.g., after deletion described above), the metadata structuring the corresponding locations may shift according to various settings and determinations by the system, in order to uphold the integrity and functionality of the location appearance after the post is deleted (e.g., such shifting may be carried out for all associated, or otherwise affected, users). Then, interactions with the now deleted post may be completed at 93.

Following a user choosing not to delete a post, the user may then select whether to interact with Comments on the accessed post at 94, as shown on the presented flow chart. Continuing from selection to interact with Comments, at 95, the accessing user may, for example, 1) leave a Comment on the post, 2) respond to an existing Comment with text, or 3) delete a comment on the accessed post (e.g., if they created the Comment or the post).

Shown at 96, following a user not interacting with delete options or Comment interactions, the accessing user may have the option to view Tags that exist within the accessed post if selected, as the number of Tags may be displayed by default. The Tags that are included in the accessed post (e.g., user, Bios, and Media) may be displayed with the option to be viewed or opened at 97. Then, at 98, the user may have the option to open a displayed page from selection of its title or picture, for example, which may be carried out to be opened at 99. Next, menus may be closed, and the user may be routed back to 93 to complete post interactions.

Continuing post interaction if the user at 96 does chooses not to interact with comments on the post, at 100 the user may select to interact with Star Responses on the corresponding post, whereby they may then leave or remove comments at 101 if they are a visiting user, such as by making a selection via the Star Response button. If the user that is viewing the post is the creator, a menu of Star Response users may be displayed when the Star Response button is selected, showing who has interacted with the post, as a user may not respond to their own post with a Star in this example implementation. The user may open user Timelines from the Star Response menu, similarly to as described for Tags, via selection of the viewed corresponding user. Next, at 102, the creating user may have the option to edit the post, while any visiting user in this example implementation may have the option to expand, or close, a post into a different view. It is noted that posts may be viewed in their Standard or Expanded view in this example.

FIGS. 28-29 depict example GUI screens representing interactions with posts as may be applicable throughout this example implementation. FIG. 28 depicts a sample Newsfeed GUI appears above the content of the post, centered (as shown), if it exists. Then, to the far right of the title area, for example, is the Relative Time Stamp 702, which displays the largest rounded quantifier of time since the creation of the corresponding post. For example, if the viewed post was created 1 minute ago, the Relative Time Stamp may say “1 m,” and then “1 h” for an hour. If the post has content imported through the User Hub from an external web site, discussed further in relation to FIG. 5, the fetchable website logo or icon may appear in place of the Relative Time Stamp number. When the user hovers the cursor over, or selects, for example, the Relative Time Stamp, the Creation Date menu 703 may be opened, so as to display the exact post creation date of the corresponding post, for example. Continuing, posts may display a picture, text, imported content, or imported content with added text in the Content Area 704 of the post, as shown. If too much text exists to be viewed, the text expansion button may be displayed at the end of the text Section, for example, which when selected may expand the text section to display more of the text for the accessed post, until a maximum is reached. If a maximum is reached, the user may then scroll through the expanded text. The text expansion button may, for example, be incorporated in selectable text “(more),” to carry out this function. It is note that, as discussed as examples herein, the Post Content Area may encompass many iterations and embodiments of how text, pictures, or videos are presented, without compromising key aspects hereof.

Continuing post interaction of FIG. 28, if a picture or video is displayed, as shown in the example graphic, and multiple pictures/videos are available to be viewed within the corresponding post, then a Picture Cycle button 705 may appear in the upper right, left, or both corners of the picture/video, as shown for this example implementation. The Picture Cycle button may display a numerical count of the pictures that are available to be viewed in that “direction” of the post, with overlaying of a thumbnail of the next picture in the queue to be viewed. For example, if ten pictures exist in a post, the first picture may present one Picture Cycle button in the top right with “9” shown inside the thumbnail, indicating that there are 9 pictures to be viewed in that direction. Further along these lines, if the user cycles to the next picture to the right, then two Picture Cycle buttons may appear, for example, one in each corner. The button in the top left corner of the post as shown in this example may read “1” for the one picture that may be cycled back to, and an “8” may appear on the Picture Cycle button in the top right indicating the number of further pictures available. The user may have the option to hover the cursor or other selection features over a Picture Cycle button, which may expand the button slightly to display the next corresponding picture thumbnail or video preview, for example.

Following post layout and interaction, as shown in FIG. 28, the Post Information Bar 706 may appear at the base of each Standard View post, as shown, which may display relevant information regarding the corresponding post, along with information on the creating user. The far left of the Post Information Bar, for example, may, as shown, display the creating user's representative image 707 (for example, the creating user's most recent Profile Picture). Directly to the right of the representative picture, in this example, appears the creating user's name 708, then the post's user-entered date information 709 directly below. Next, to the right of the user and date information on the Post Information Bar, may appear the Post Options button 710, which, when selected, may open the Post Options menu 711. The Post Options menu 711 may allow the user, for example, to select and change corresponding settings surrounding the post, which selectable/available features may vary depending on settings specific to the user accessing the menu. The Post Options menu may, for example, allow the creating user to Edit the post, which when selected, for example, may open the Memory Creation module to change information/content, or Delete the post, which if selected may result in deletion of the corresponding post. Further, when a post is deleted, it may either be removed from the specific accessed location (such as a Bio page), or be removed from the entire presented implementation of systems, directed by a backend process, for example, based on the user selected option of deletion. If the selector of the Post Options button is not the creator of the post, the selector may be provided with the option to select a Report button (not shown; see similar feature shown and described in relation to FIG. 24), thereby allowing the user to report the post for possible review for appropriateness by a manual review or automated system procedure after selection.

Continuing, the upper left corner of Standard View posts as shown in this example is reserved for a Tags button 712, which may appear in the posts, whether those Tags be users, Bios, or Media Entities, for example. In this example implementation, if at least one entity is Tagged in the accessed post, the Tag button may appear. The user may select the Tag button to open the Tagged Entity menu 713, which may, for example, then display all users, Bios, or Media Entities that are Tagged in the accessed post, organized by order of Tagging, oldest to newest or arranged in some other suitable format. Displayed Tags may have a representative image 714 (e.g., the newest profile picture) shown, for example, to the left and corresponding title/username to the right 715. Selecting the title/username of a Tag may open the corresponding Bio/Media page of the Timeline for that user.

In general, for this example implementation, Star Responses may include favorable responses left for corresponding posts, Progressive Profile entities, and Media. On the far right of the Post Information Bar, as shown in this example, the Star Response button 716 may appear directly to the left of a count of Star Responses the corresponding post has, unless that number is zero, in which case no numeral may appear. If the accessing user is not the creator of the corresponding post and the post allows Star Responses, the Star Response button may appear “hollow” (e.g., outlined symbol) by default, and may be shown as filled in when selected, for example, thereby designating its having been selected. If the creator of the accessed post selects the Star Response button while there is at least one Star Response to the post, in this example, the Star Response menu 717 may be opened and may display all users that have left Star Responses, listed by name, organized by most recent Star Response listed first, for example. If desired, the user may then select the name of a displayed user to open that corresponding Timeline in its initial position.

Then, to the left of the Star Response button, on the Information Bar of posts, as shown in this example, the Comment button 718 may appear, with the numerical count of Comments the corresponding post has being displayed, unless that number is zero, in which case no numeral may appear. Selecting the Comment button toggles may open Comments in Region Three on the Timeline, Bio, and Media pages, as shown in this example implementation, while such selection may have no function on Newsfeed pages, for example.

Following post interaction, a Comment entry field 719 may appear, as shown, at the base of the Comments in Region Three, allowing entry of a Comment in the accessed post, including picture non-text content, for example. Comments may appear with the Commenting user's representative picture 720 (e.g., newest Profile Picture) shown in this implementation to the left of the user's name 721, Comment content 722, and Relative Time Stamp 723. If the user selects to respond to a Comment, they may select the Comment Response button 724, and the Comment entry field may thereby function as a response field for entry of the specific Comment.

Following the selection of a Standard View post in this example implementation, an example Expanded View picture post GUI screen 730 may be displayed as shown in FIG. 29. The title, Relative Time Stamp, Comments button, Star Response button, Comment text entry, and content may function and appear similarly to as described for a Standard View post, except for certain appropriately added text.

The bottom left corner of Expanded View posts in this example implementation may be reserved for Tags that appear in the posts, whether those Tags be users, Bios, or Media Entities. For example, if at least one entity is Tagged in the accessed post, the Tag button 731 may appear to the far left, as shown, followed by the name or title of the first Tagged entity in the accessed post. If multiple Tags are present in the accessed Expanded View post, the amount of post Tags that are not displayed may be represented numerically by “+X” to the right of the initial Tag, for example, where X is the amount of Tags not displayed by default. If there are at least two Tags in the accessed post, for example, selecting the Tag button or the name/title of a displayed Tag may open the Tagged Entity menu, functioning similarly to as discussed in relation to FIG. 28. The Tagged Entity menu may display all users, Bios, or Media Entities that are Tagged in the accessed post, organized by order of Tagging, oldest first, for example.

Continuing Expanded View post interaction, the creating user's representative picture 732 (e.g., the newest Profile Picture) may appear to the far left of the accompanying module to the main content of the Expanded View post, as shown. Then, to the right of the creating user's picture may be shown the creating user's name 733 directly above the date-criteria 734 of the accessed post. Next, the Post Options button 735 may appear to the right of the date-criteria of the accessed post, functioning similarly as it shown on the Post Information Bar of a Standard View post, as discussed further in relation to FIG. 28. Then, the Progressive Profile Post button 736 may appears to the right of creator information, as shown, opening Progressive Profile when selected, open to the section of the corresponding Progressive Profile that includes that accessed post's Estimated Date.

Further, below the section displaying user information for the accessed Expanded View post is shown an example text section 737 where text may appear, if it exists, to accompany picture/video posts. Functioning similarly to Standard View posts, if too much text is available than able to be displayed, the Text Expansion button may appear, spelled out as a selectable “(more),” for example, which the user may select if they choose to view more of the post's text.

### Date Approximation Detailed Example Description

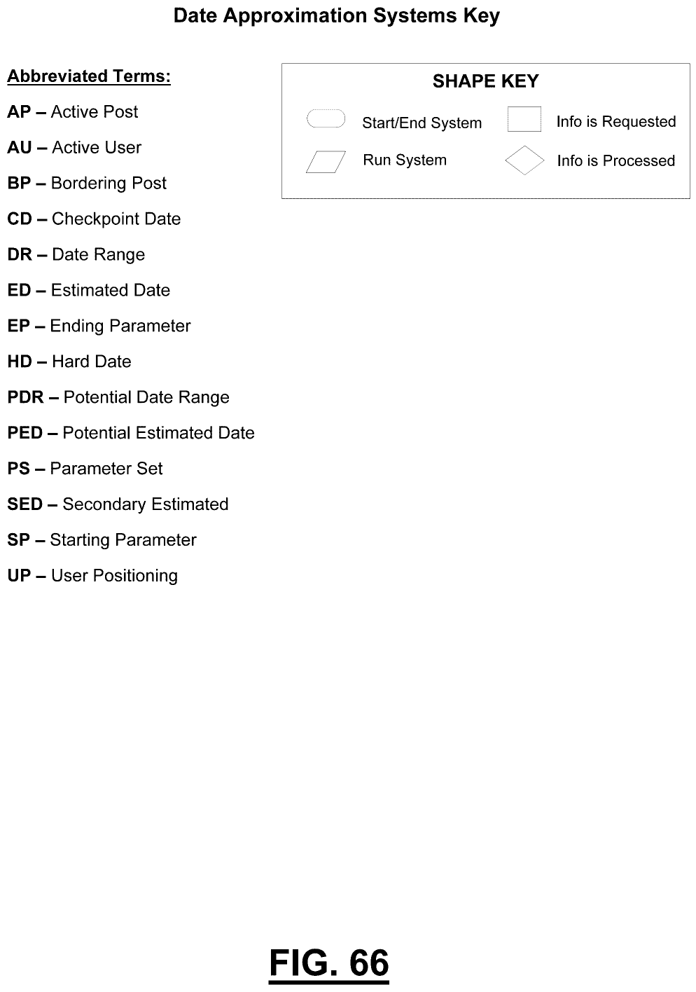

The description set forth below in connection with the attached drawings in conjunction with the abbreviations key shown in FIG. 66 provide a representative overview of the presented concepts and functions of date approximation, in accordance with both the above portion of the Detailed Description and the below Date Approximation Detailed Example Description.

FIG. 32 presents a representative overview flow diagram of an example process used to facilitate aspects of an example implementation of date approximation functionality as carried out in reference to further detail in the following flow charts 33-65. The process of the representative flow diagram 800 in FIG. 32 covers multiple steps related to the dates of posts within the presented implementation. At 801 the presented system is started, beginning the facilitation of date criteria through the “Post Date Controls” flow diagram as presented. At 802 Date Selection systems are taken as the first step of the presented flow diagram, facilitating date criteria entering, selection, or editing for a post on a Timeline of the present embodiment. Next, both 803 and 804 include processes focused on the creation of metadata for the facilitation of Profile navigation, creation, or improvement. In this example implementation, “Checkpoint Dates” are created as necessary metadata components to the orientation of Profile components for Timeline navigation. Continuing, 805 and 806 carry out processes focused on the creation of Progressive Profile Sections, which facilitate the control of what content appears in the corresponding profile, for example, based on date. Further, at 807 the “Post Date Controls” flow diagram of FIG. 32 is completed.

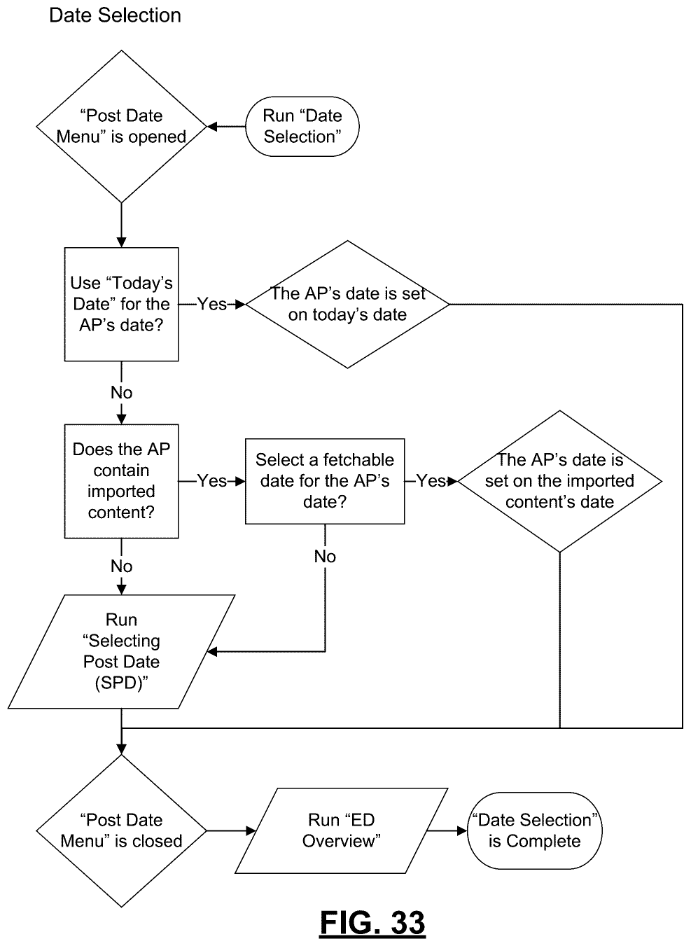

FIG. 33 presents a representative flow diagram of the details of the Date Selection” portion of the process of FIG. 32, carried out in conjunction with user access and interaction options for selecting date-criteria of a post, in accordance with aspects of referenced in box 43 of the representative flow diagram of FIGS. 8a-8b as well as shown in FIG. 9. The representative flow diagram of FIG. 33 directs the user to further date selection, or input, as well as other functionality for fulfilment. The presented flow diagram allows interactions within the Post Creation Date Selection menu, as referenced in the presented implementation. For a new post, the user has the option to select “today's date,” or a current date of access, as well as the date criteria accessible from any imported content, as discussed further in relation to FIG. 11. In addition, the user may select to input date-criteria results in the continuation to other functionality, for example.

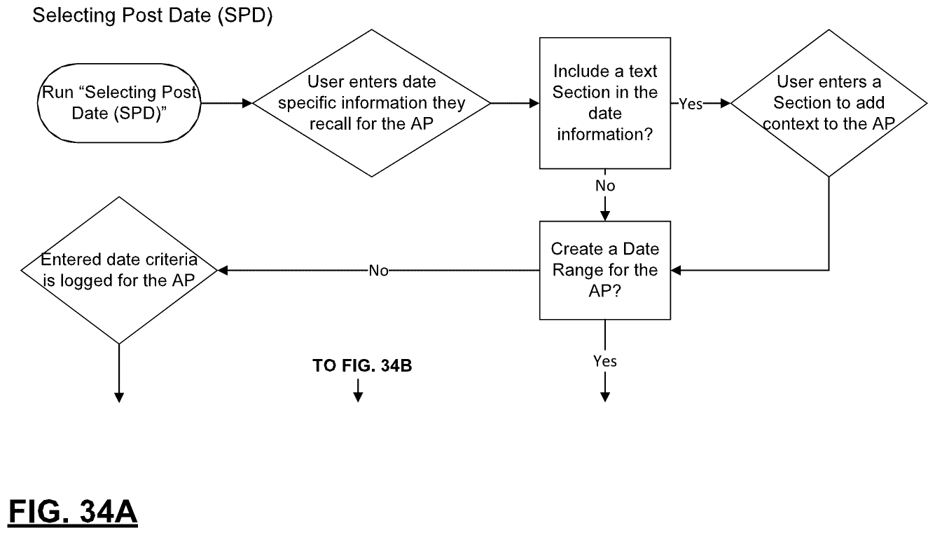

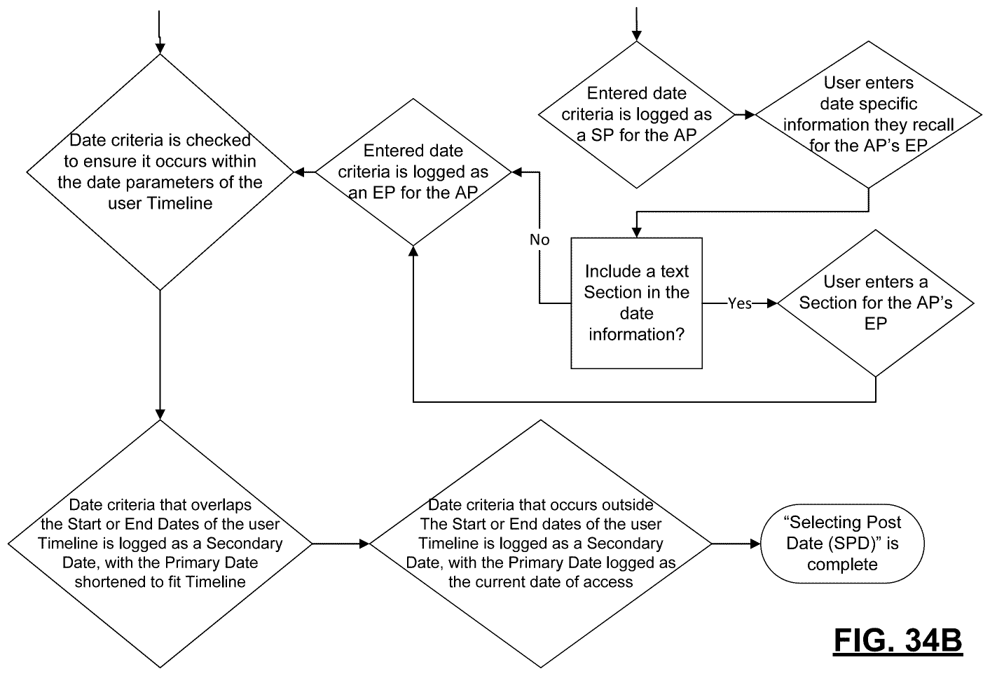

Further, from the selection of user-entered date, FIGS. 34a-34b present a representative flow diagram of user date-criteria selection options for a post, in accordance with aspects of the present disclosure. Displayed in FIGS. 34a-34b are steps that include checking the usability of user entered, or selected, date-criteria in accordance with other features in accordance with aspects of this disclosure. Date-criteria options as they are outlined in this example implementation allow for the entry/selection of a day, month, and year; month and year; season and year; just a year; a text-based selected or entered Section, such as “Childhood,” day, month, and Section; month and Section; season and Section; or a Date Range of two chosen options. “Sections,” as the term is used in this disclosure, refers to text-based representations of a time frame, used in place of a year. It is to be noted that these presented date-criteria options are not meant to limit the potential scope of date-criteria options.

The presented flow diagram walks through the user selection, and/or entering of, date-criteria for a corresponding post. At the beginning of the flow diagram of FIGS. 34a-34b, the user decides if they are entering specific date-criteria, a text Section, or a Date Range for the new post, thereby determining what processes are run. Next, the user may enter Ending Parameter date-criteria for a Date Range to be confirmed, the processes are then run to ensure date-criteria functions in the parameters of the user's Timeline.

In this example implementation of date selection, the user may select or enter date-criteria before their birthdate, creating additional date-criteria hereinafter referred to as a “Secondary Date.” Further, when this Secondary Date is created, a primary date is automatically created based on when the user's birthdate occurs, often using the current date of access, for example. A Secondary Date may be useful in connecting things that are older than the Timeline date range to current memories, such as a photograph of older generations found today by descendants. In some implementations, a Date Range may be permitted to overlap the user's birthdate (or Start Date of Timeline), allowing for a split into a Secondary Date, as previously discussed, as well as a new primary date that begins with the user's birthdate.

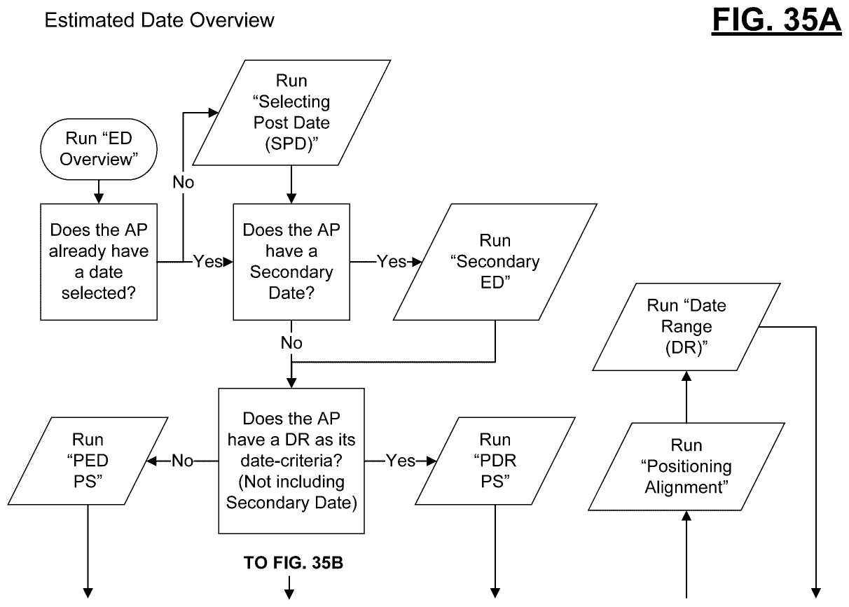

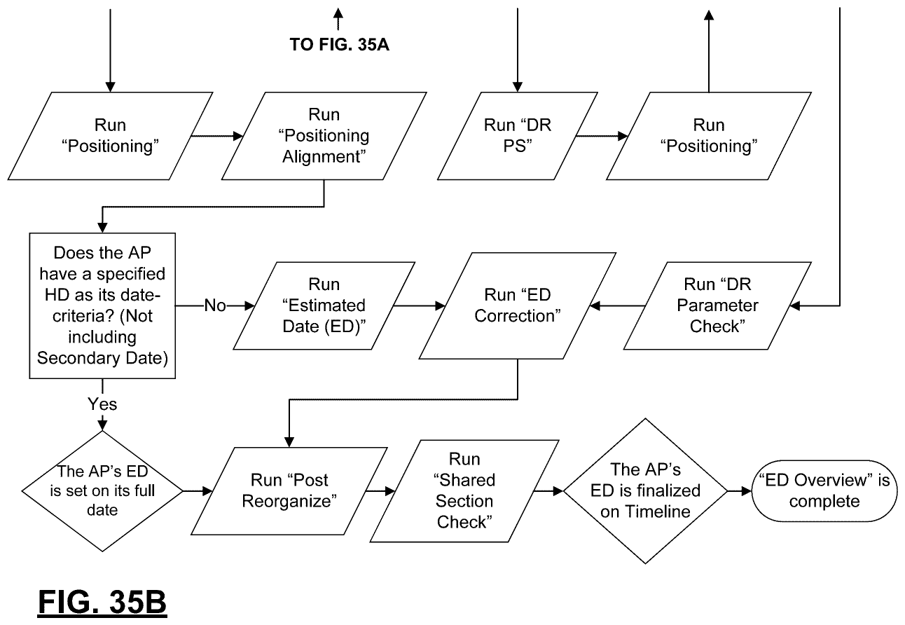

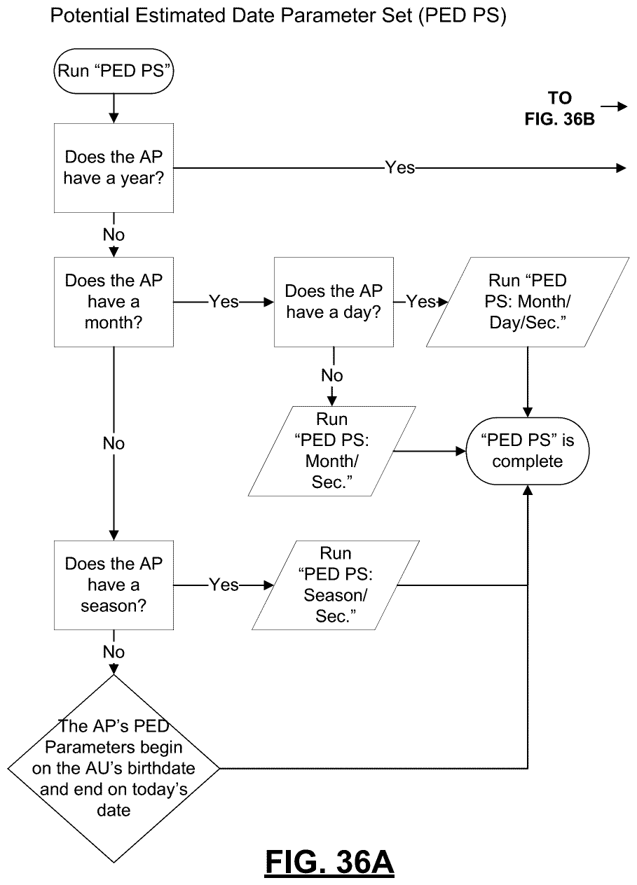

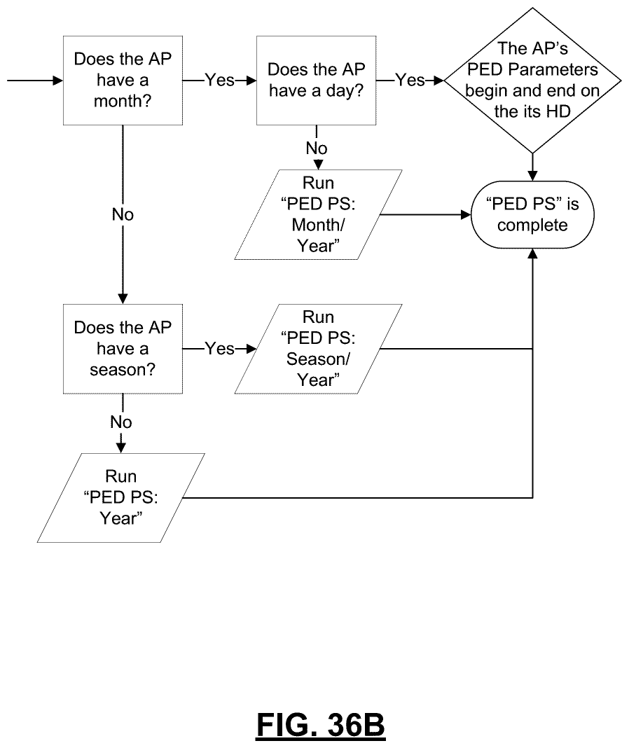

Following the selecting, or entering, of date-criteria, FIGS. 35a-35b presents a sample representative flow diagram of a date approximation system for posts in accordance with aspects of the present disclosure, referred to as the “Estimated Date Overview.” As presented, this example implementation of date approximation walks through multiple subprocesses with varying functions to establish an approximated (or “estimated”) date on a Timeline. The first step of the depicted representative flow diagram may include determining if the new post has a Date Range as its primary date-criterion, which may govern the pathways of additional process flow to follow. If Date Range is not a primary date-criterion, a Potential Estimated Date (PED) Parameter Set (PS) may be carried out; while if Date Range is a primary date criterion, a Potential Date Range (PDR) PS may be carried out. Discussion of PED PS and PDR PS is continued in conjunction with FIGS. 36a-36b and the accompanying descriptions.

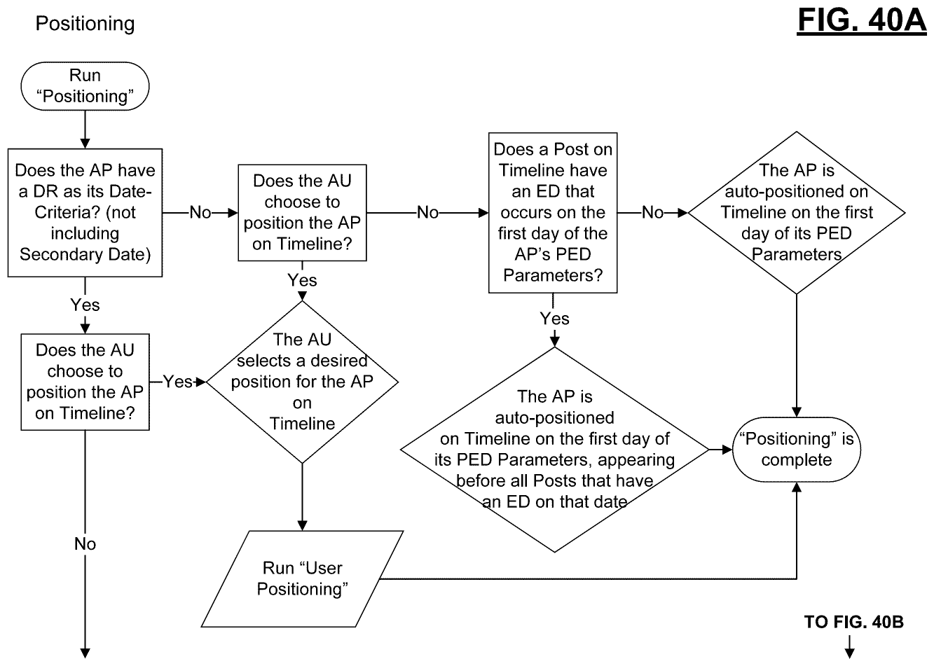

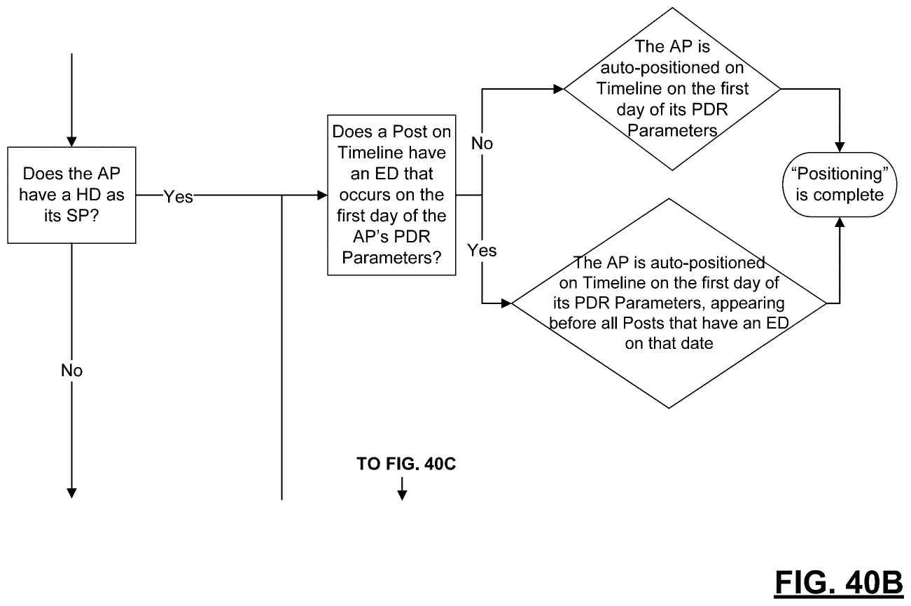

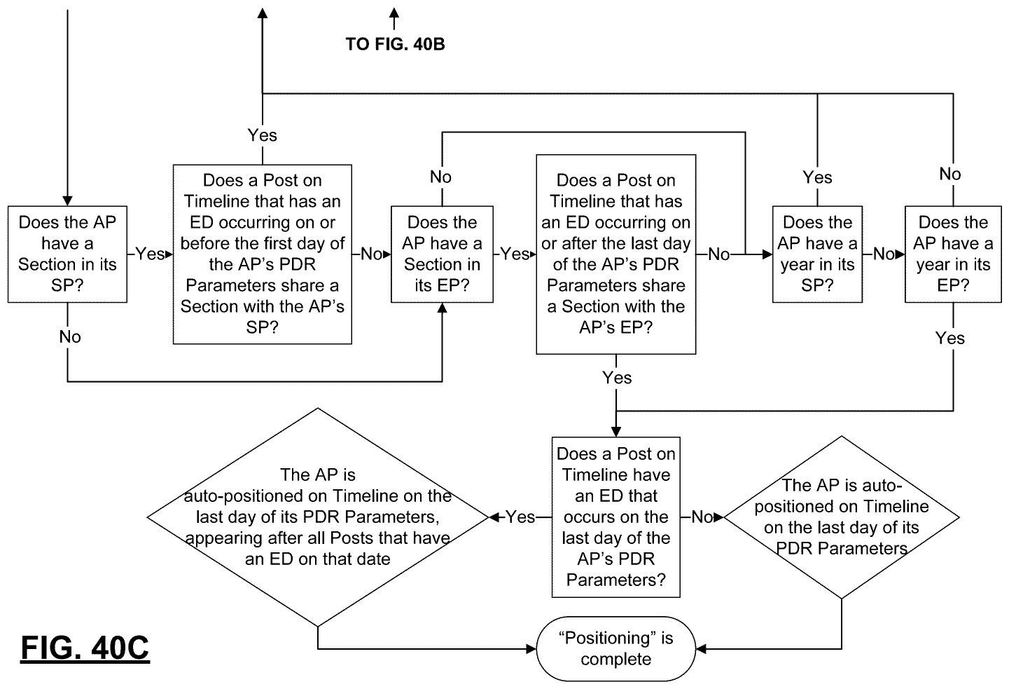

Continuing from the PED PS system, a further “Positioning” process may be carried out, which may require user input in accordance with aspects of the present example implementation. User input, in relation to positioning of posts, may entail the positioning of a corresponding post on a graphic interface relating to, or embodying, the Timeline of the accessing user. Also, the user may choose to let a process within the presented implementation automatically position the corresponding post as a user input interaction. The positioning process and related subprocesses are discussed further in conjunction with the description of FIGS. 40a-40c.

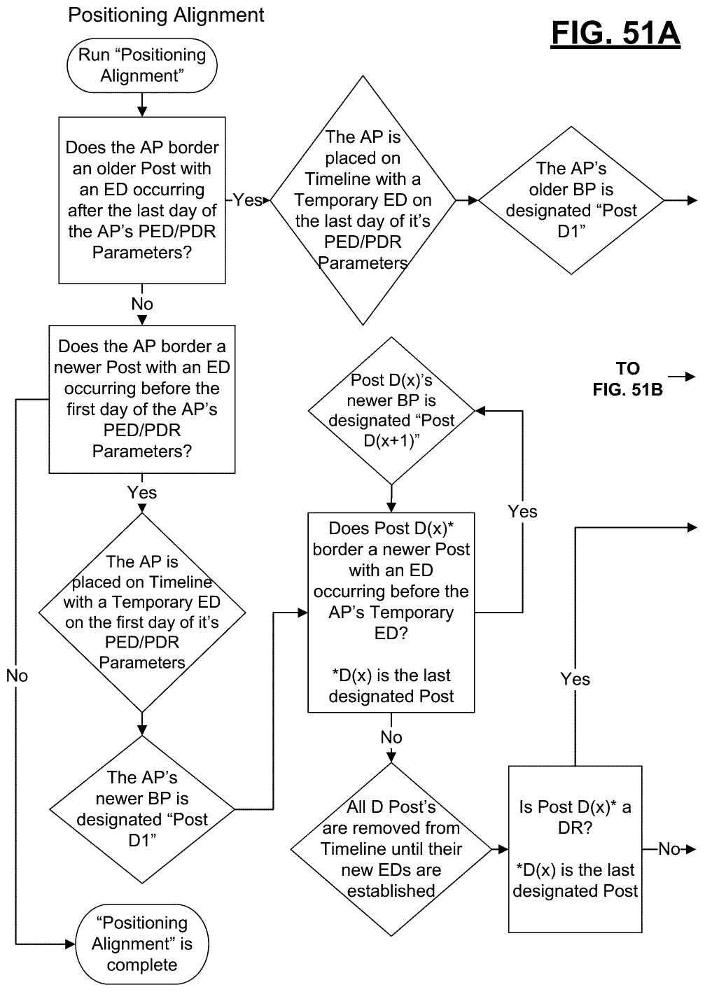

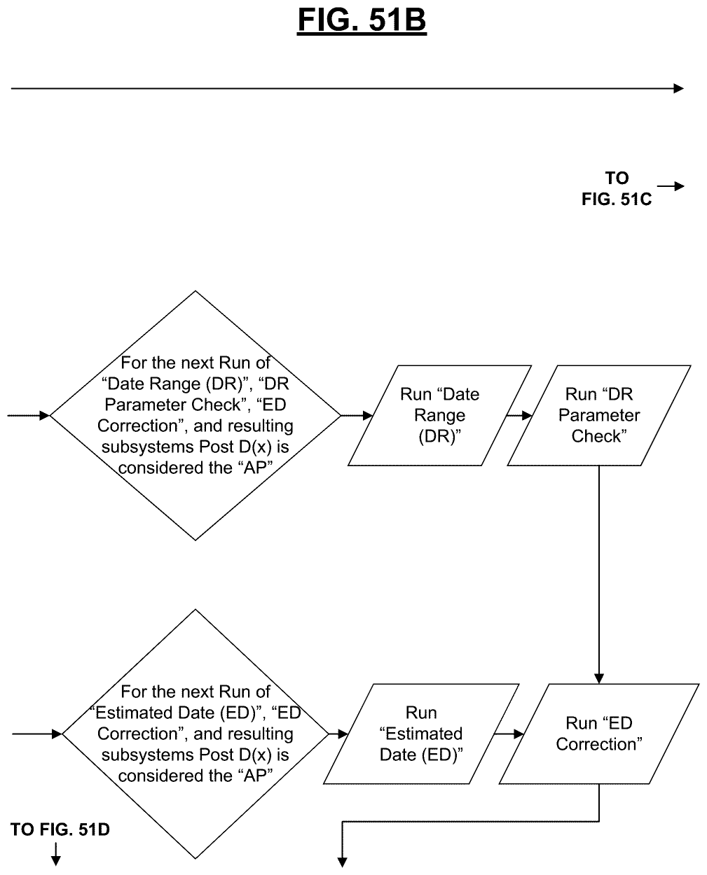

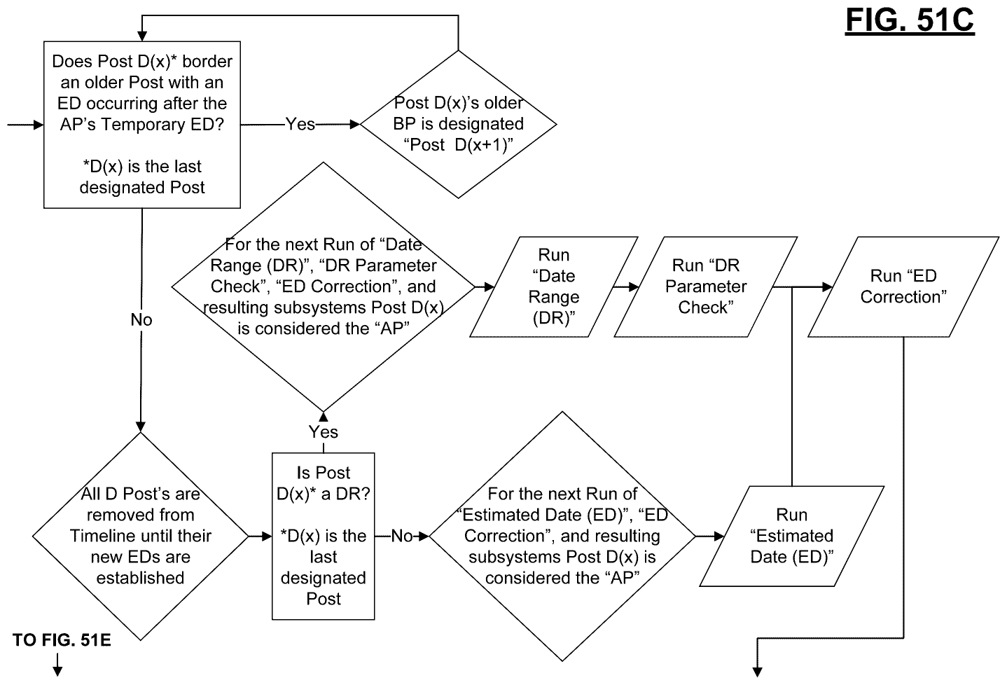

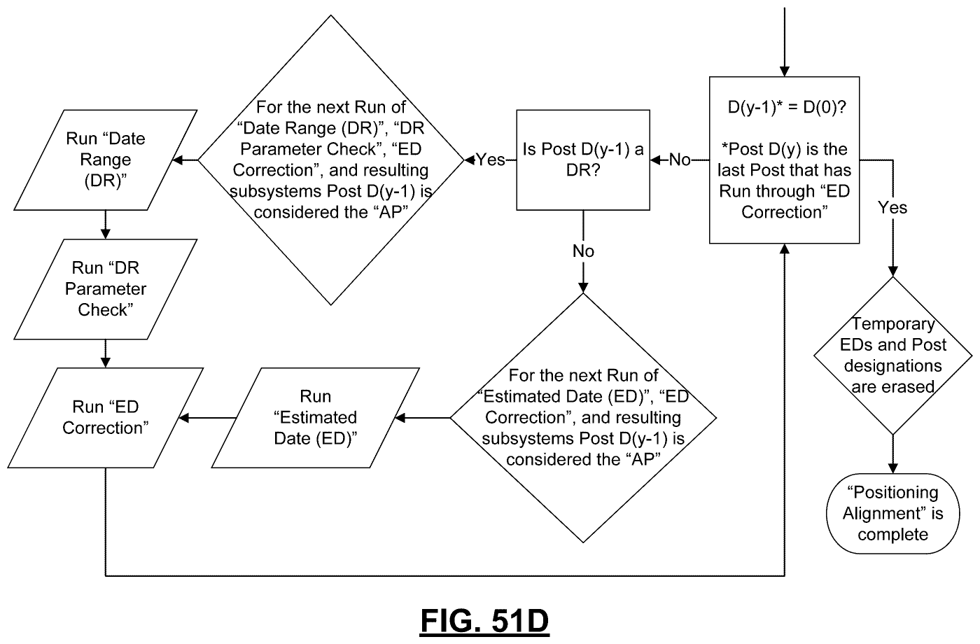

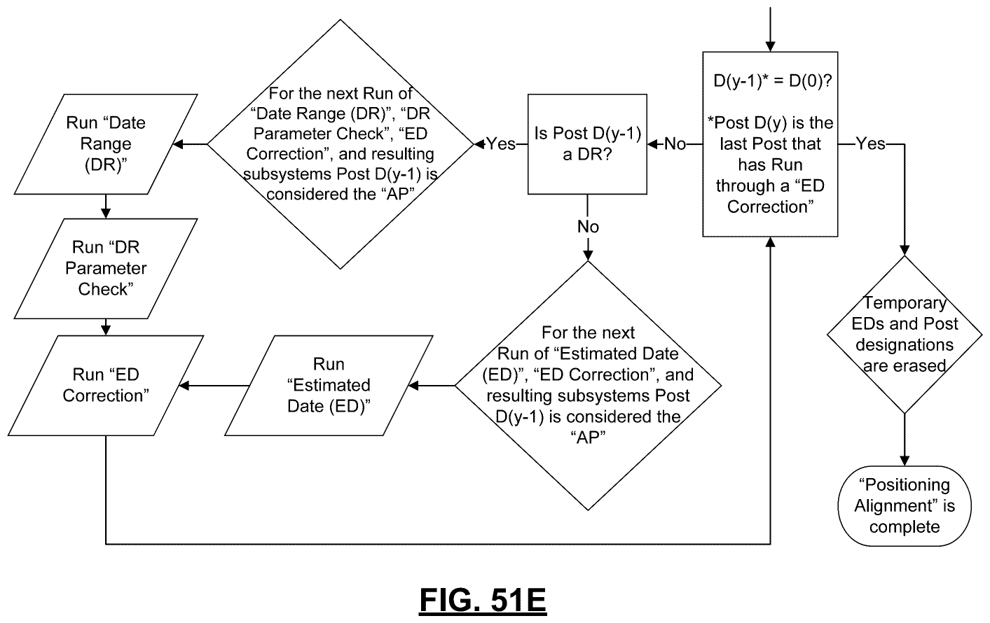

Next, after the Positioning system is completed, a process referred to as “Positioning Alignment” may be carried out to ensure the position determined by other processes, such as the previous Positioning process, is placed properly and does not negatively affect metadata or other structural components of the corresponding Timeline and Profile, for example. Further discussion of this Positioning Alignment process is discussed in conjunction with the description of FIGS. 51a-51e.

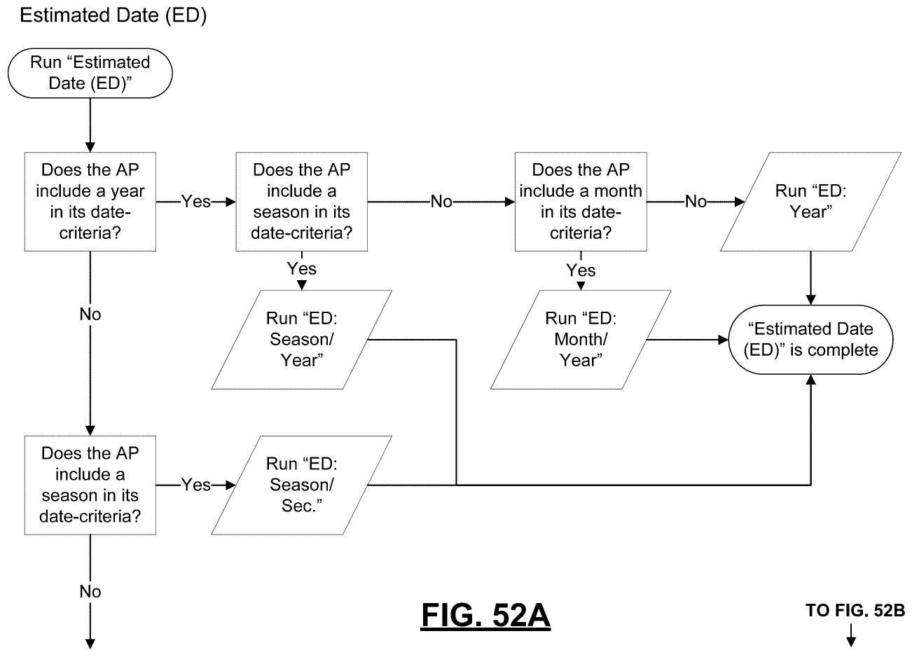

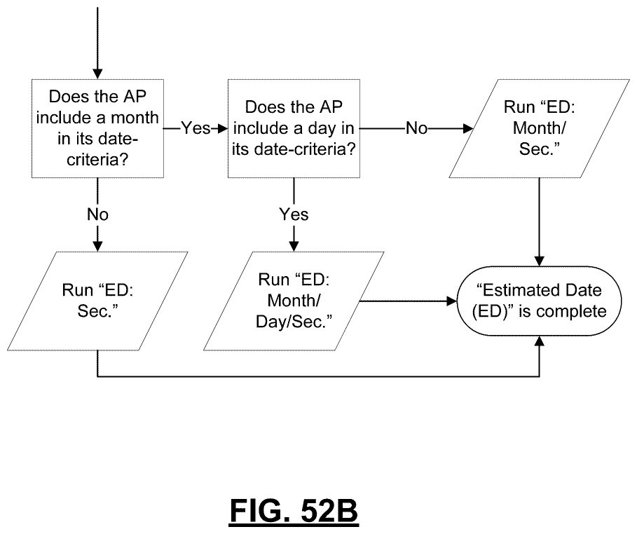

Following the Positioning and Positioning Alignment processes, an approximated date, or Estimated Date (as shown in the drawings) may be created, updated, or edited in the “Estimated Date” process. The Estimated Date process may include subprocesses that, collectively with all Estimated Date features, may fulfill creation, or other updating, of a date that stands as a representational approximation on the date of the memory content for the post in question. Further discussion of this Estimated Date process is continued in conjunction with the description of FIGS. 52a-52b.

Returning to the beginning flow diagram processes of FIGS. 35a-35b, a separate path may be followed when the corresponding post of the overarching Post Date Controls system of FIG. 32 has date criteria containing a Date Range, which may, for example, be selected through processes outlined in conjunction with FIGS. 34a-34b. The PDR PS system mentioned above may be carried out in place of the PED PS system for this type of date-criteria specific post.

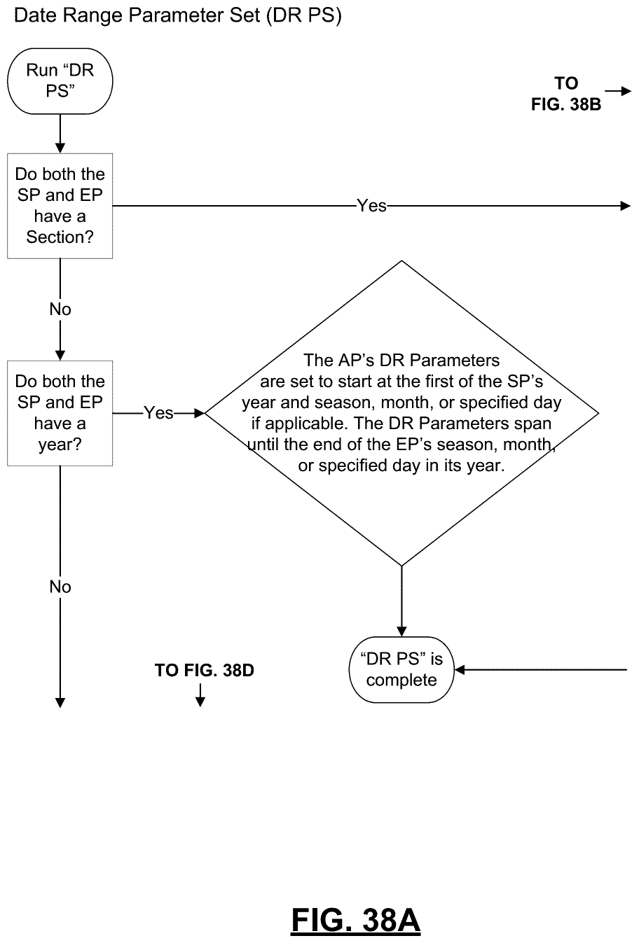

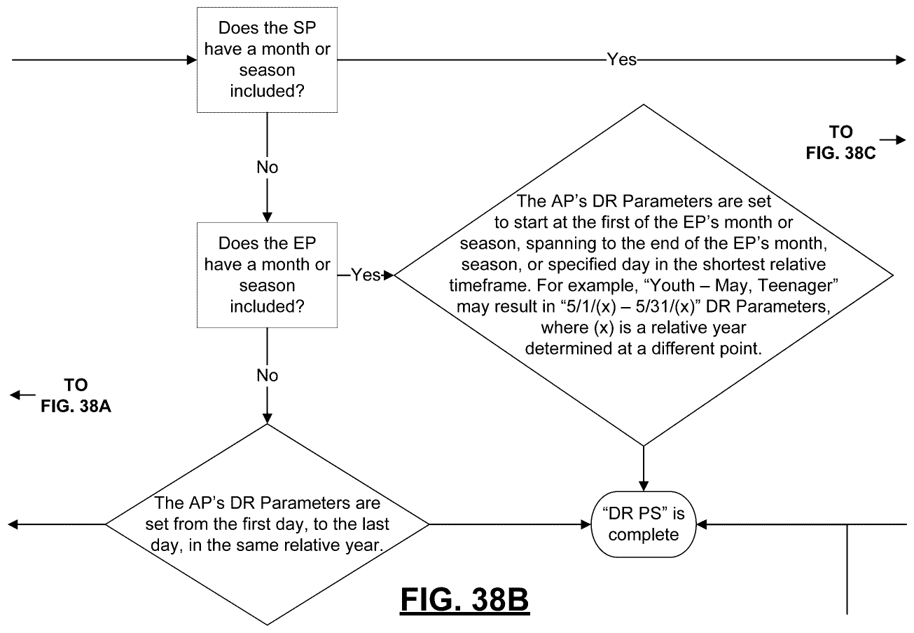

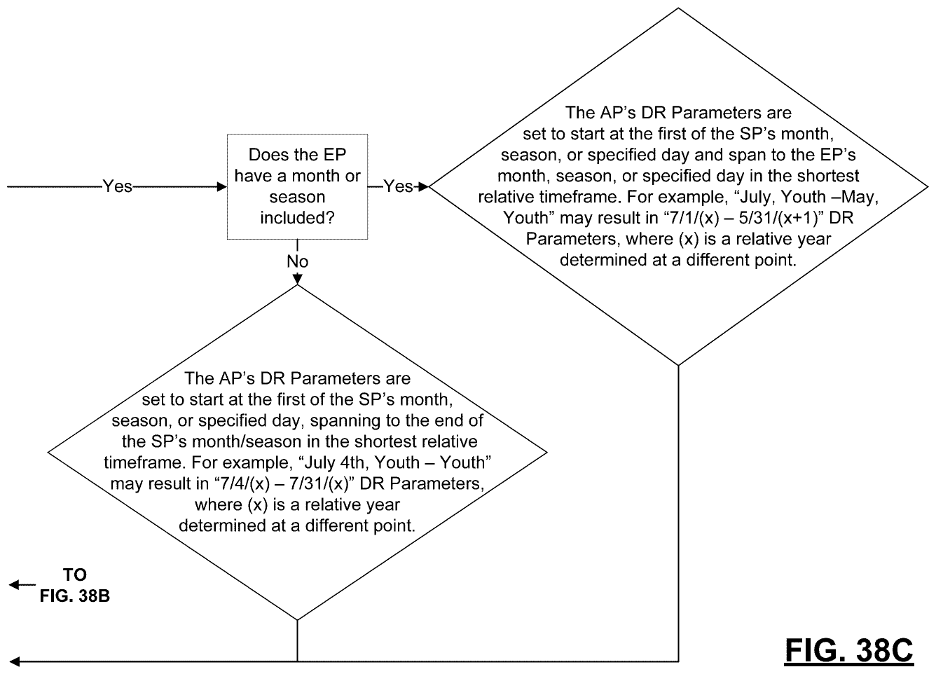

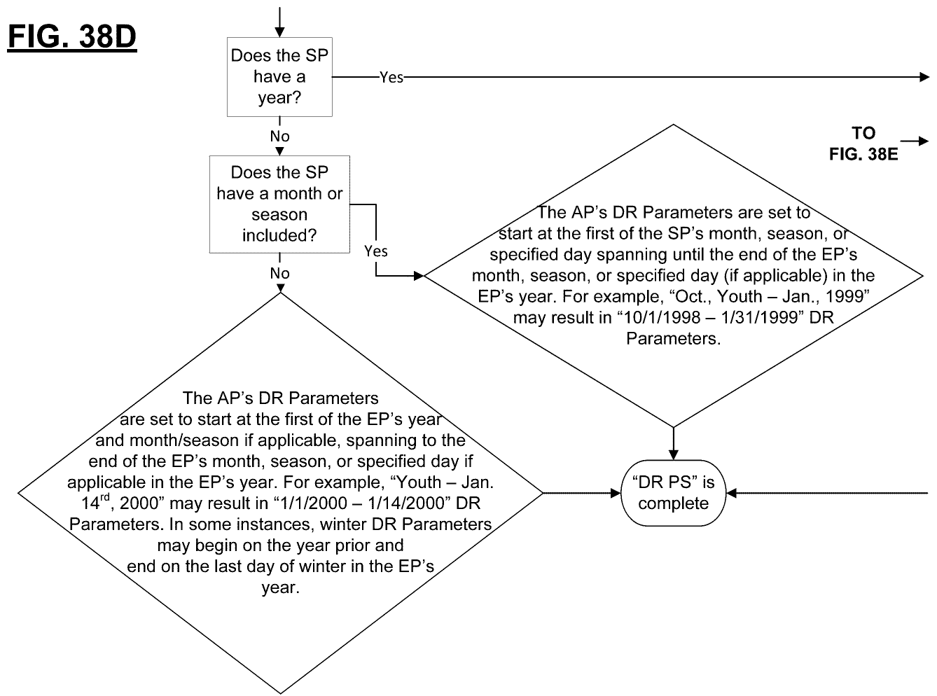

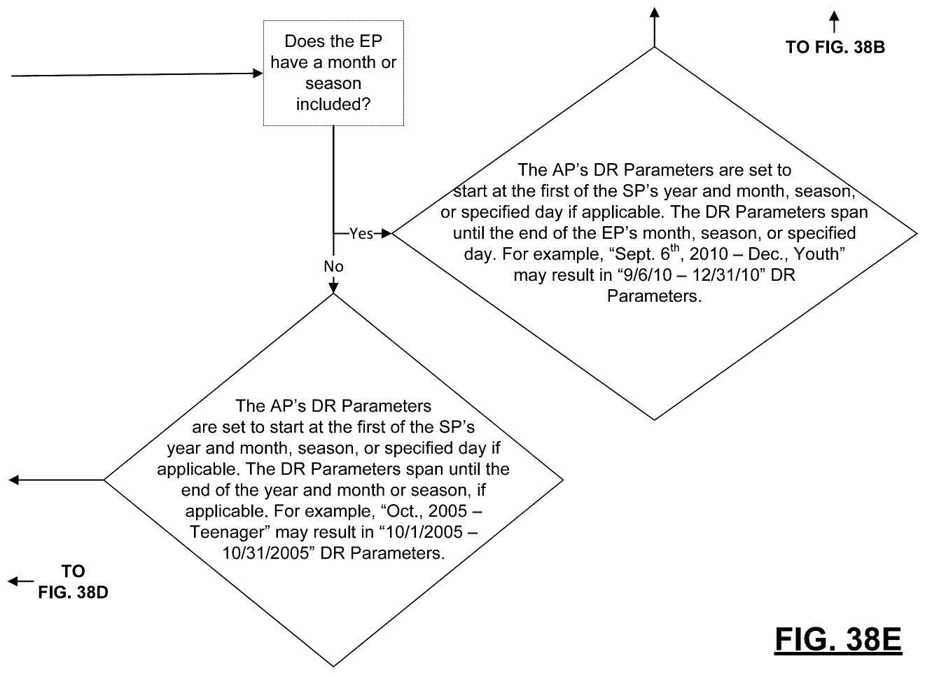

Similar to PDR PS features, the process may continue on to set theoretically optimal, preferred, or otherwise selected Date Range parameters, which may function in a different application of purpose from the Potential Date Range Parameters determined through PDR PS processes. The aforementioned term “optimal” may be used to reference a desired or selected narrower range than Potential Date Range Parameters of a post, while not being intended to limit function. For the purposes of this example implementation, the processes that go on to set the optimal Date Range for the corresponding post are titled Date Range (DR) Parameter Set (PS). The DR PS process discussion is continued in conjunction with FIGS. 38a-38e and the accompanying descriptions. Continuing, Positioning, and Positioning Alignment systems may be carried out, similar to as carried out for a post without a Date Range included in its date-criteria.

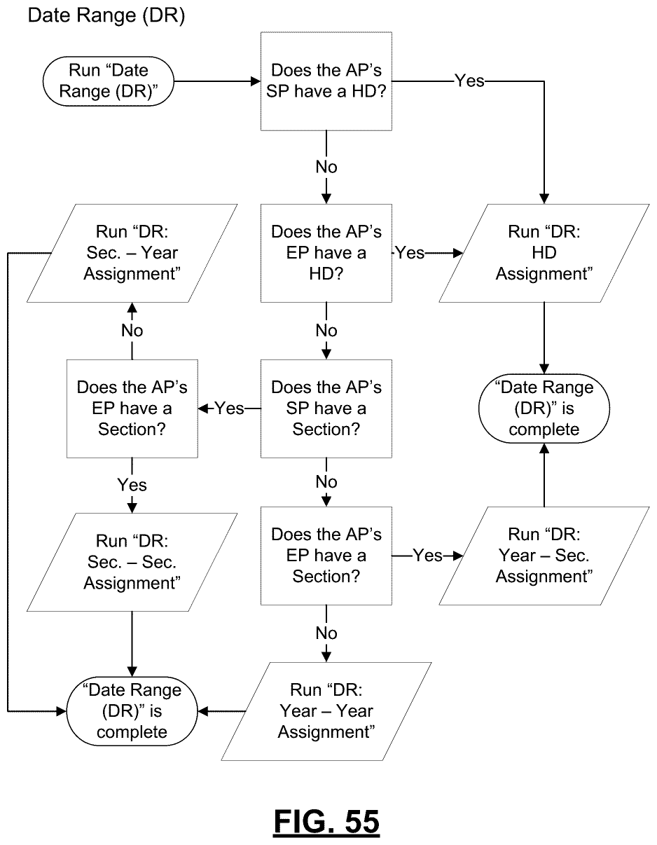

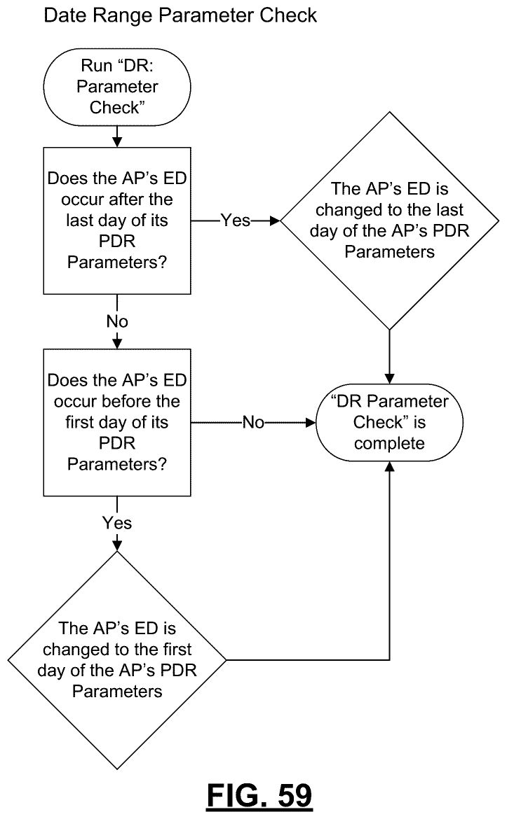

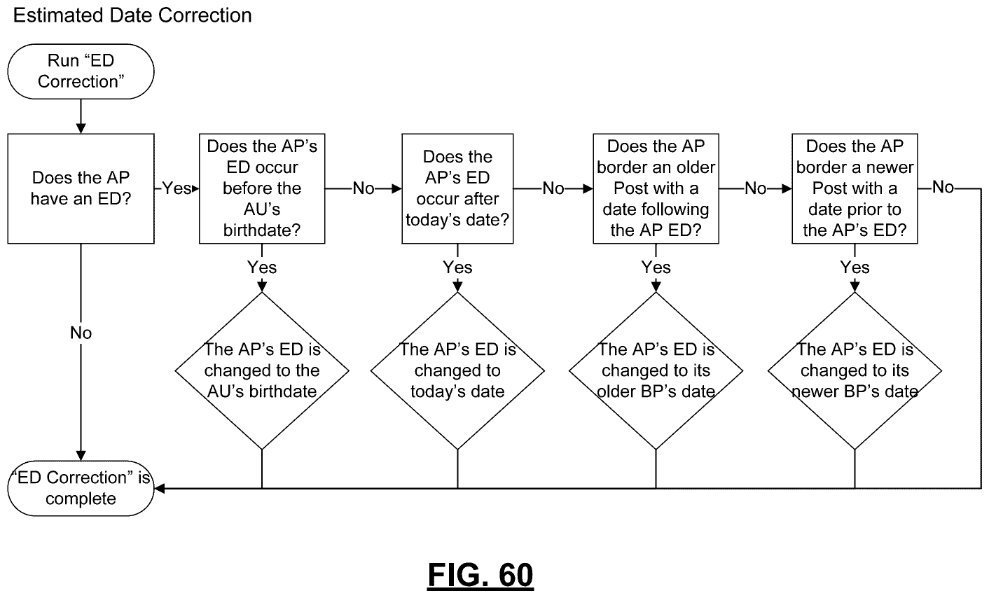

In place of the Estimated Date system mentioned above, a Date Range approximated date process may be carried out to create, update, or edit the Estimated Date for the corresponding post that includes a Date Range in its date-criteria. This Date Range Estimated Date process is discussed further in conjunction with the flow diagram of FIG. 55. Next, a system runs to check if the newly created/updated Estimated Date is properly placed in its Date Range parameters, as a safeguard, discussed further in conjunction with the flow diagram of FIG. 59. Continuing on with the corresponding post, regardless of its date-criteria, a process is run that may check for or update an Estimated Date that is improperly placed or for which other improper metadata exists on the post being referenced in this example implementation. Discussion of the Estimated Date quality check system continues in conjunction with FIG. 60.

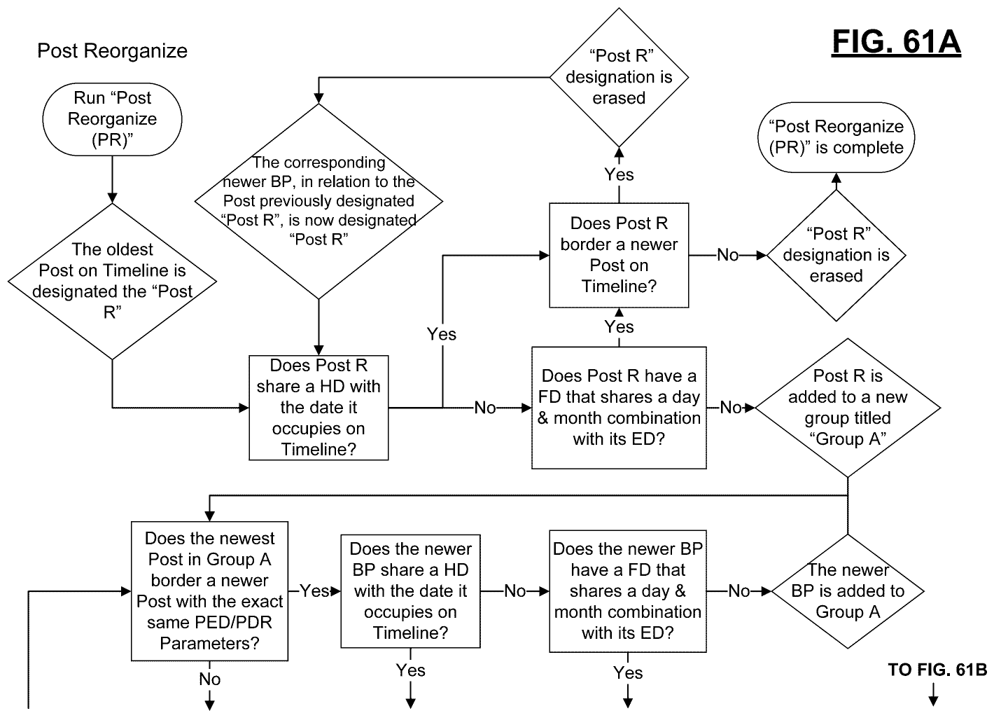

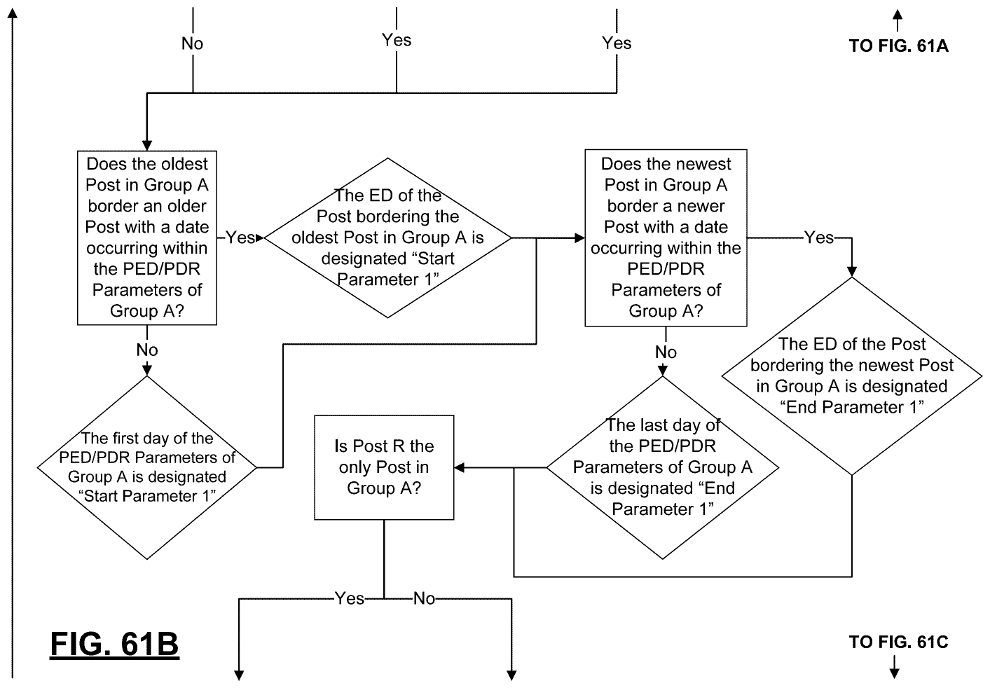

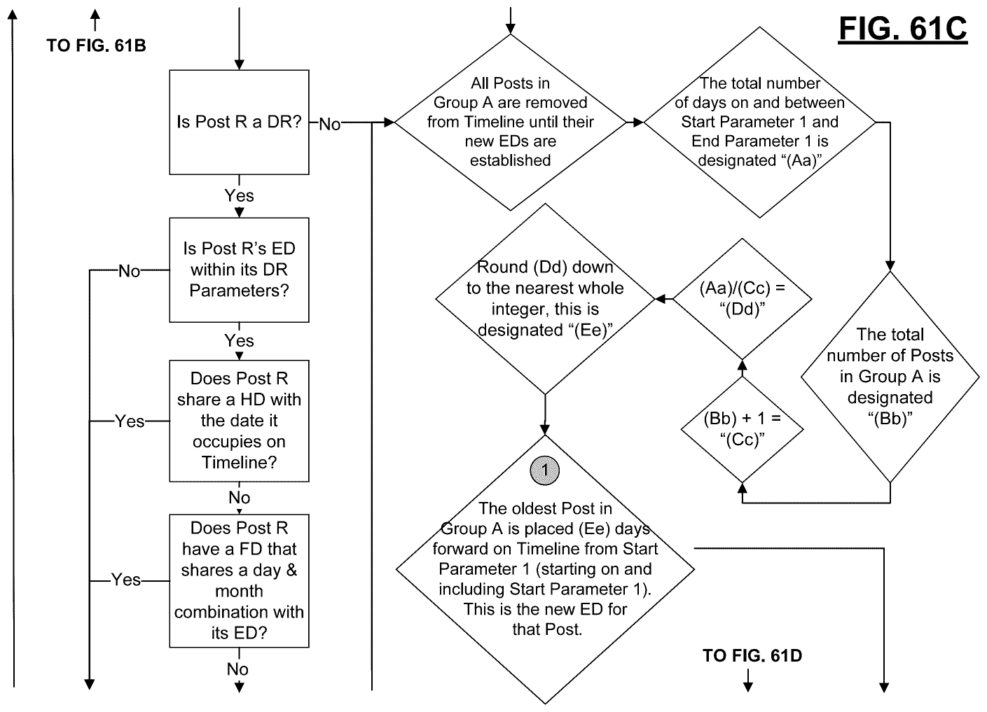

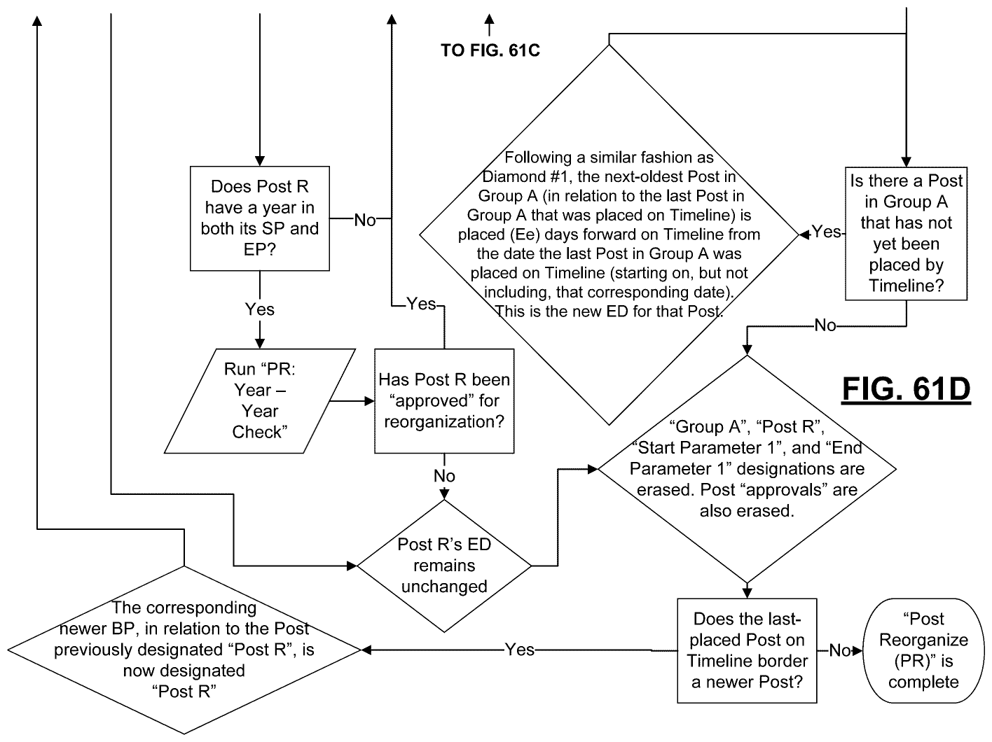

Continuing, another process may be carried out to check, edit, or improve the organization or spacing of posts on the corresponding Timeline to the post with the newly created or updated Estimated Date. Discussion about the specifics of the Post Reorganize features is continued further in conjunction with the representative flow diagram of FIGS. 61a-61d.

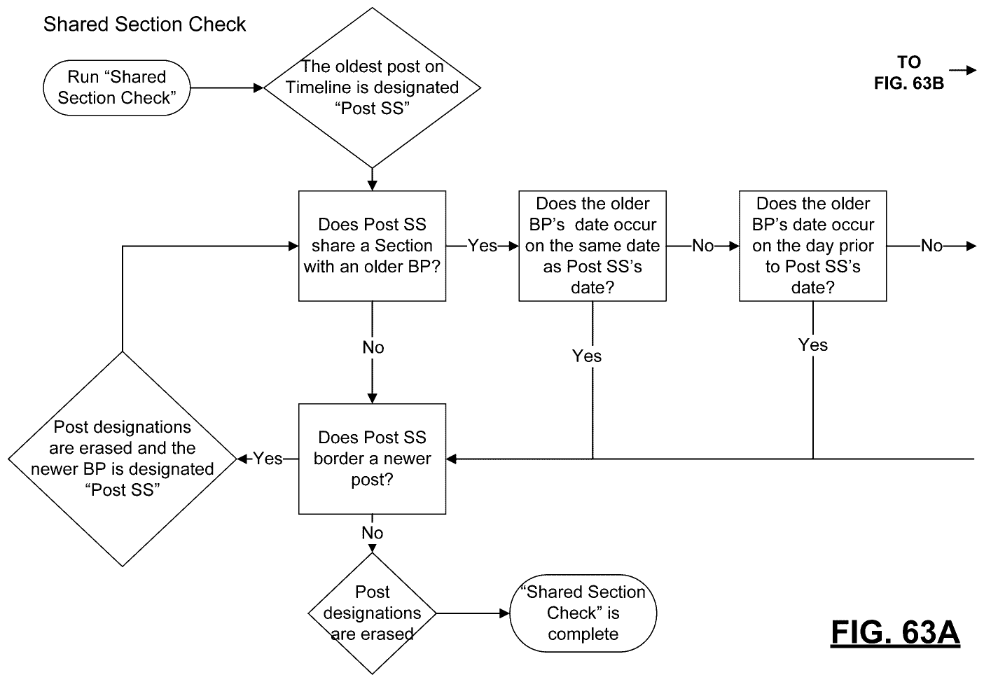

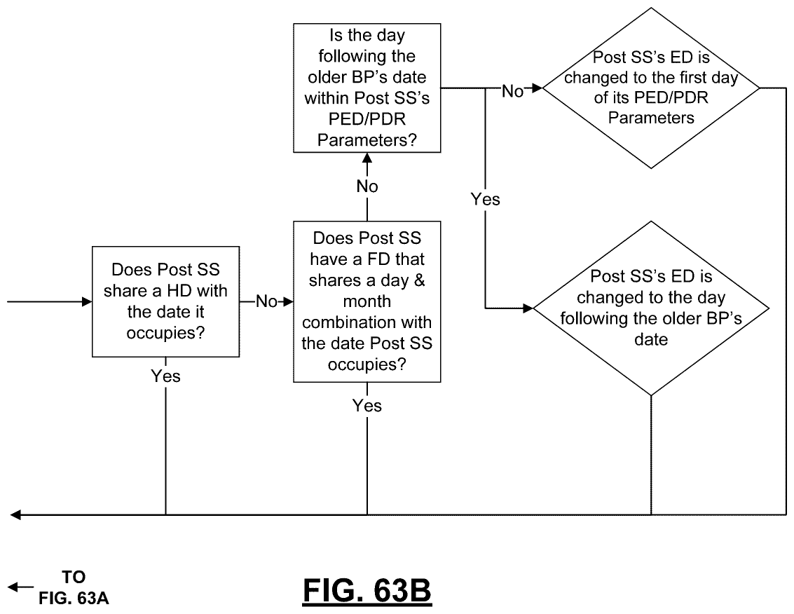

Next, a final step of the presented Estimated Date Overview may involve a process that may focus on Sections in post date-criteria. The Shared Section Check features referenced in the presented flow diagram may function to connect posts that include the same or similar Sections in date-criteria. For example, two bordering posts with “Childhood” as date-criteria would likely have their Estimated Dates brought closer together than they would be otherwise. Discussion of the Shared Section system is continued further in conjunction with the representative flow diagram of FIGS. 63a-63b.

With regard to the PED PS process, FIGS. 36a-36b present a representative flow diagram walking through an example process of setting of Potential Estimated Date Parameters, which define the range in which an approximated date may be placed. This process may include determining if a date-criterion variation may be used to attain appropriate parameters for the approximated date. A similar process in the variation may then be used to the one outlined in FIGS. 36a-36b, though specifically for posts that have a Date Range as a date-criterion. Ultimately, the approximated date for the post may fall within the potential range of dates determined by one of these outlined processes.

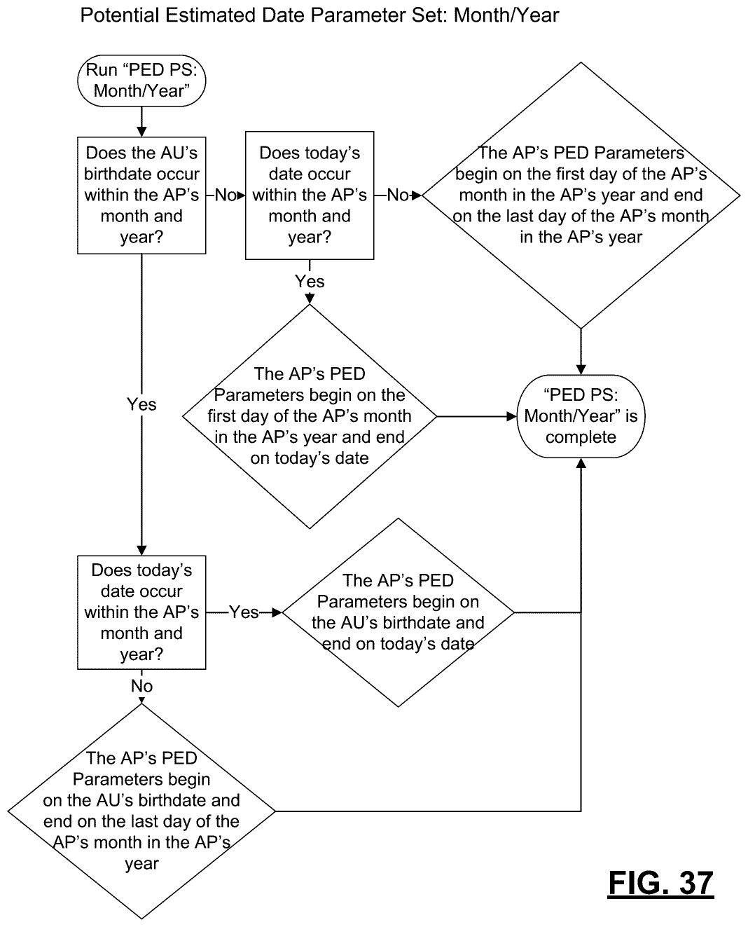

FIG. 37 continues from FIGS. 36a-36b, presenting a sample representative flow diagram that outlines one variation of a post without a Date Range as a date-criterion. The presented sample depicts a post with a month and a year selected/entered as date-criteria. As shown, determinations may be made based on when the user's birthdate and today's date occur in relation to the user's Timeline, for example. It is to be noted that the birthdate of the user and “today's date” may be interchangeable with the Start and End Dates of a Timeline, in place of a specifically defined day. As presented, the potential parameters of a post may not occur before the birthdate of a user or after today's current date of access. Along the lines of the presented representative flow diagram of FIGS. 36a-36b, posts with Date Range criteria may function in a similar way; however the process may take additional steps to assign appropriate systems, as there may be inherently more user shared criteria with a Date Range in this event.

Continuing the example representative flow diagram steps of FIGS. 35a-35b, FIGS. 38a-38e present a sample representative flow diagram that may create an optimal range of dates for a Date Range post, often shorter in length than the potential initial range and in this example intended to rarely spanning more than 365 days, if ever. Further, whether the post falls in this “optimal” date-criteria bracket or not may likely affect how other processes may be carried out and Timeline positioning occurs.

As presented in the sample representative flow diagram, FIGS. 38a-38e may determine the optimal Date Range Parameters, but may often need to assign a further process flow, depending on the Date Range date-criteria variation. A simple example could involve a two-week span (such as Jul. 7, 2010-Jul. 21, 2010) for a vacation. Following a more complex possible example, the user may have entered a month and year (such as July 2010) to span until a month and Section (such as January, College) as the range. For this example, an initial range assignment would be made, and then a process may continue in a further representative flow diagram, similar to that for Potential Date Range Parameters, for example, as referenced above in this description.

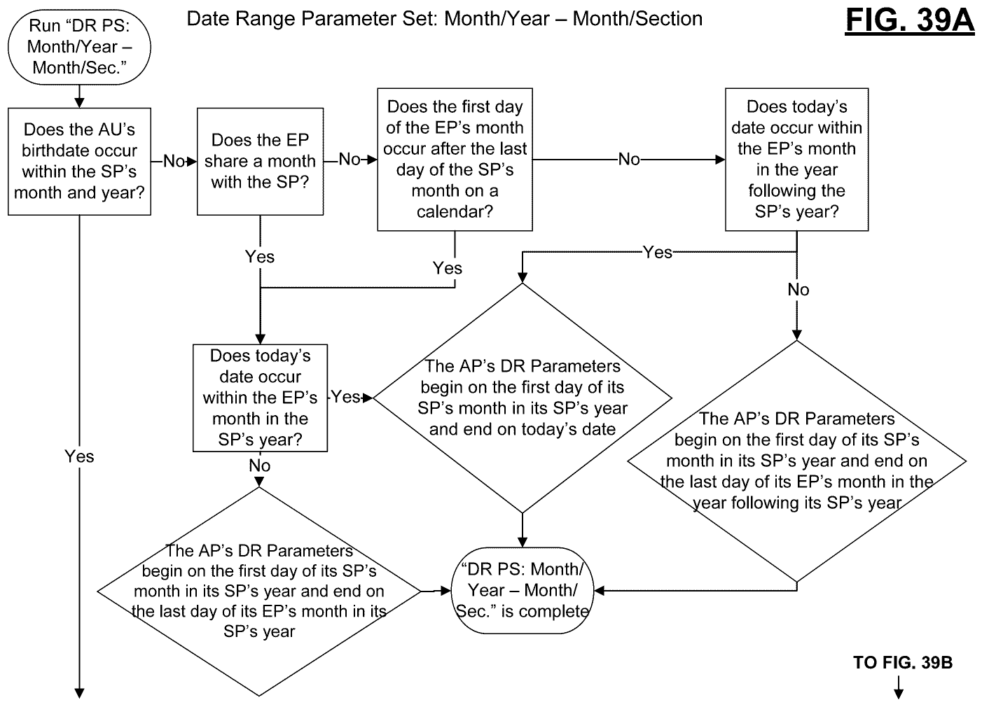

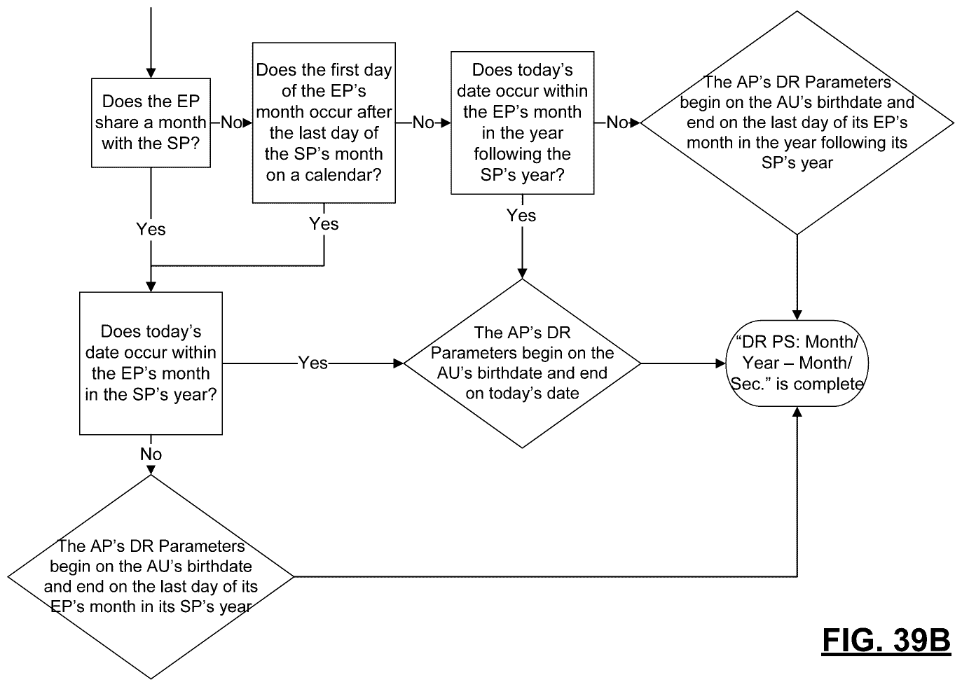

Continuing from the presented example implementation, the representative flow diagram of FIGS. 39a-39b outlines a process downstream of FIGS. 38a-38e, where a post with a month and year spanning to a month and Section may have its optimal Date Range Parameters determined. As referenced above, the optimal Date Range may often be the shortest viable parameters, so “July, 2010— January, College” may have an optimal range of parameters set to “Jul. 1, 2010— Jan. 31, 2011.” This represented example shows a distinction from the PDR Parameters of the same post, which may likely equate to “Jul. 1, 2010— Jan. 31, 2023” (wherein “2023” is representing the most recent year currently). This presented example is meant to note that the most current date that has existed in January would be the end of this example range for PDR Parameters, likely to be updated as more days in January of newer years pass. The use of the terminology “current year” is not intended to limit the scope or interpretation of this section of this Detailed Description.

Furthering the date approximation process of FIGS. 35a-35b, FIGS. 40a-40c continue on to present a representative flow diagram outlining example positioning of a post on a Timeline after date-criteria and potential parameters have been determined. If the user chooses to have the post automatically positioned, for example, the post may be placed with accuracy considerations of date-criteria, otherwise further may be run to assist the user in positioning their post on the corresponding Timeline.

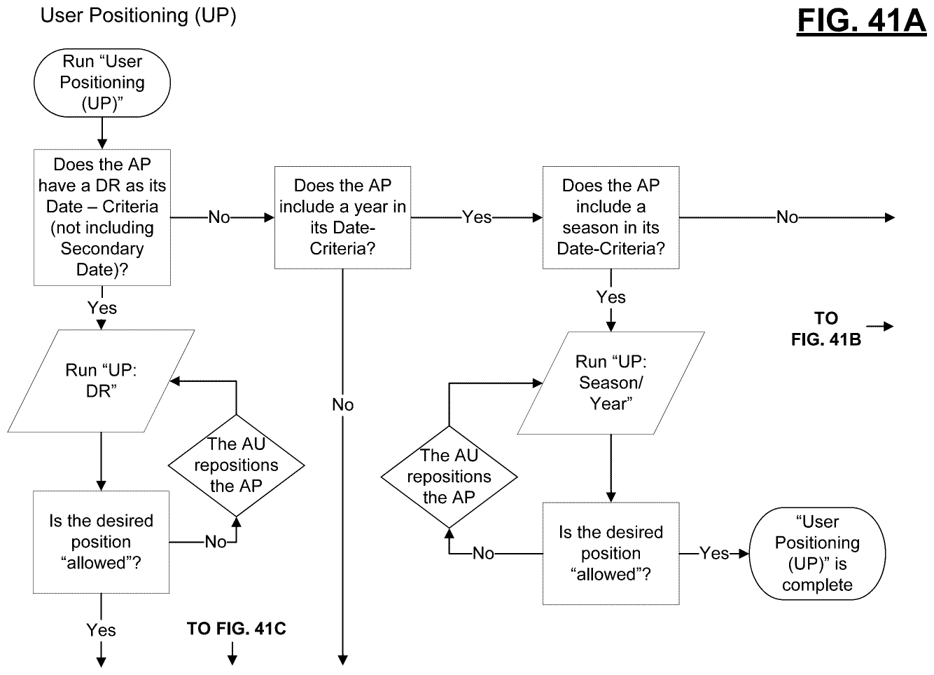

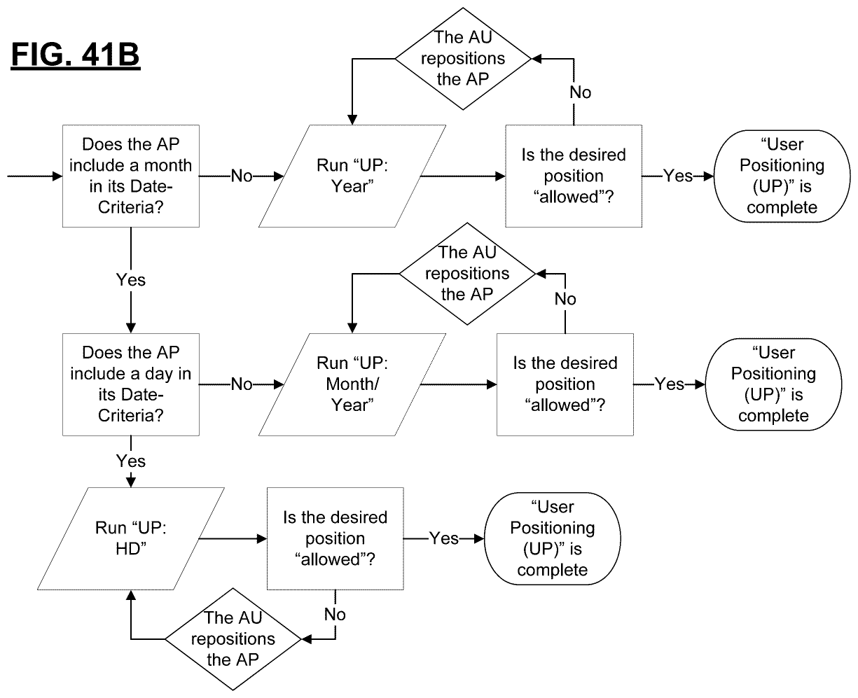

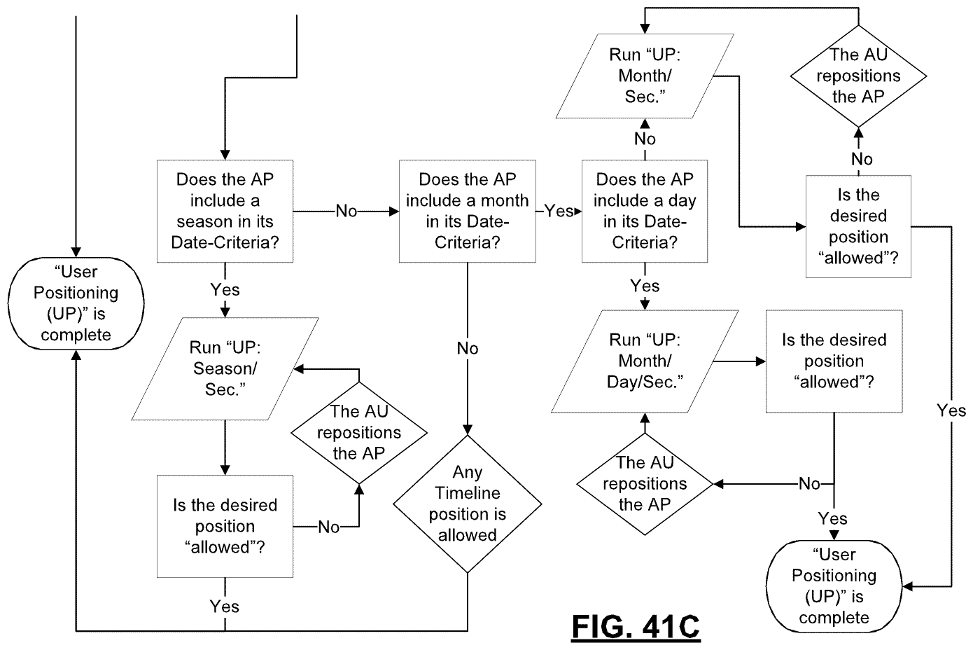

Continuing, FIGS. 41a-41c present a sample representative flow diagram for facilitating the positioning of a post on Timeline by the user, along the lines as referenced at box 45 of the representative flow diagram of FIGS. 8a-8b. This process and resulting subprocesses may help ensure that when the user is positioning a post on Timeline, it will more likely be placed in a position that falls within potential parameters and fulfills the user entered date-criteria (such as, if they indicate “July,” that the item has a date range component that covers July). Continuing, the outlined representative flow diagram assigns a user positioning feature based on the date-criteria of the in-question post.

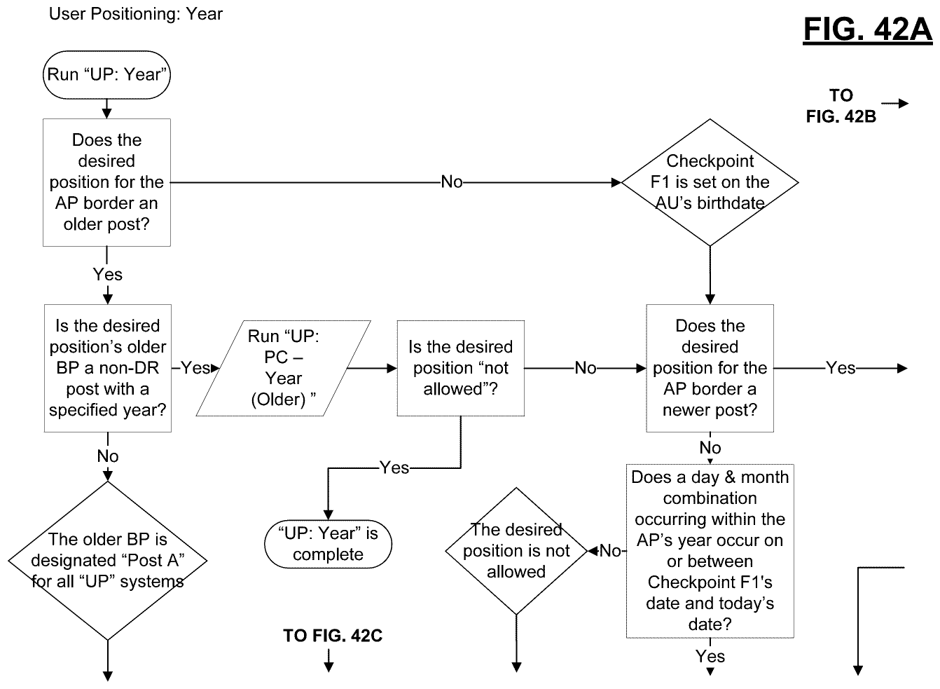

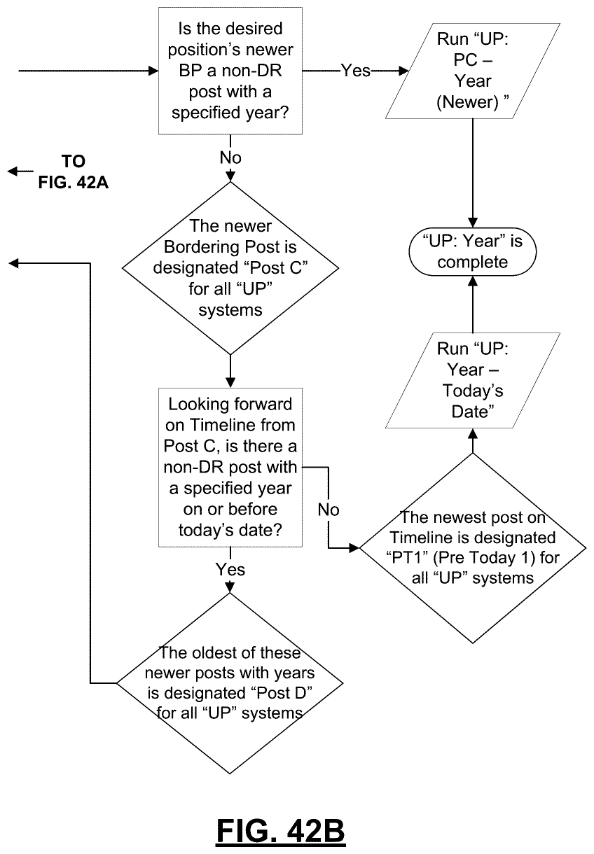

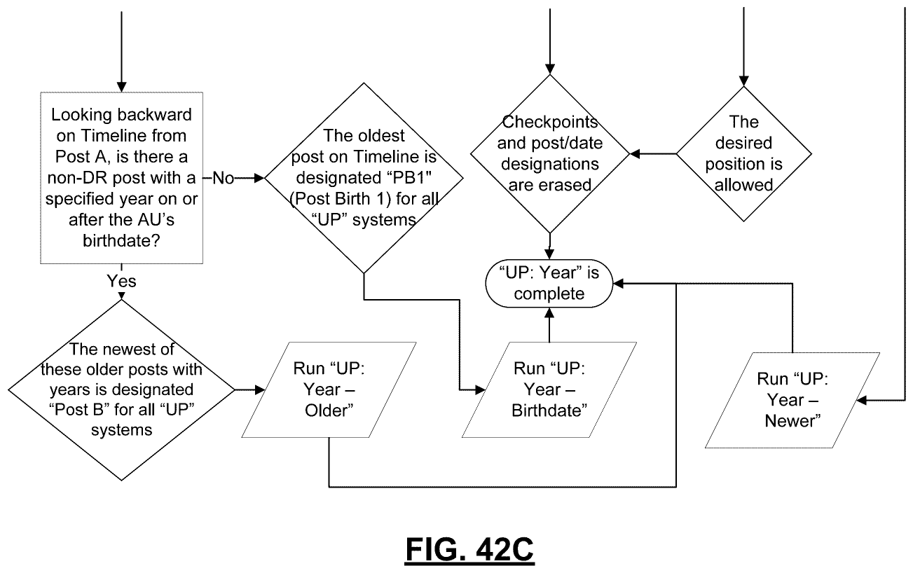

Continuing the positioning process, FIGS. 42a-42c present a sample representative flow diagram for a process for positioning a post with just a year as a date-criteria variation. This representative flow diagram takes a user desired position and checks bordering posts (if present), as well as any other posts, to ensure if the position is viable. Posts and dates on the corresponding Timeline may thereby be used to create data to ensure the viability of positioning. If the position cannot be determined to be viable from the process presented in FIGS. 42a-42c, a further process may be carried out based on what posts appear bordering the positioning post, or otherwise on Timeline.

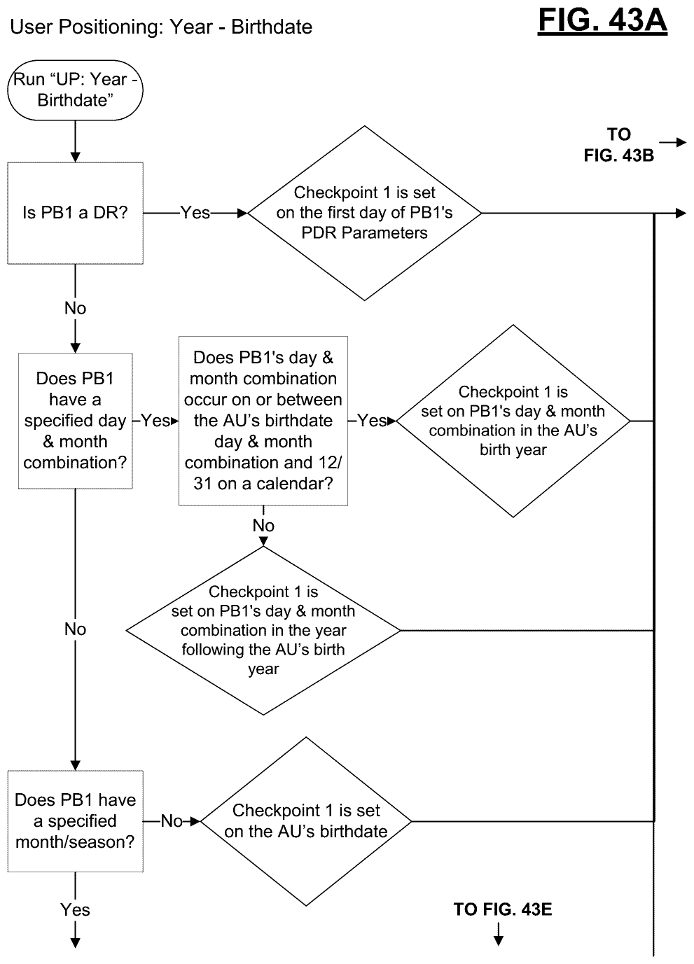

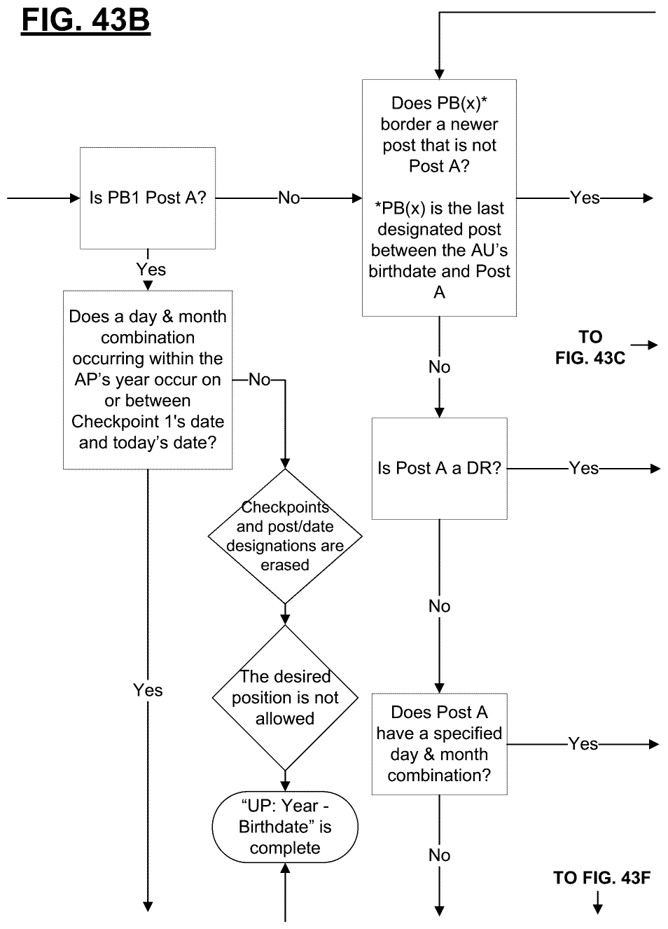

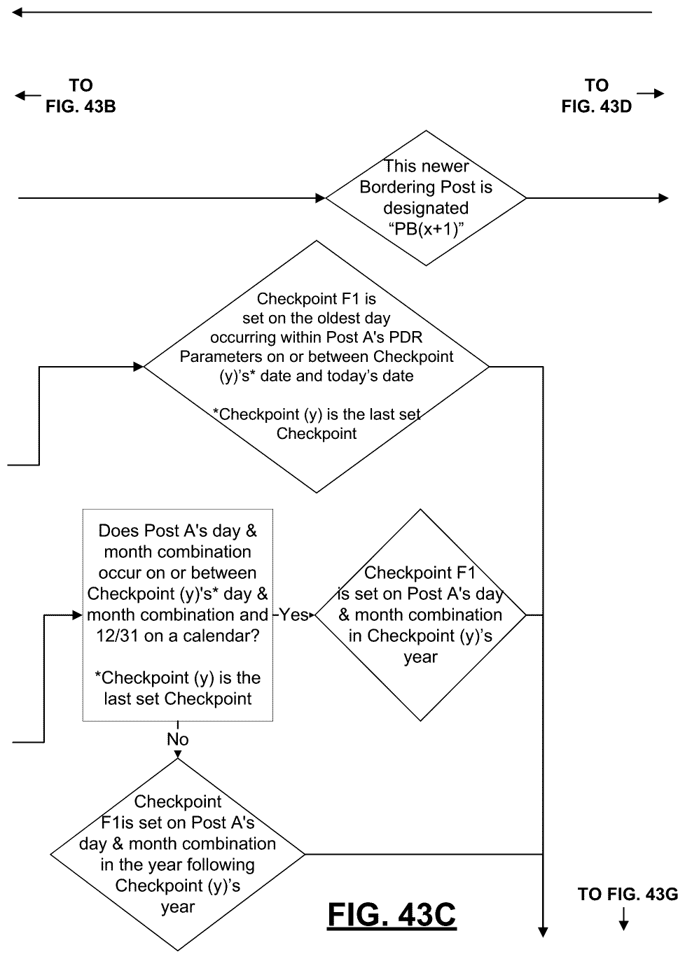

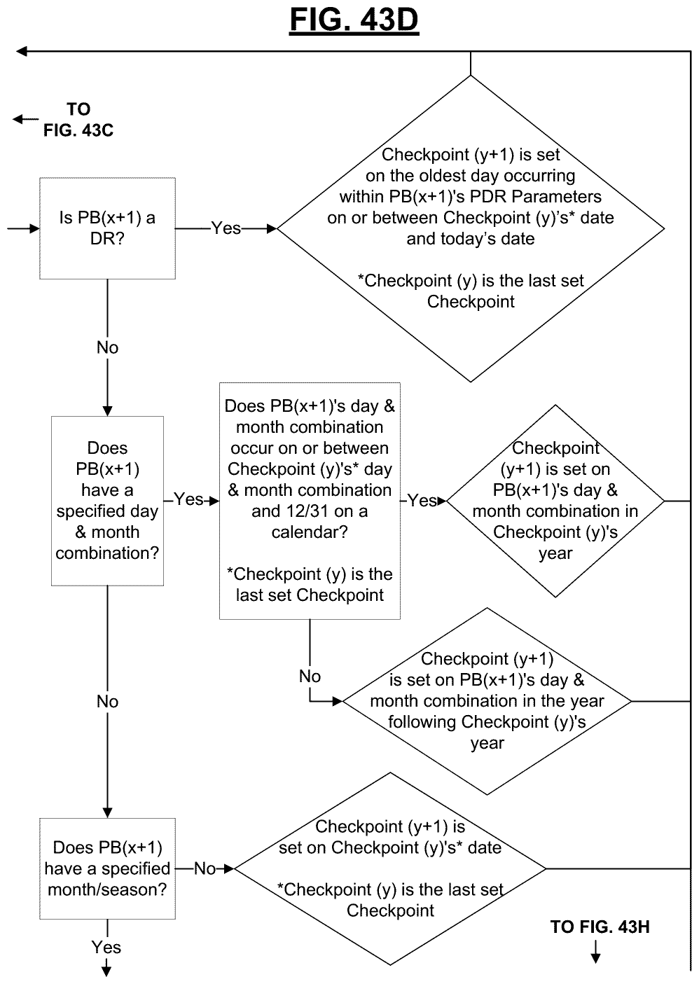

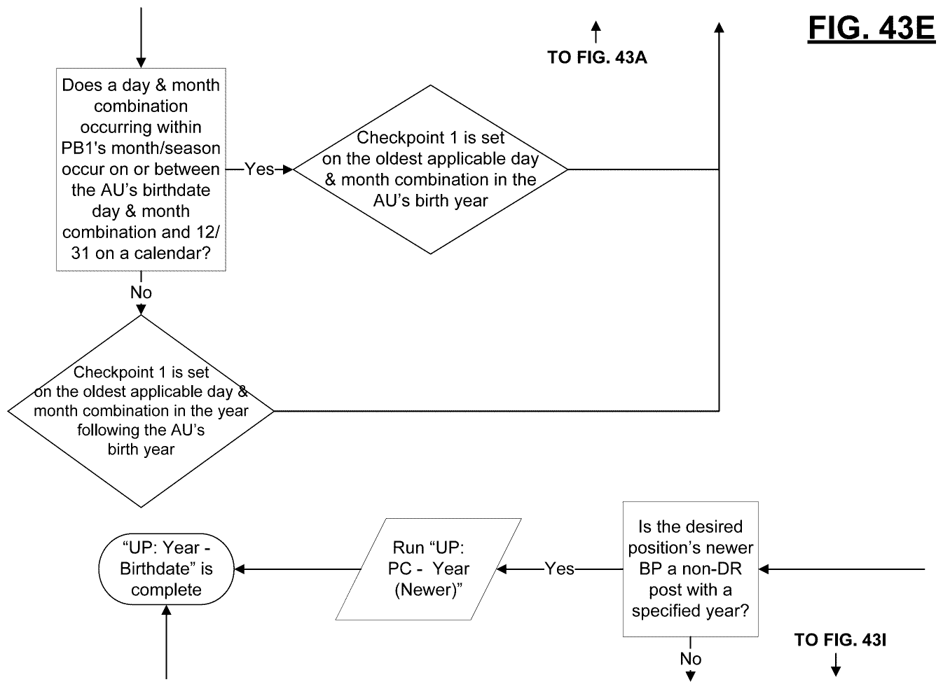

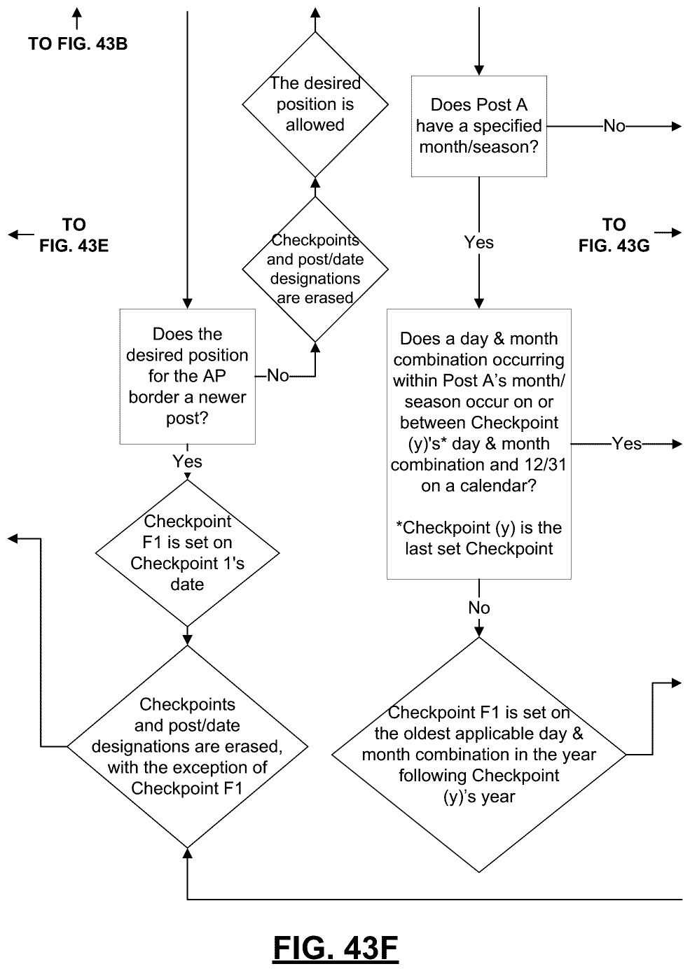

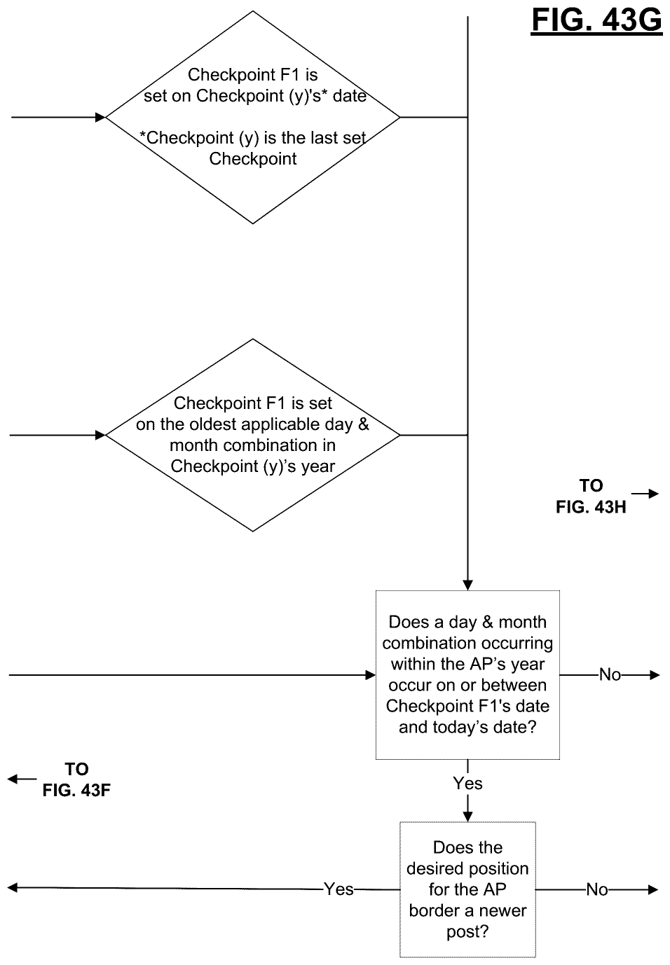

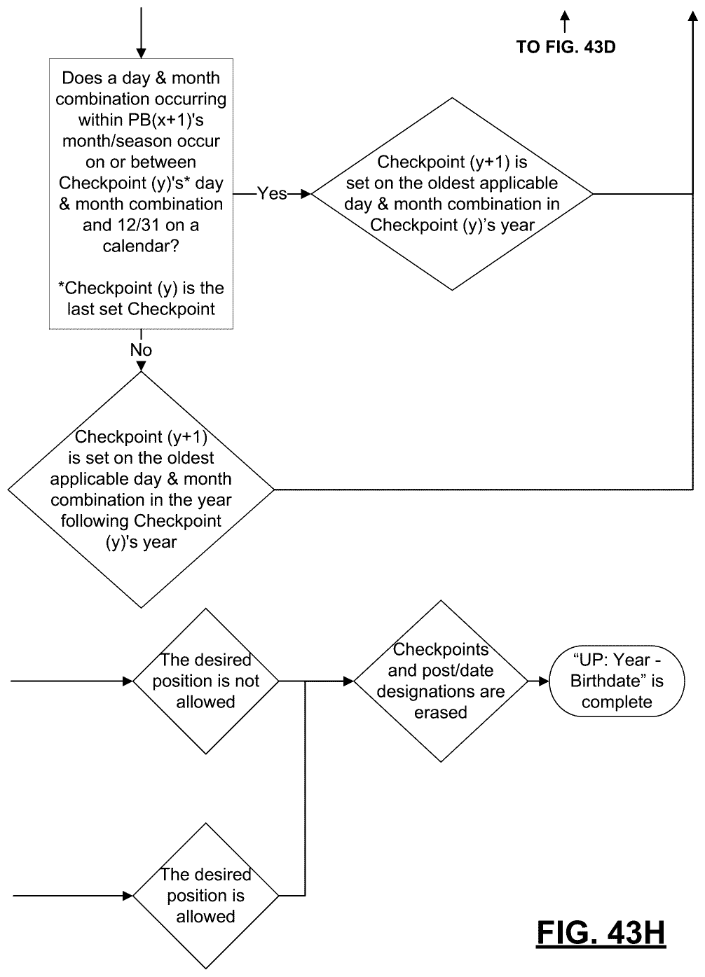

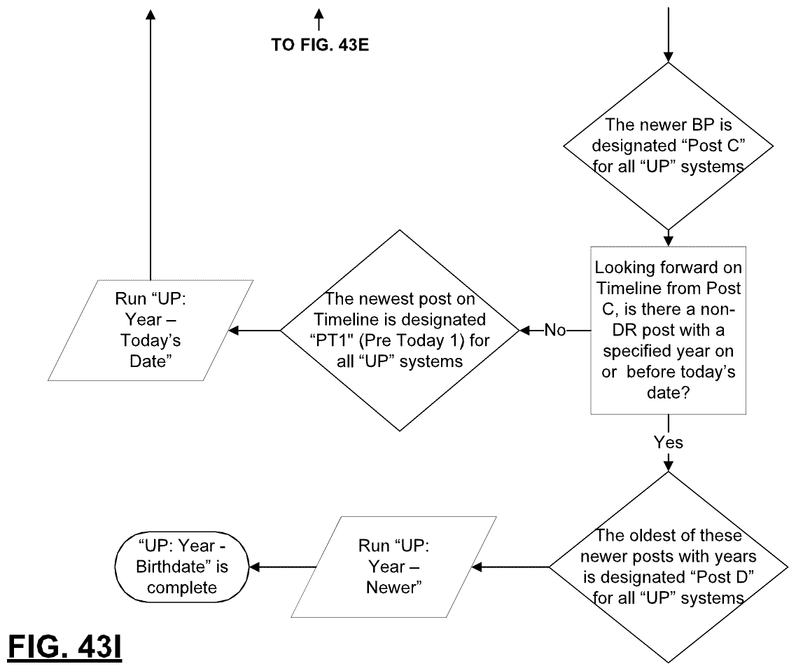

Further, in this implementation of the presented positioning systems, FIGS. 43a-43i present a representative flow diagram where the positioned post is located in a desired position. This specific desired position may, for example, have an older post bordering it, containing a Section as a date-criterion. Also, there may be no other older posts containing a year as date-criterion on Timeline from this initial bordering post. Using these older posts and their associated metadata, a checkpoint date may be set to find the oldest possible date that could be permitted in the desired position without compromising the Timeline and its linearity of dates. From the determination of the checkpoint, the position may be approved, denied, or more subprocesses may be carried out based on other posts within the Timeline.

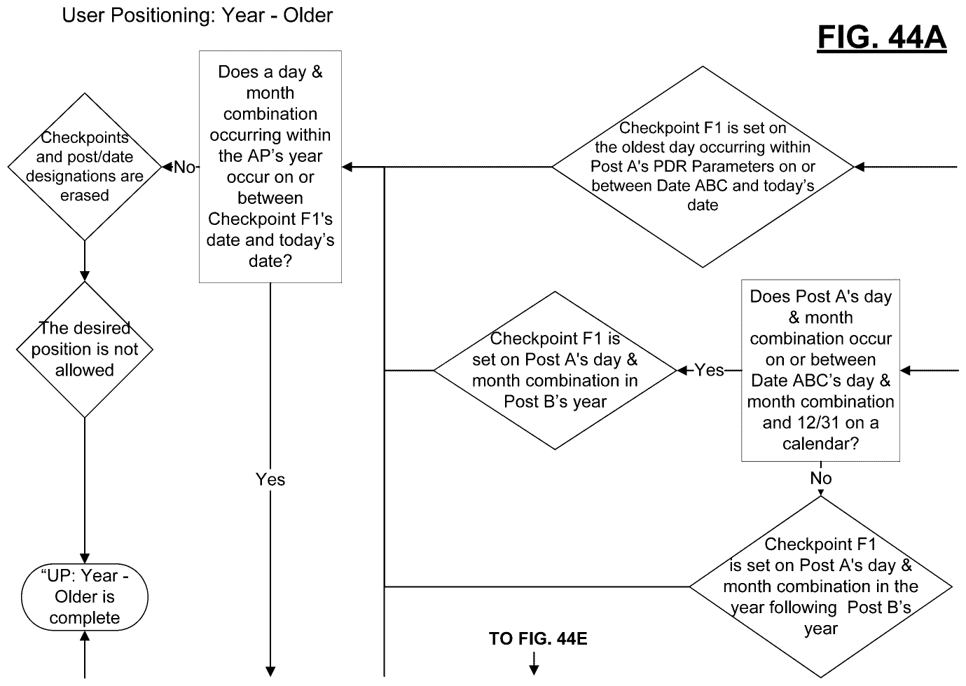

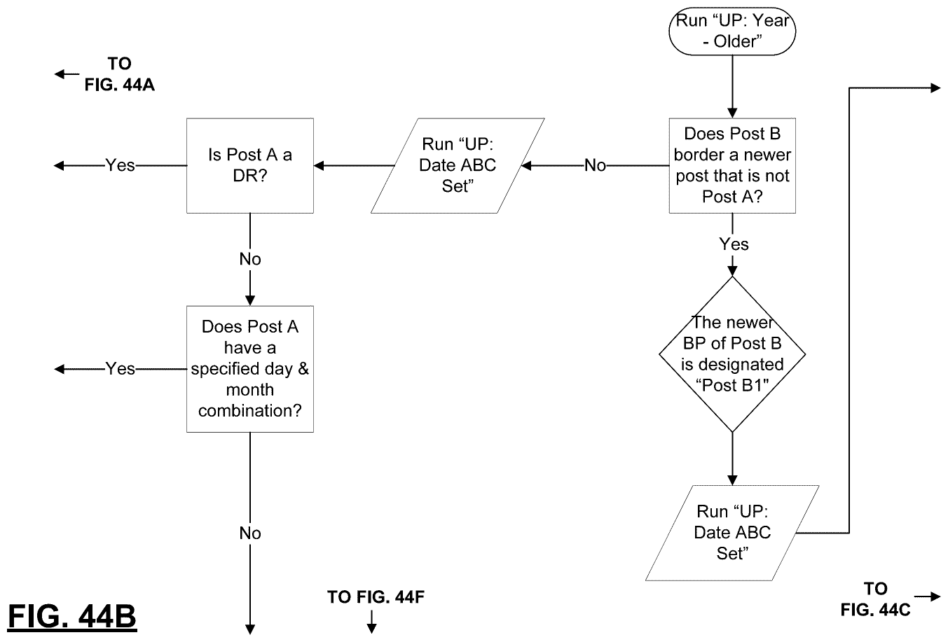

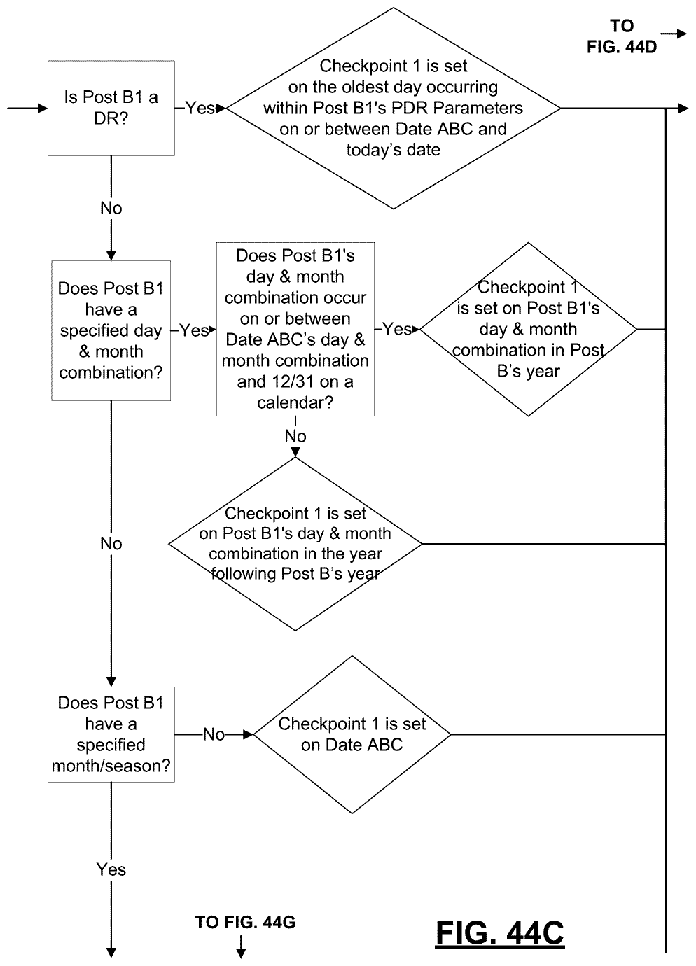

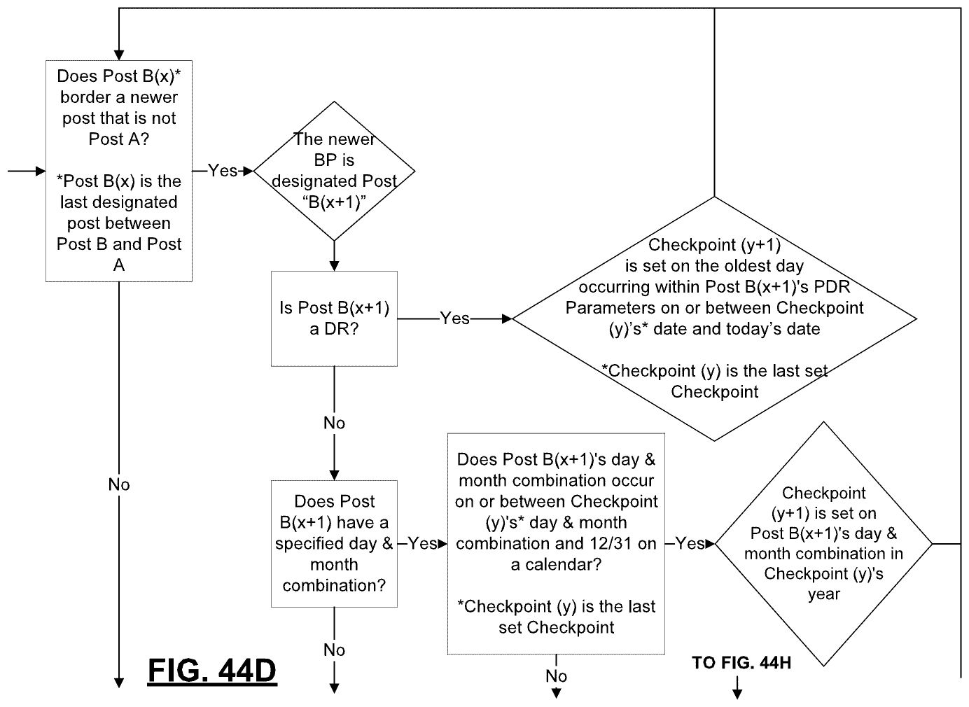

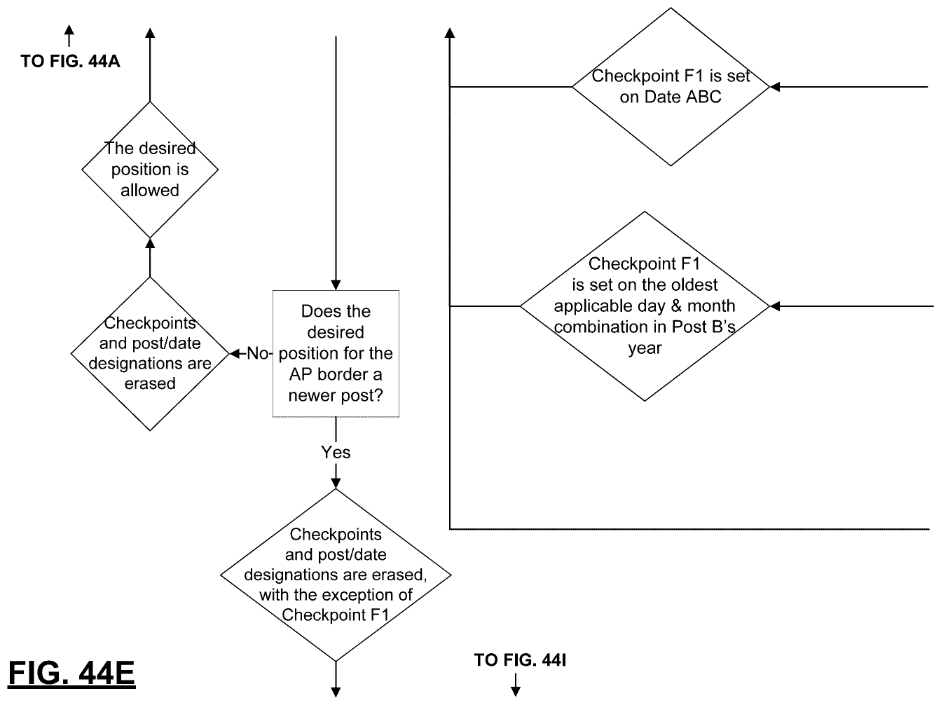

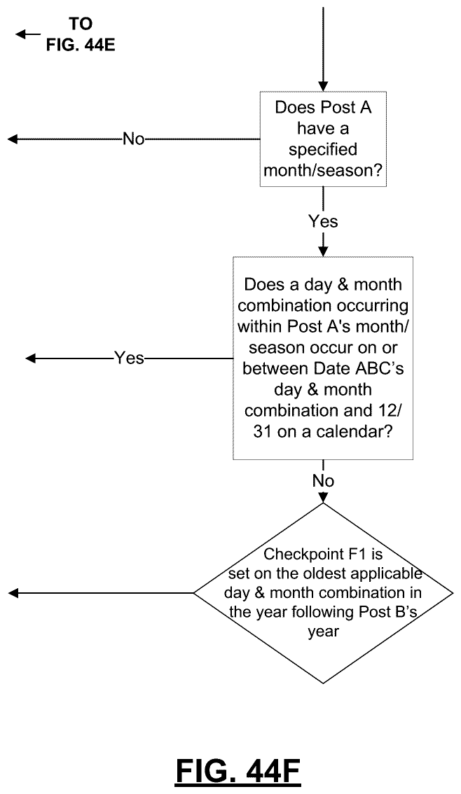

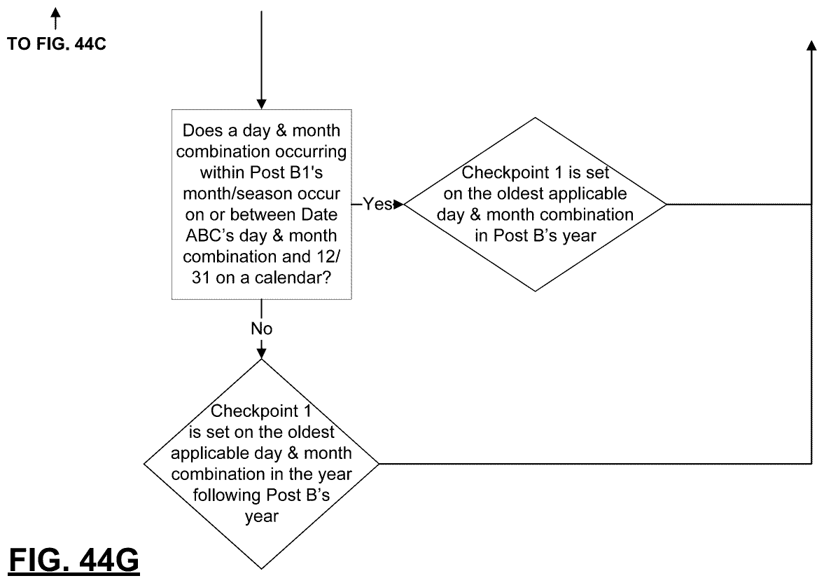

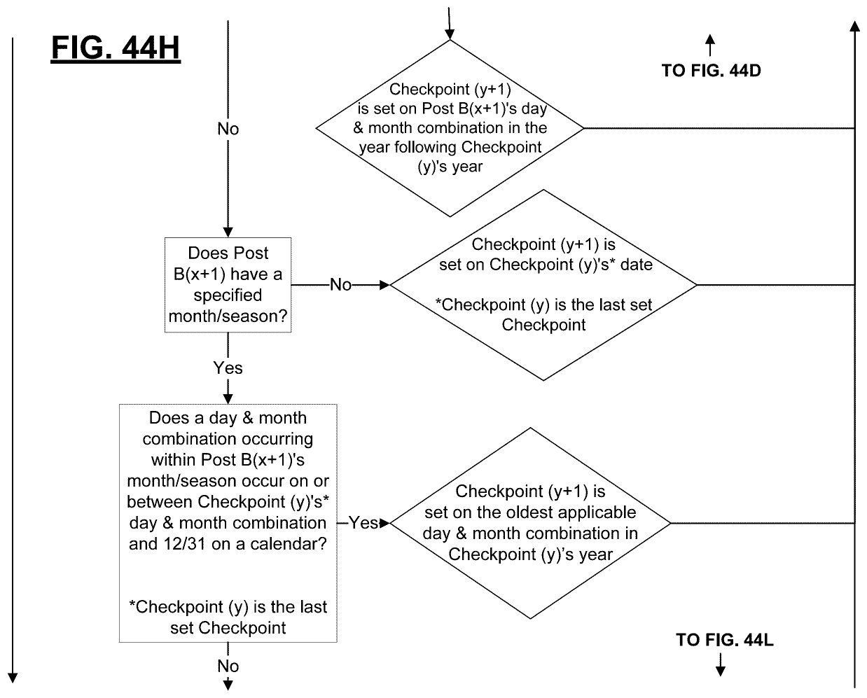

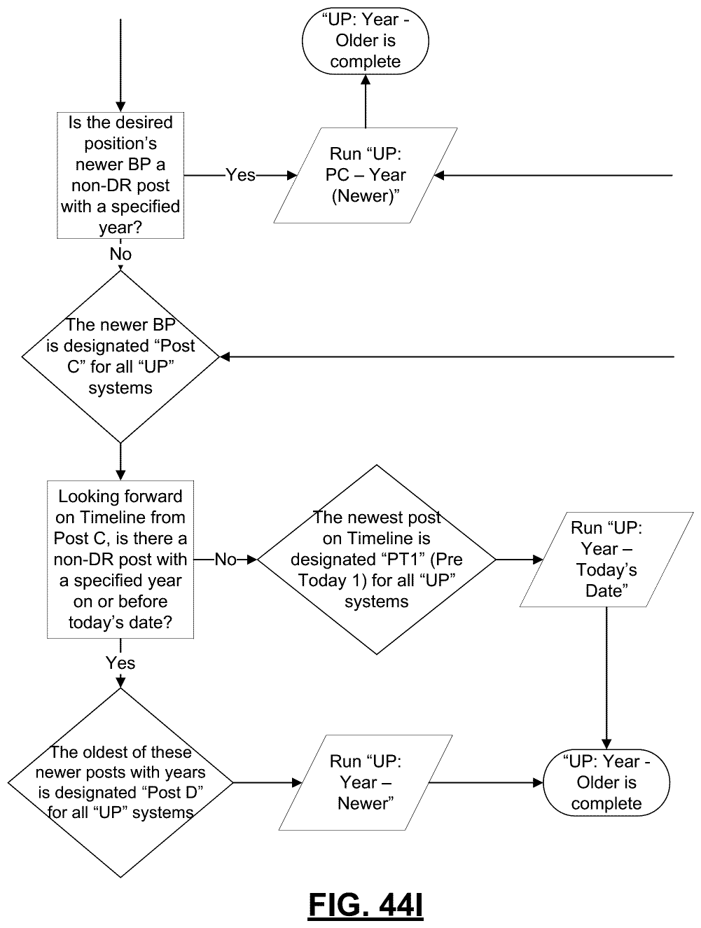

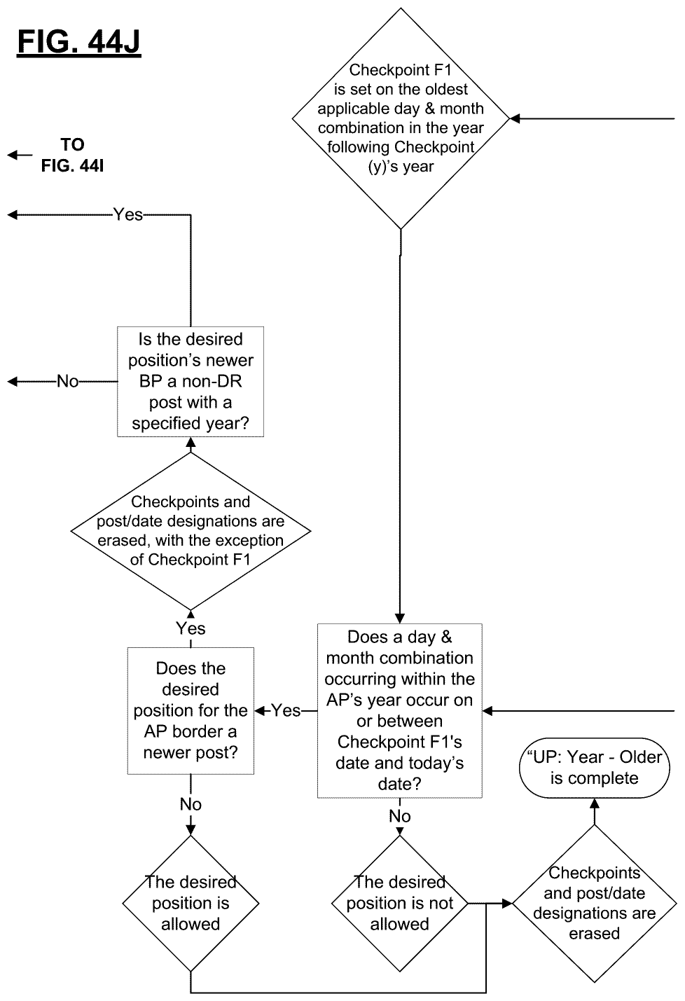

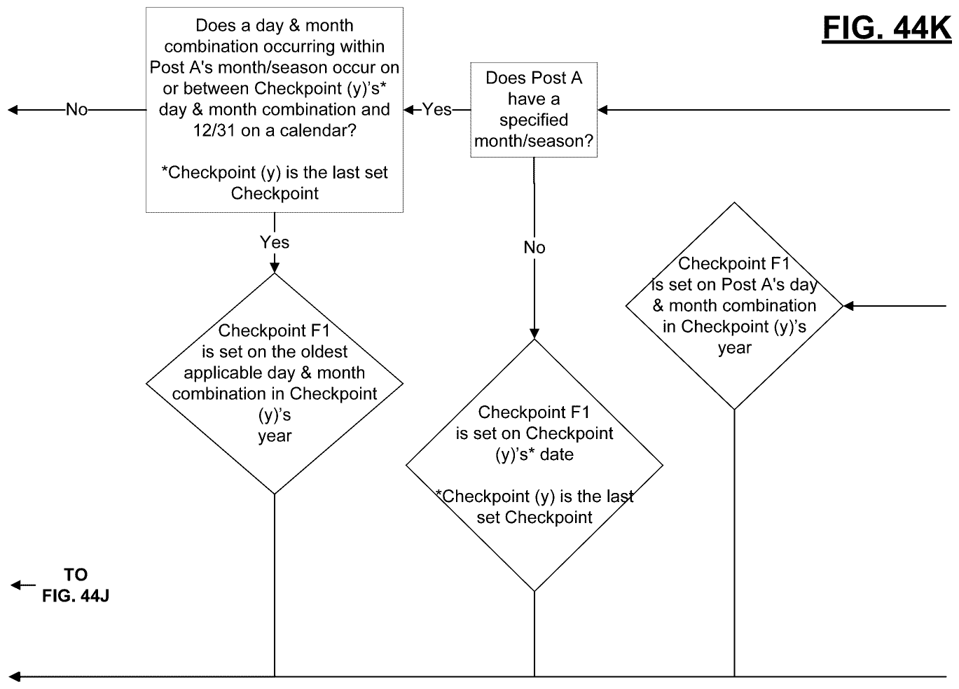

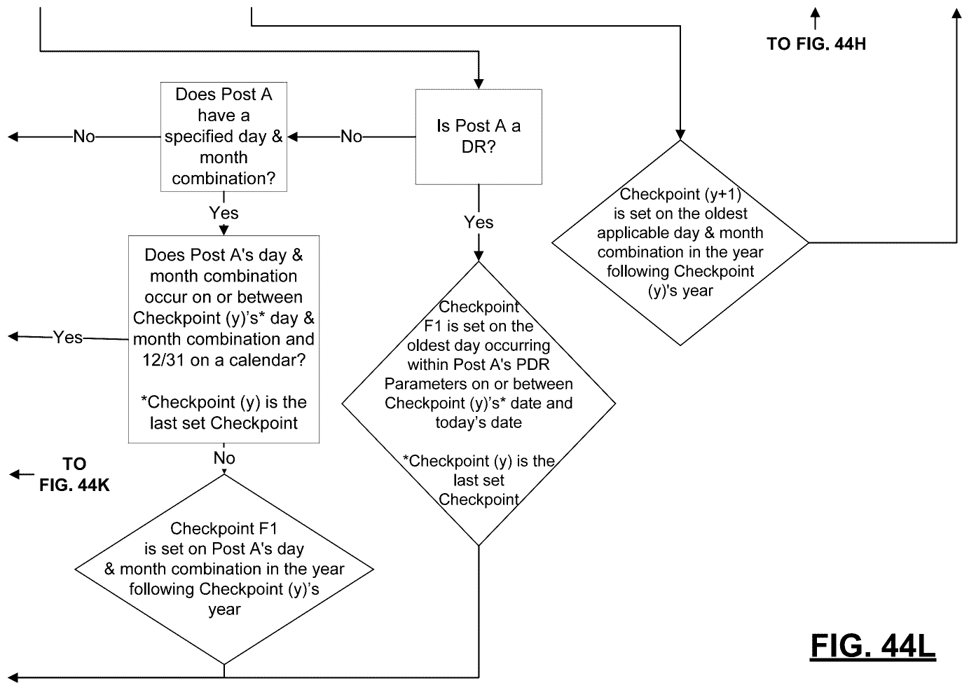

Continuing from FIGS. 43a-43i, one potential process may be carried out, as outlined in the representative flow diagram of FIGS. 44a-44l. This outlined process uses the checkpoint(s) previously set to determine if the desired position is viable for the Timeline. It is to be noted that this particular process may be used in this presented manifestation, for example, when a desired position is bordering a newer post with no year in its date-criteria, while no other newer-positioned posts with years in their date-criteria exist on the Timeline.

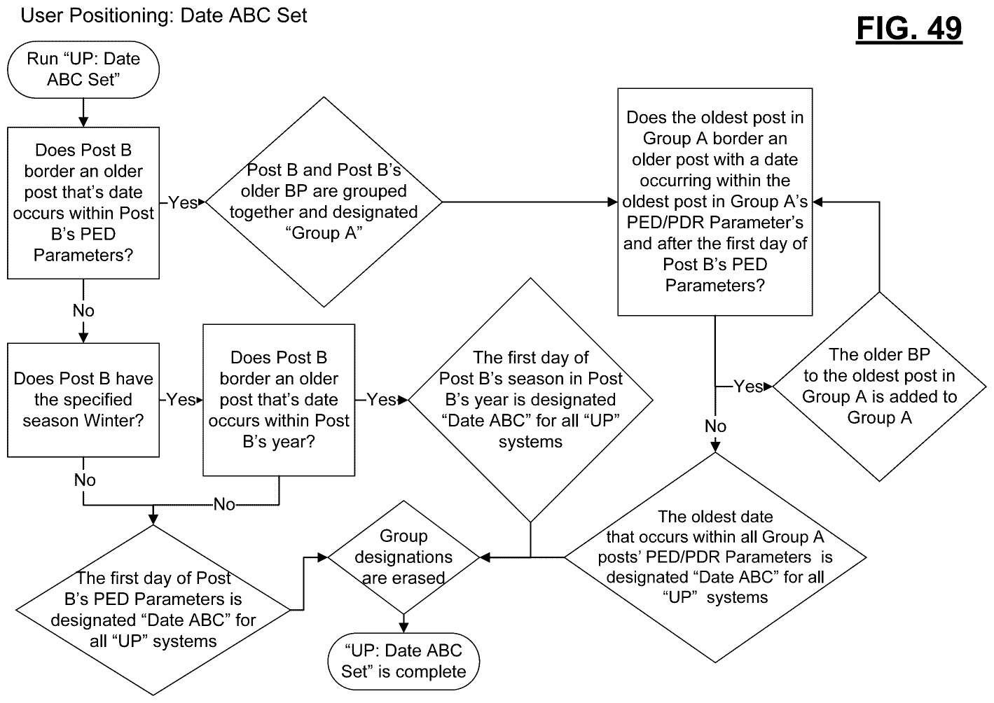

Alternatively, in place of FIGS. 43a-43i, a separate process may be carried out to continue the position validation of the user desired position, for example. An example implementation of this manifested process is the process depicted in FIGS. 44a-44l, presenting a representative flow diagram representing validation of a position where an older bordering post with a Section as date-criteria exists, but there is also present another older-positioned post on the Timeline with a year in its date-criteria. Within the presented process of FIGS. 44a-44l, a subprocess may be carried out to determine a date that assists in validating the desired position, referred to as “Date ABC” for the sake of this description. FIG. 49 presents a representative flow diagram outlining the process for setting this Date ABC, following the previous flow chart. When Date ABC is set, the representative flow diagram of FIGS. 44a-44l continues, setting a checkpoint to help determine the validity of the desired position.

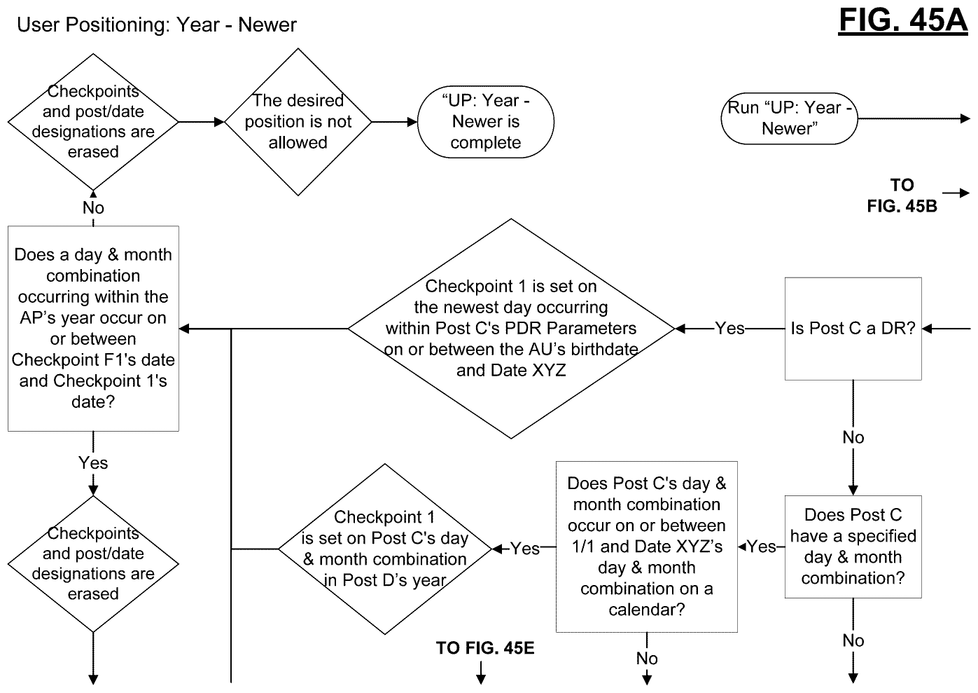

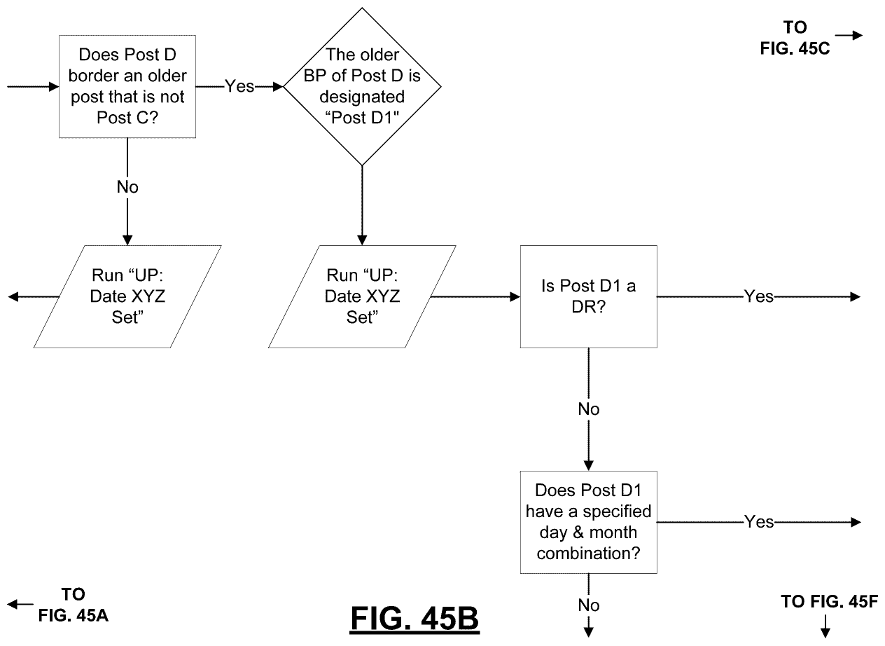

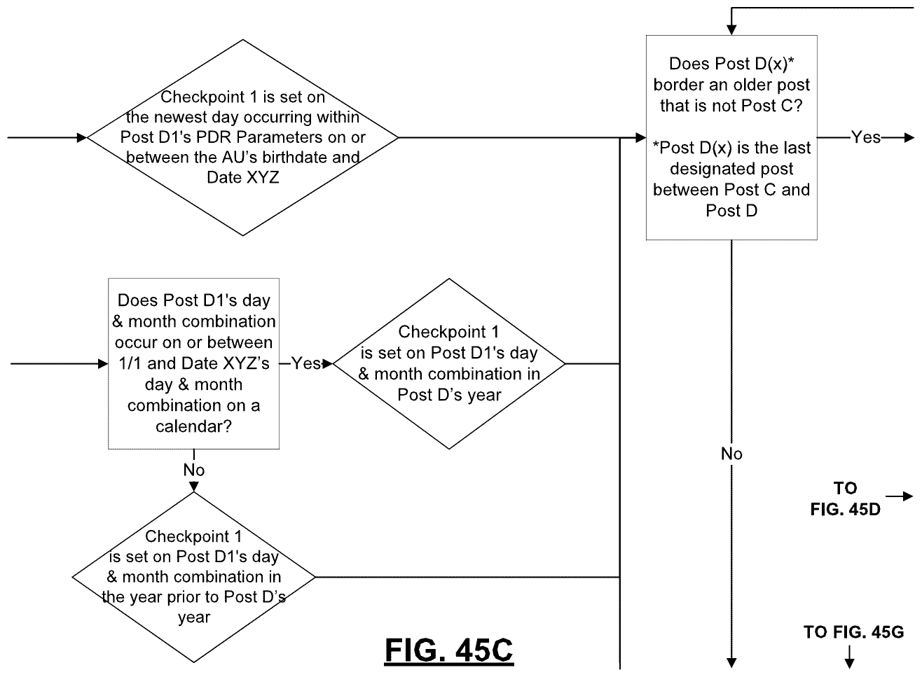

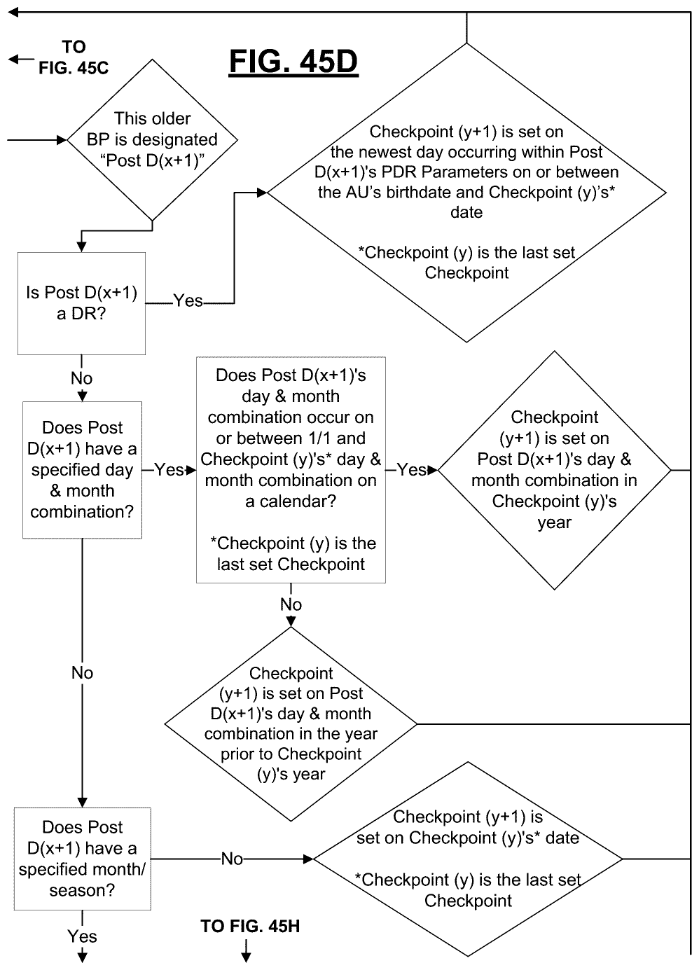

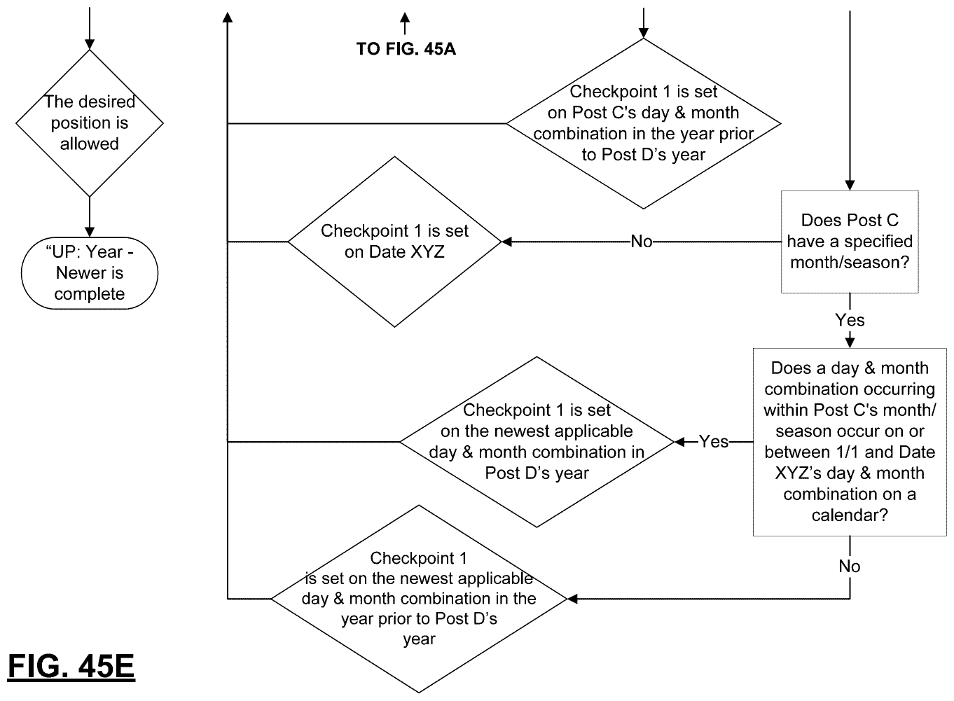

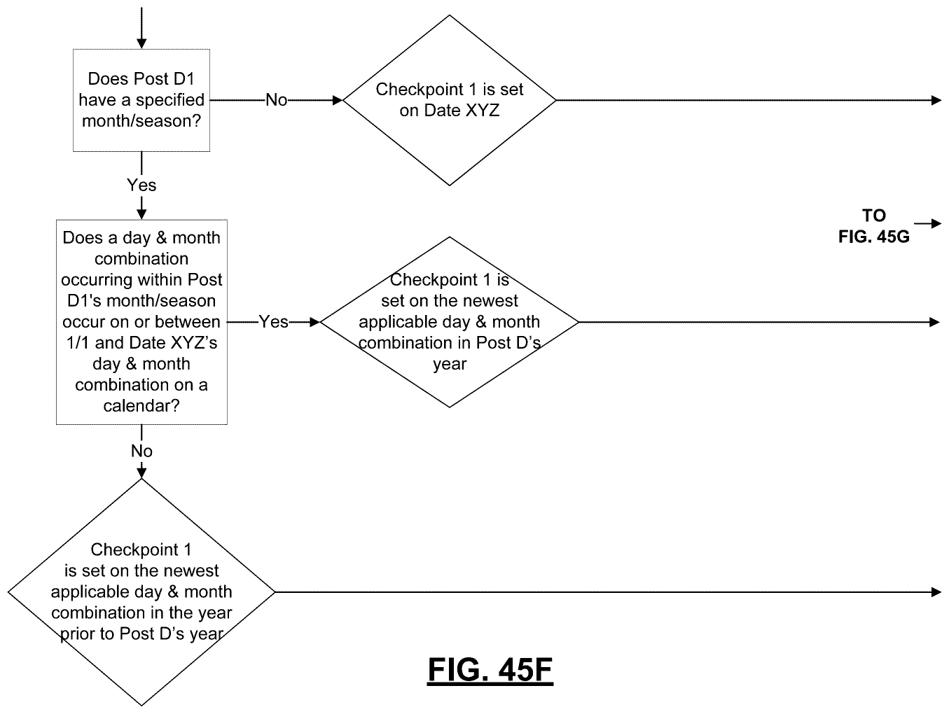

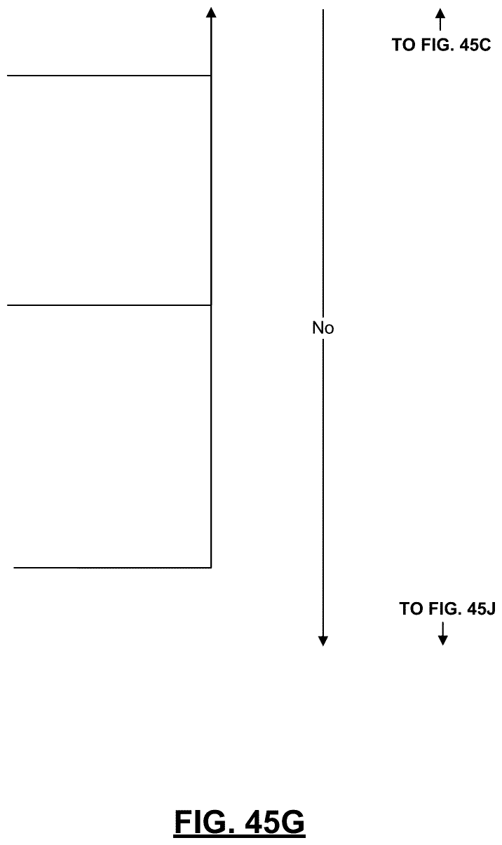

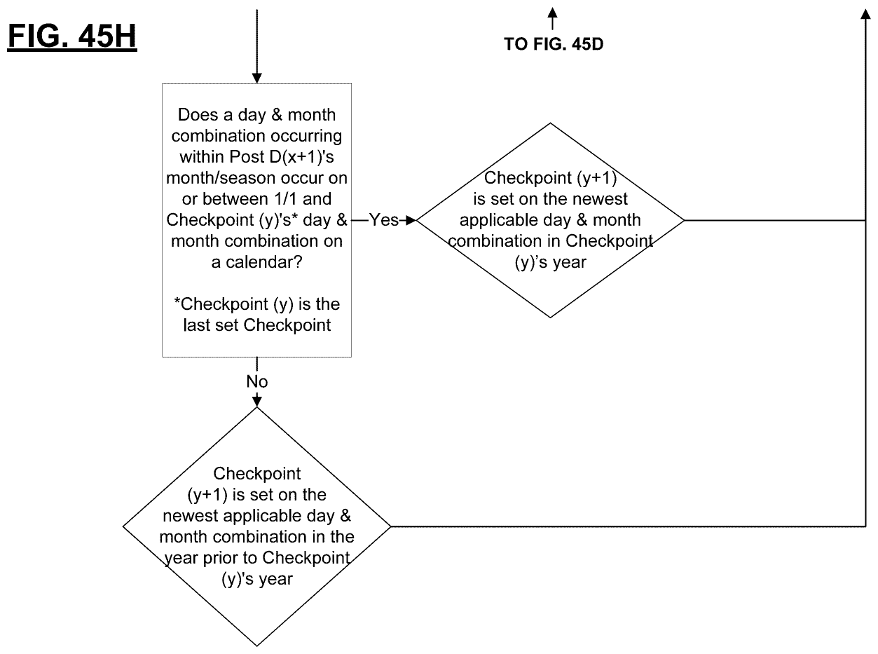

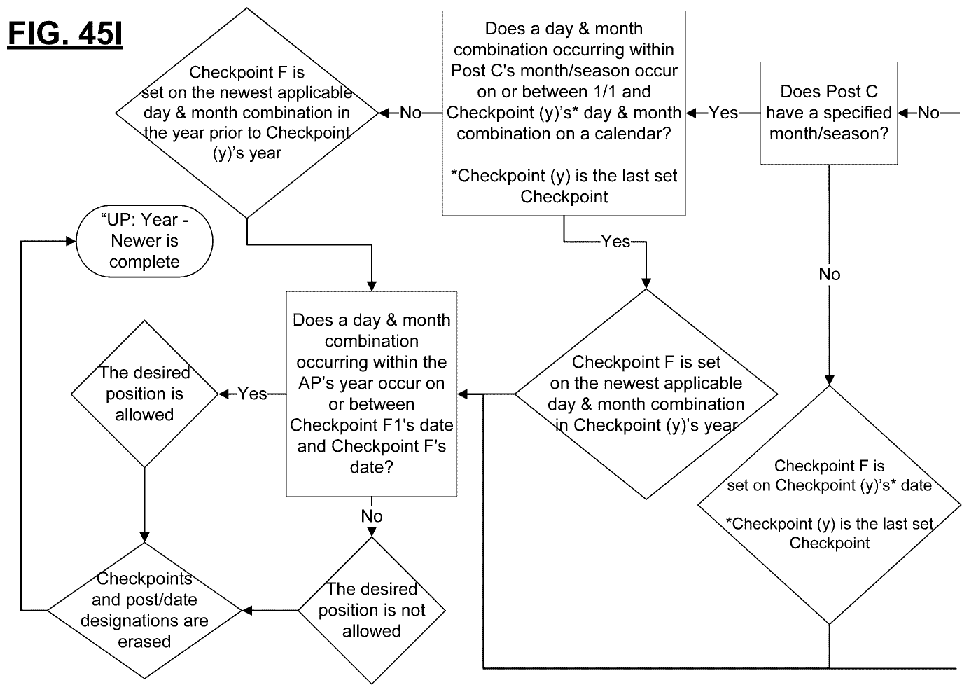

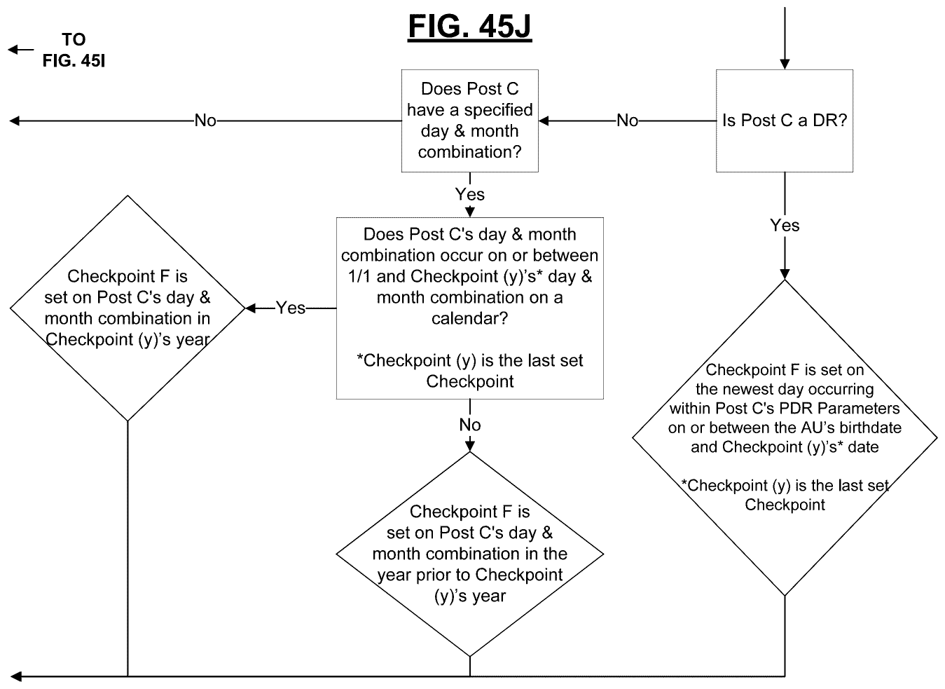

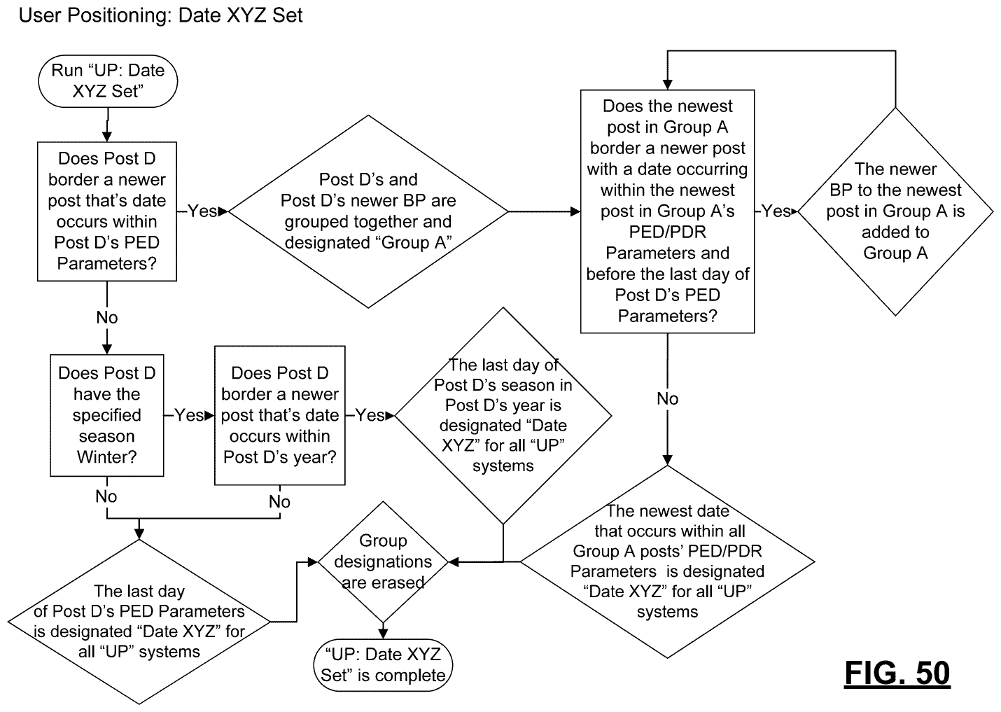

Continuing from FIGS. 44a-44l, one potential process may be run, as outlined in the representative flow diagram of FIGS. 45a-45j. This outlined process may use the checkpoint(s) set prior to determine if the desired position is viable for the Timeline. It is to be noted that this particular process may be used in its presented manifestation, for example, when a desired position is bordering a newer post with no year in its date-criteria, while there also exists another newer-positioned post with a year (but no Date Range) in its date-criteria on Timeline. Within the presented system of FIGS. 45a-45j, a subprocess may be carried out to determine a date that assists in validating the desired position, referred to as “Date XYZ” for the sake of this description. FIG. 50 presents a representative flow diagram outlining an example process for setting this Date XYZ, following the previous flow chart. When Date ABC is set, the representative flow diagram of FIGS. 45a-45j continues, setting a checkpoint to help determine the validity of the desired position.

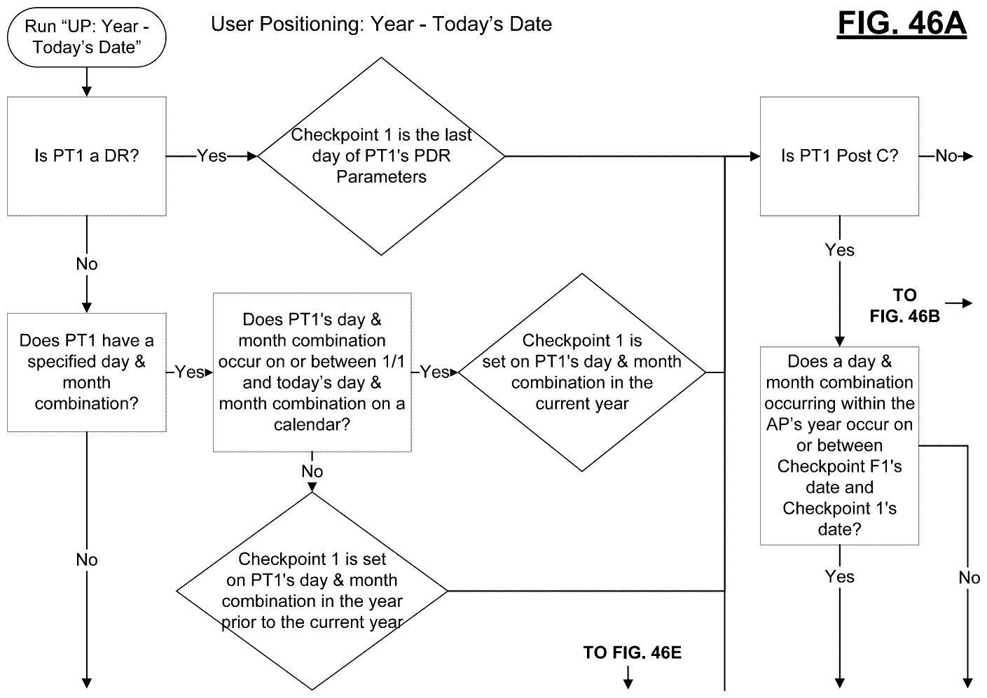

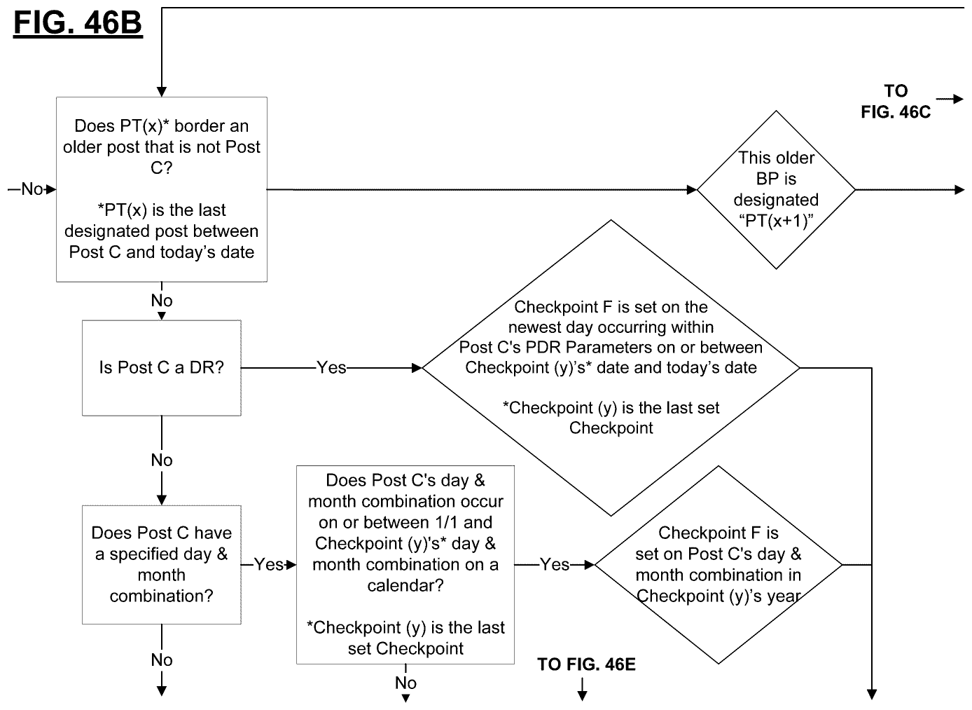

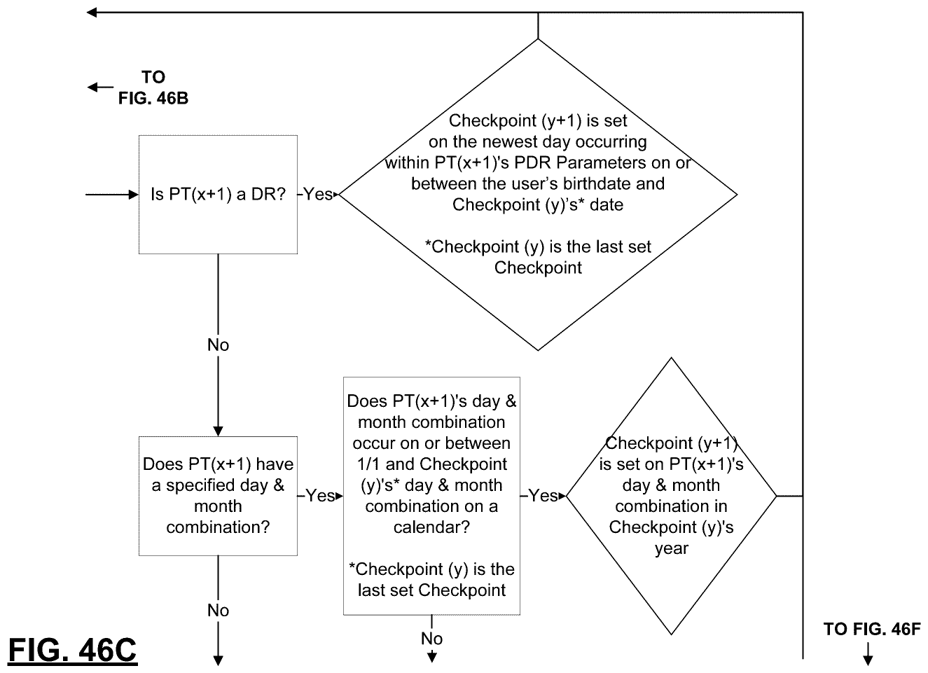

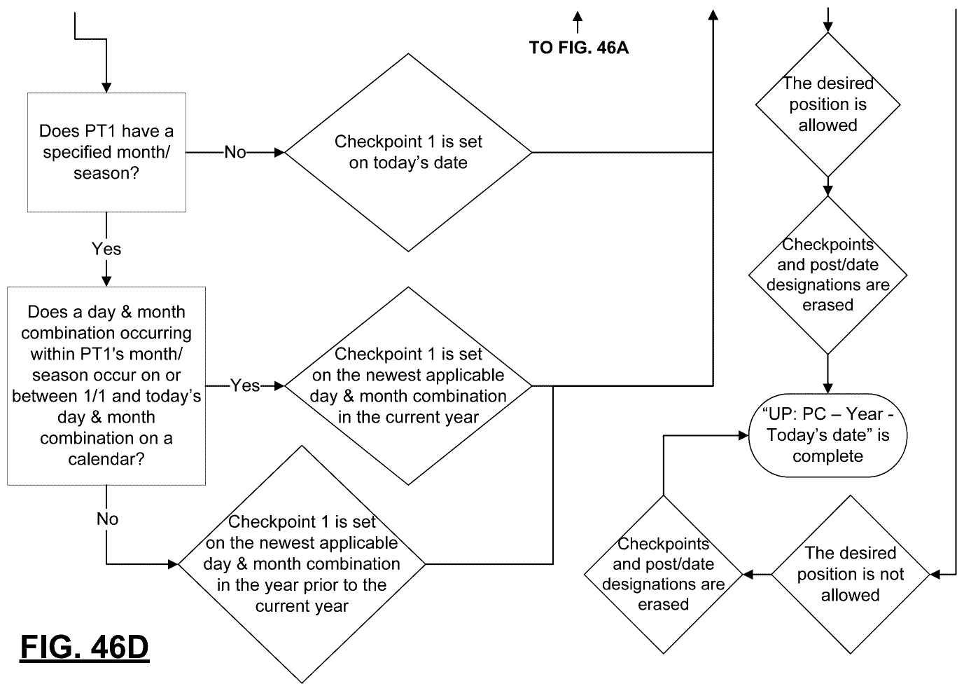

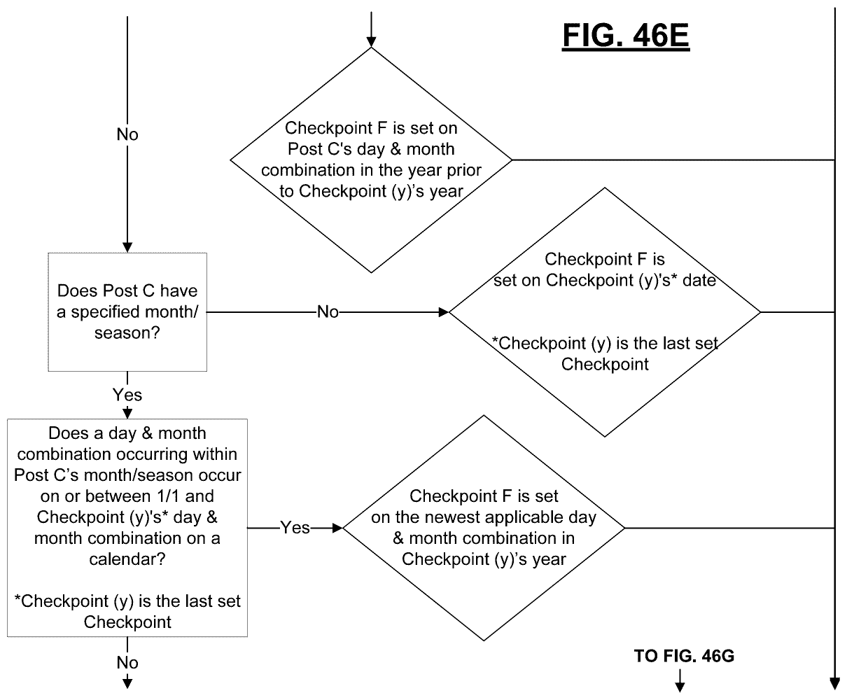

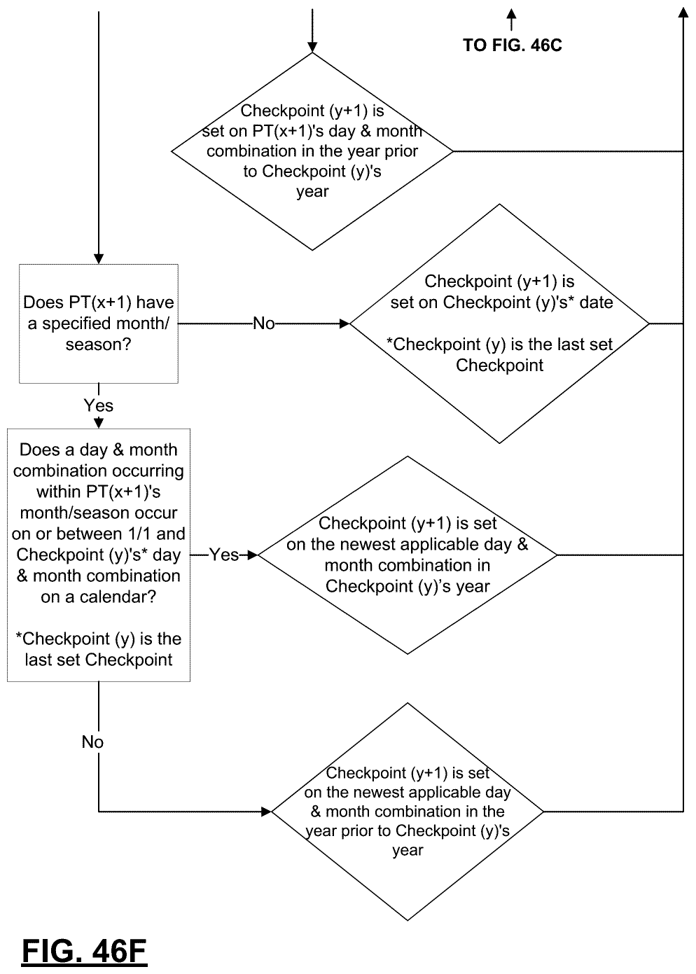

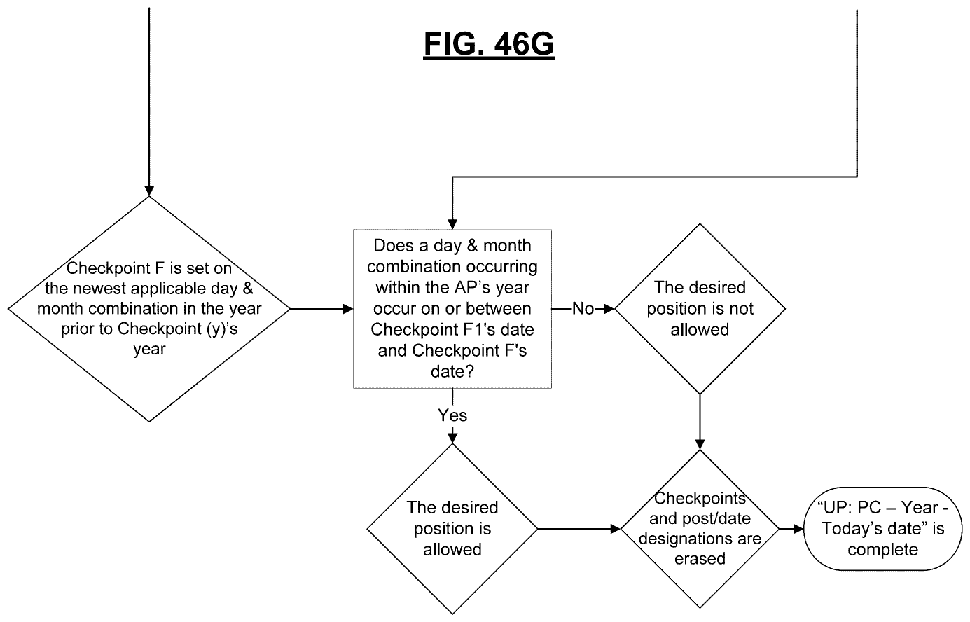

An alternate path from the representative flow diagram of FIGS. 44a-44l may run a potential process, as outlined in the representative flow diagram of FIGS. 46a-46g. The outlined process may, for example, use checkpoint(s) set previously to determine the viability of the desired position. This particular process may be used in the presented implementation when the desired position is bordering a newer post with no year in its date-criteria, while there does not exist another newer-positioned post with a year (but no Date Range) in its date-criteria on the Timeline.

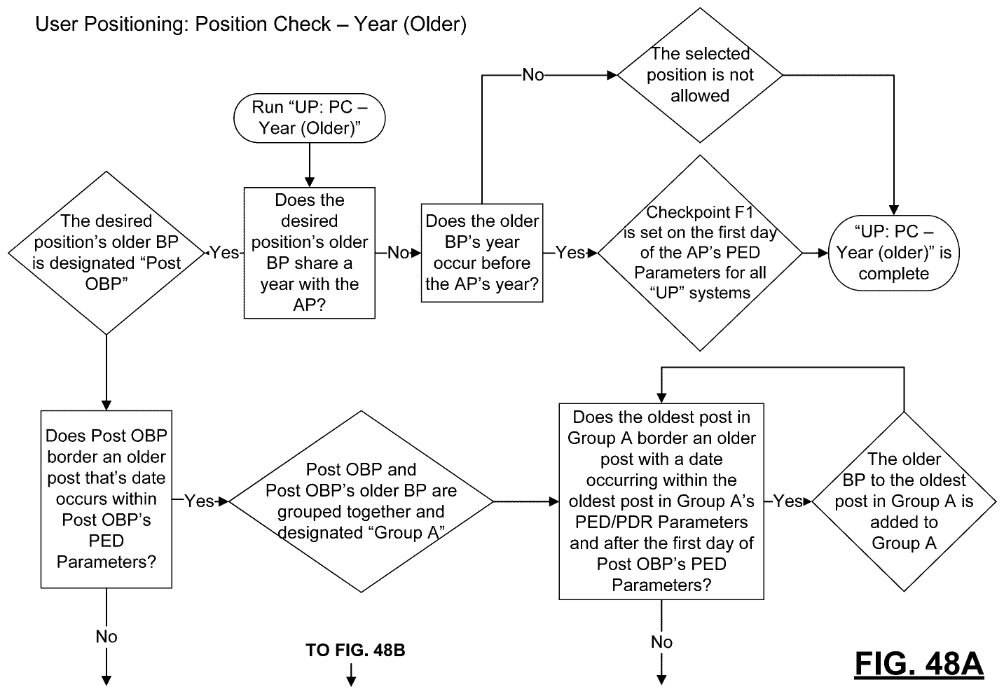

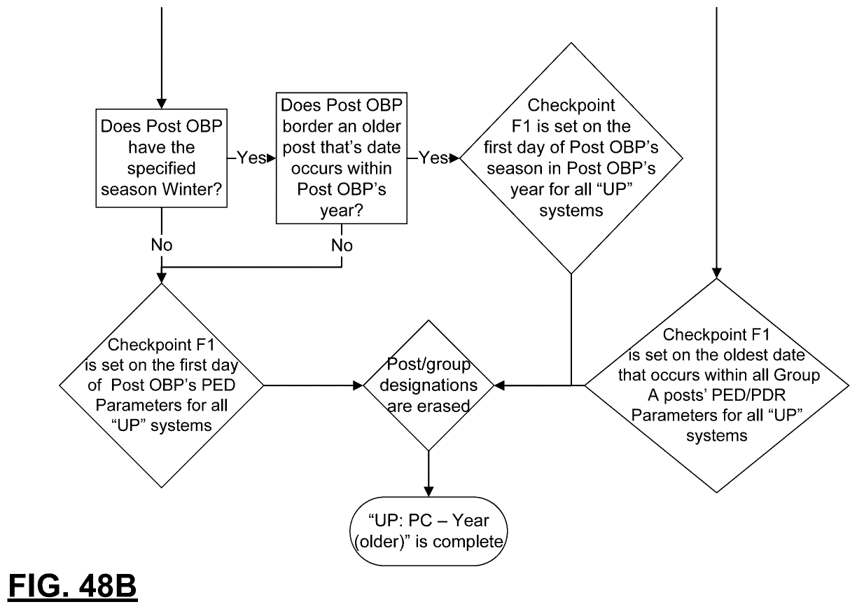

Returning to continue from the representative flow diagrams of FIGS. 43a-43i and 44a-44l, FIGS. 47a-47b present a sample representative flow diagram walking through a viability check on the desired position for some variations. It is to be noted that this position check system may be used for a post with a year as date-criteria, for example. Multiple variations of this position check system may exist, tailored for use for each variation of date-criteria the positioned post may have. Continued from the representative flow diagram of FIGS. 42a-42c, FIGS. 48a-48b present a sample representative flow diagram where a checkpoint is set for the post in a desired position with a year included in its date-criteria. This process helps facilitate a position check of the overarching process that it is included in. Another variation of this presented process may be used for posts that have a Date Range or Section included as their date-criteria.

It is to be noted and made clear that this detailed description outlines a post with a year being positioned as an example; however all differing date-criteria posts may have unique processes to determine position viability, through functioning in a similar manner to as described herein.

Continuing the presented positioning processes, FIGS. 51a-51e present a representative flow diagram that may assist in ensuring the integrity of the Timeline and the viable positioning of posts before an approximated date is added to the newly positioned post. This process may be used, for example, to check to make sure no approximated dates of older-positioned posts are newer than the potential parameters of the new post, as well as in the opposite time direction (no newer-positioned posts with older approximated dates than the potential parameters of the new post). If these or other disparities are presented, posts may be removed from the Timeline and re-added to ensure recreation of appropriate metadata and approximated date.

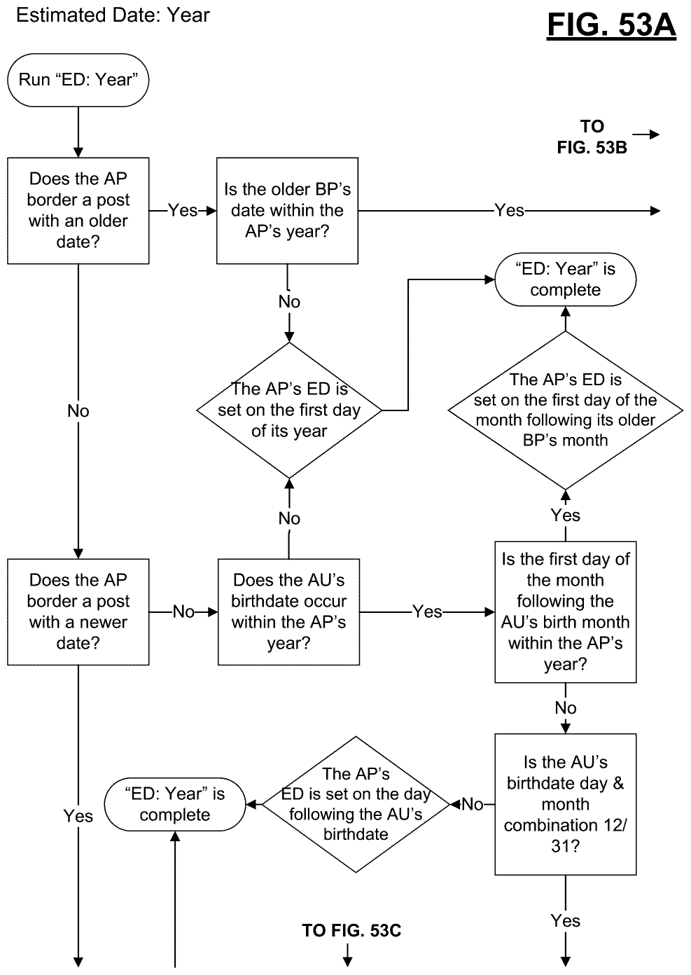

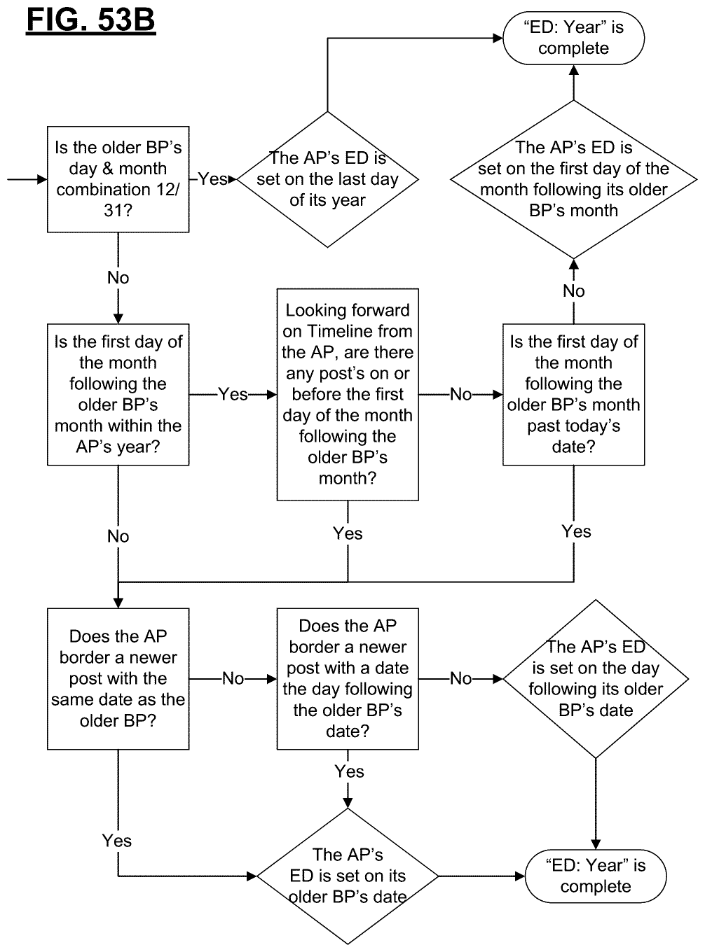

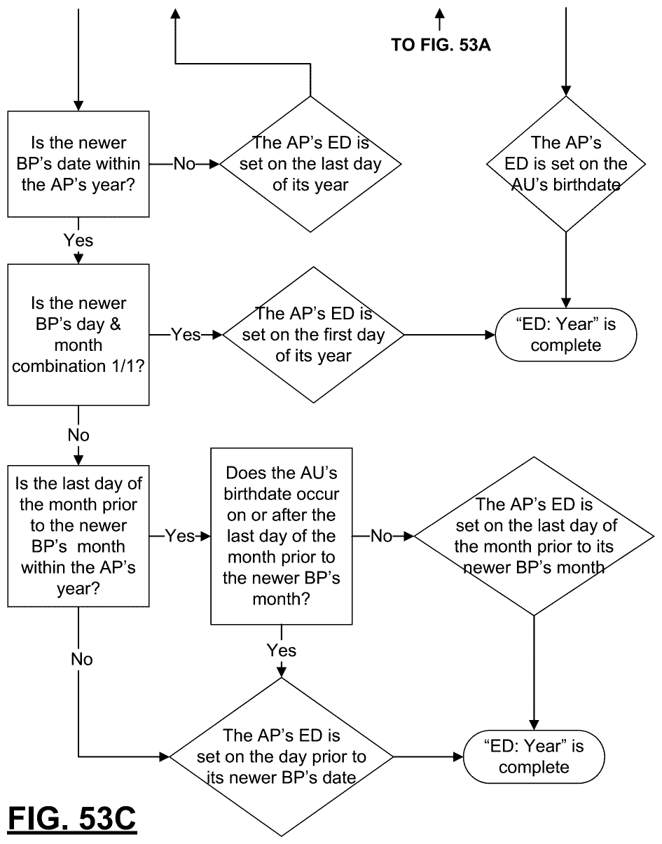

Continuing from the Timeline integrity check outlined in FIGS. 51a-51e, FIGS. 52a-52b present a representative flow diagram that assigns an approximated date on a post without a Date Range as date-criterion. To have a date assigned, the outlined process of FIGS. 52a-52b may determine an appropriate subprocess that will walk through the corresponding steps. Next, FIGS. 53a-53c present another sample representative flow diagram assigning an approximated date to a post with only a year as its date-criterion. This process may check, for example, bordering posts' metadata, including their approximated date, while also trying to separate posts from each other to give distance of at least a day, month, or more depending on the situation. For other instances of date-criteria with a year, process variations may similarly be carried out, to those as assigned by the representative flow diagram of FIGS. 52a-52b.

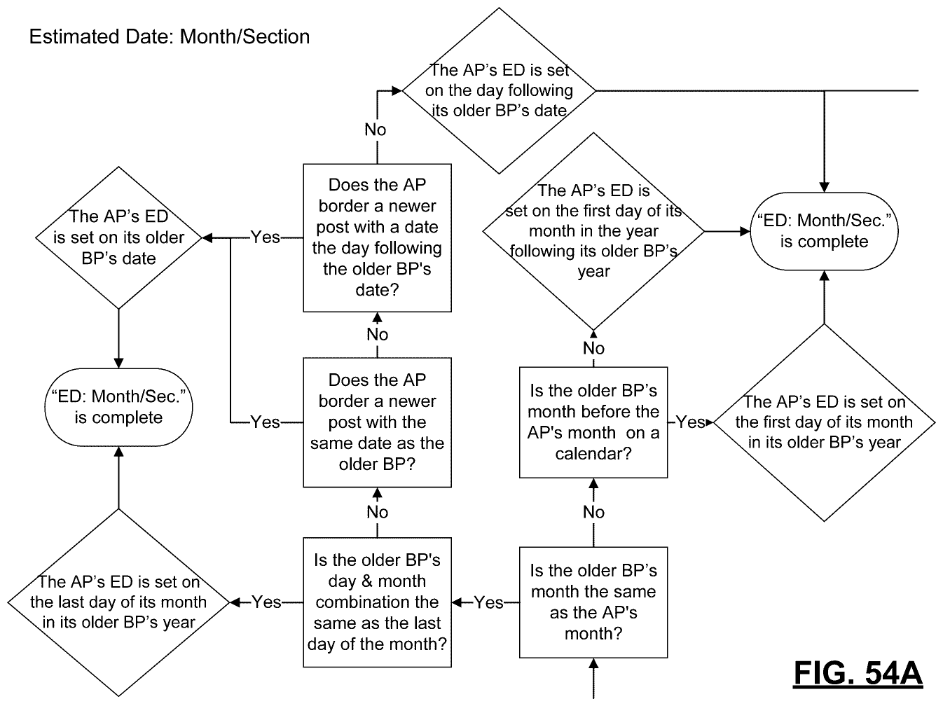

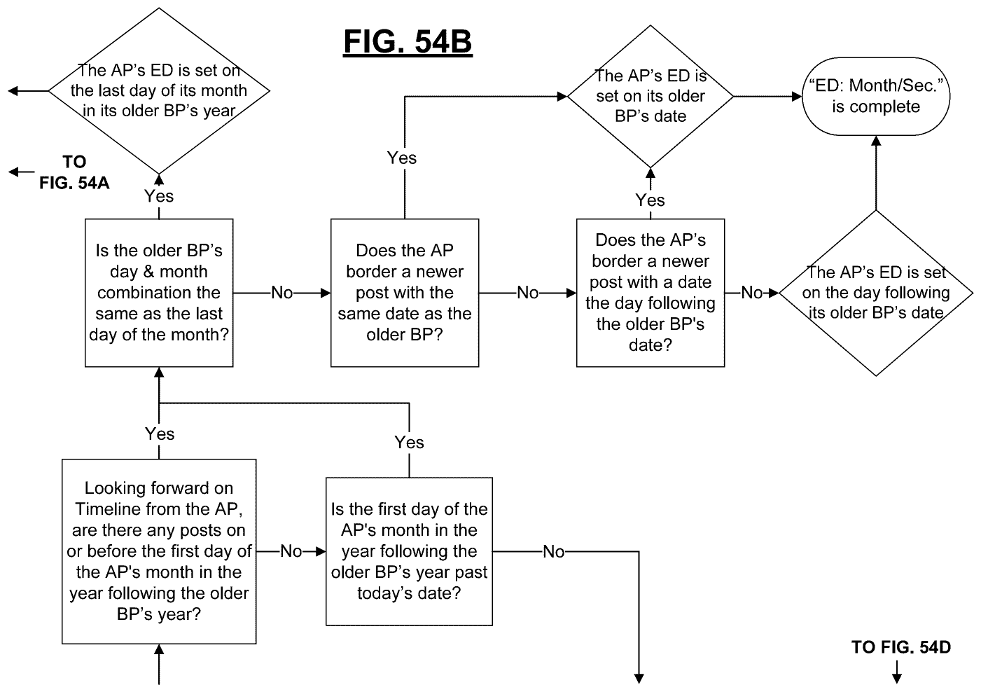

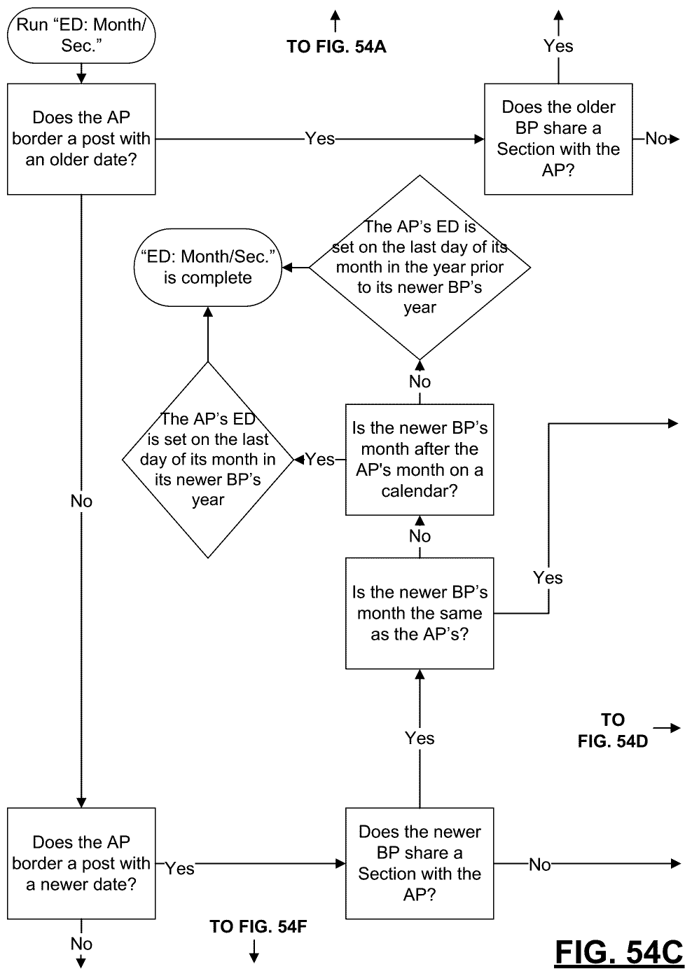

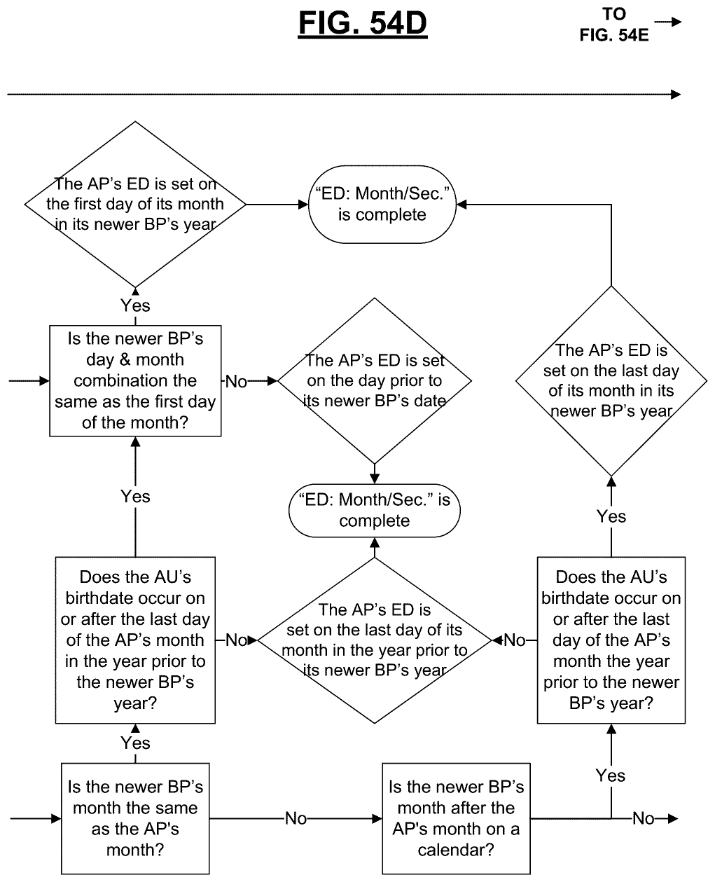

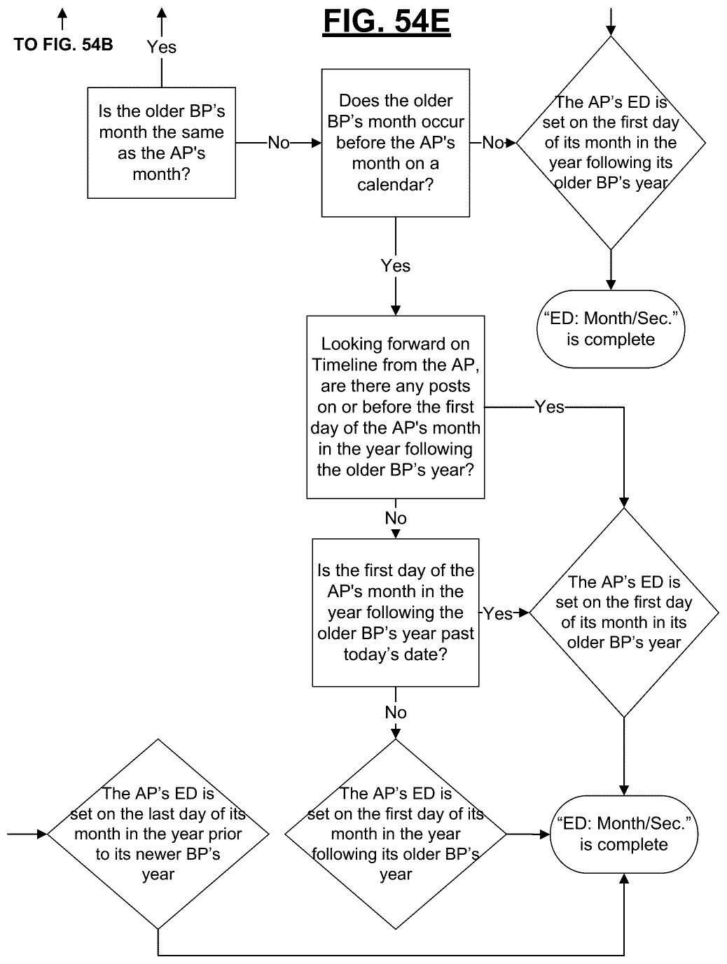

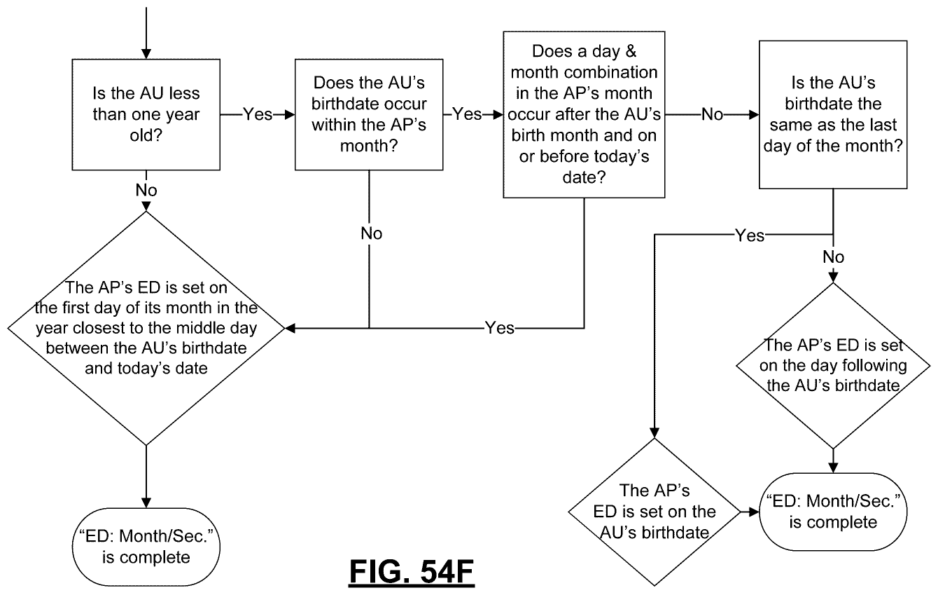

FIGS. 54a-54f) present a sample representative flow diagram variation assigned from the process outlined in FIGS. 52a-52b, where the post has a month and a Section as its date-criteria. This depicted process may, for example, function similarly to the process outlined in FIGS. 53a-53c, though additional distancing steps may be carried out to widen the distance between posts when possible, while also ensuring posts that share Sections are kept close in time.

As an alternate date approximation path after the representative flow diagram of FIGS. 51a-51e, FIG. 55 presents a representative flow diagram for a process that assigns an approximated date on a post with a Date Range as a date-criterion. To have a date assigned, the outlined process in FIG. 55 determines appropriate subprocesses that may be carried out, such as through additional process details of the following figures. The “assignment” process that may be carried out from this representative flow diagram may lead to further assignment processes before leading up to the final process that places the approximated date.

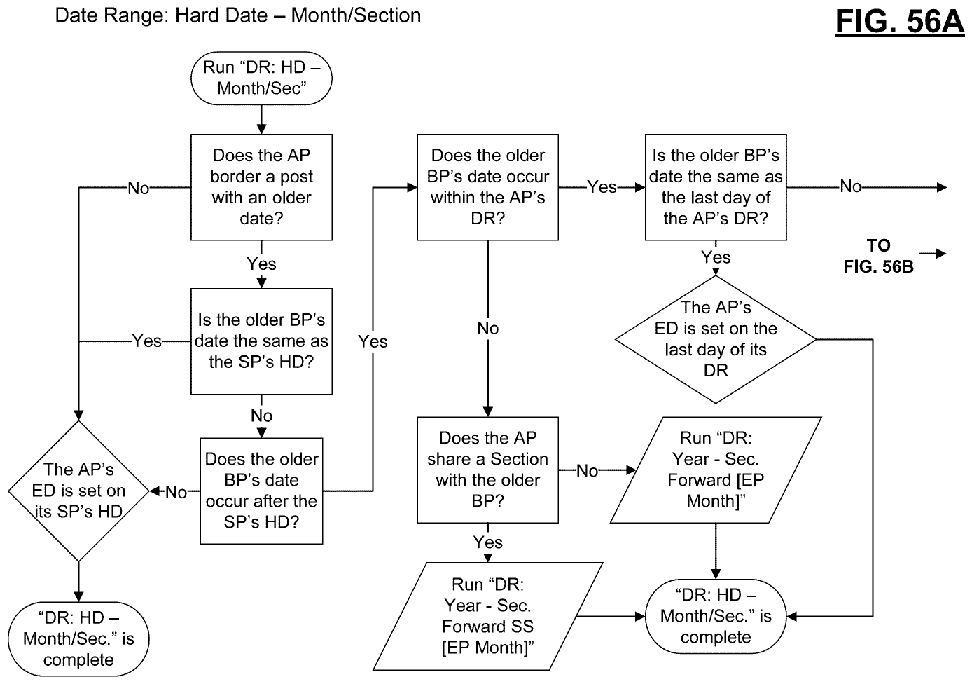

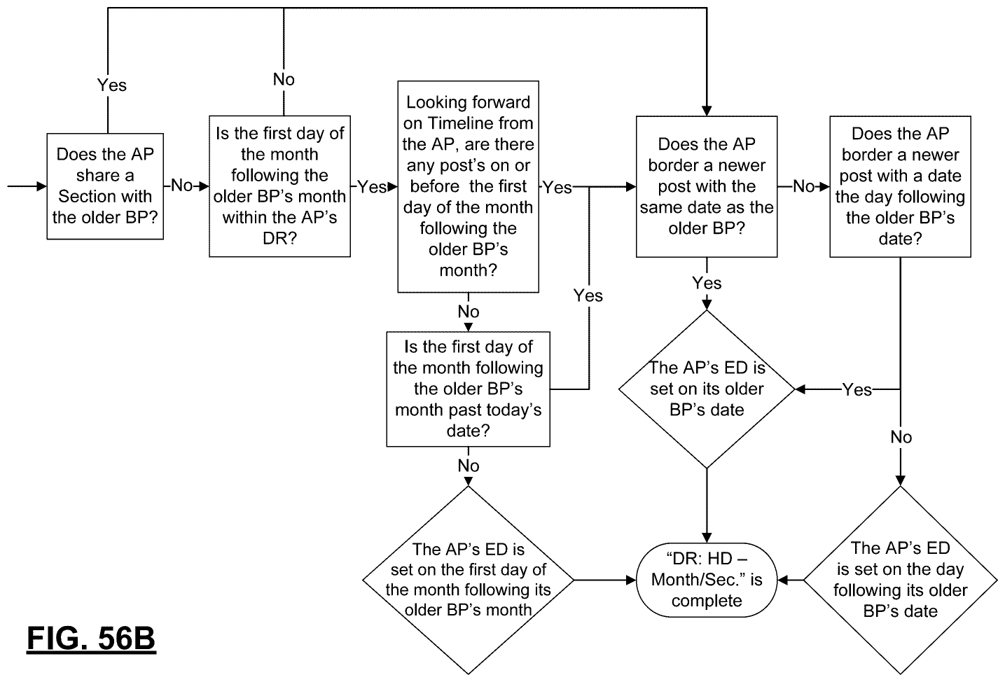

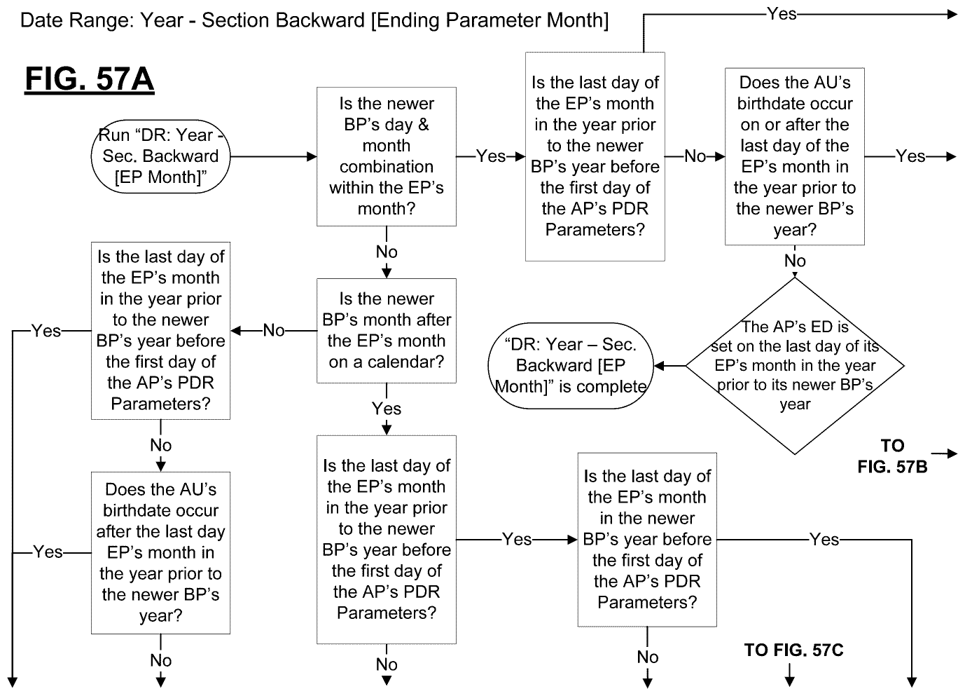

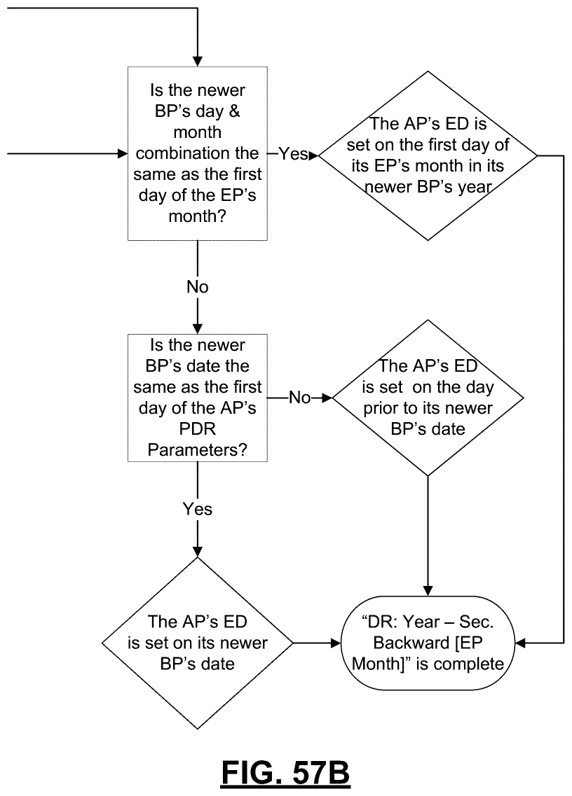

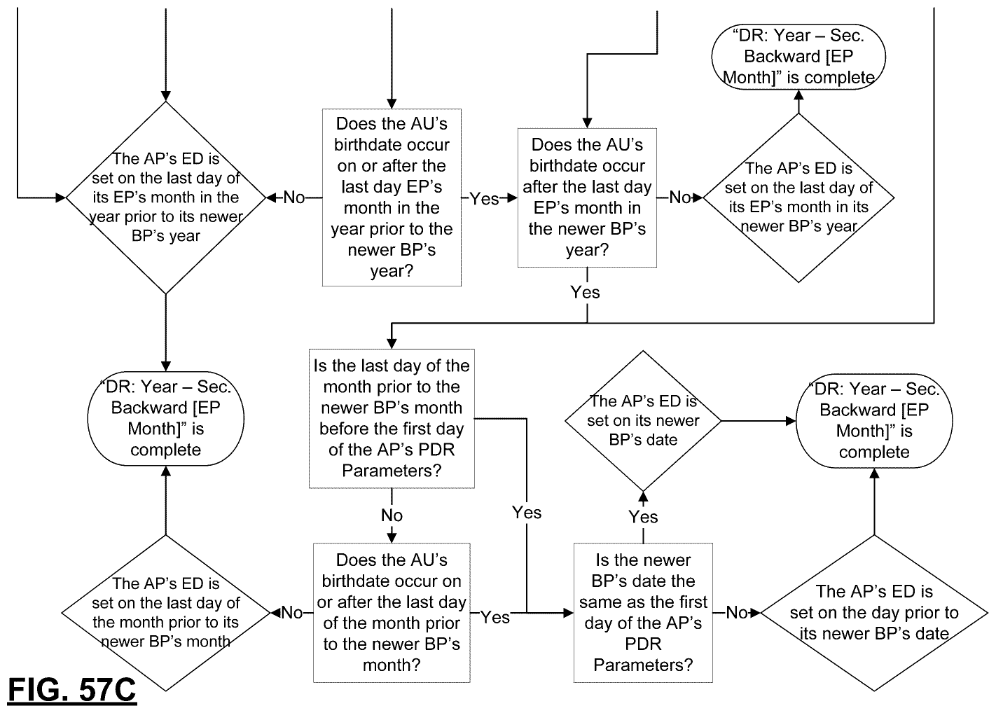

Following the process of FIG. 55, FIGS. 56a-56b present a sample representative flow diagram of a date assignment process for a Date Range post with a date-criterion that is a hard date (day, month, and year) spanning to a month and Section. An approximated date may be assigned through this process, as shown, though subprocesses may be put in place for creating distance between posts. FIGS. 57a-57c present a representative flow diagram continuing from FIGS. 56a-56b, in which distance may be made between post approximated dates, while the current post is moving backwards in its Potential Date Range Parameters. This outlined process may be specific to posts with date-criteria starting with a year and ending with a month and a Section, as there may be many variations to ensure similar outcomes for different types of posts. Also, separate processes may be used when the post obtaining an approximated date shares a Section with a bordering post.

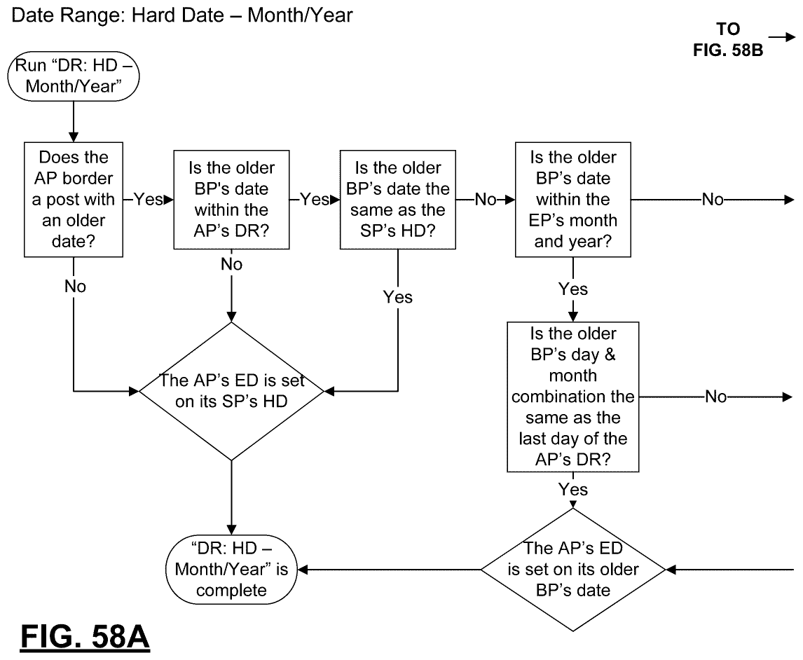

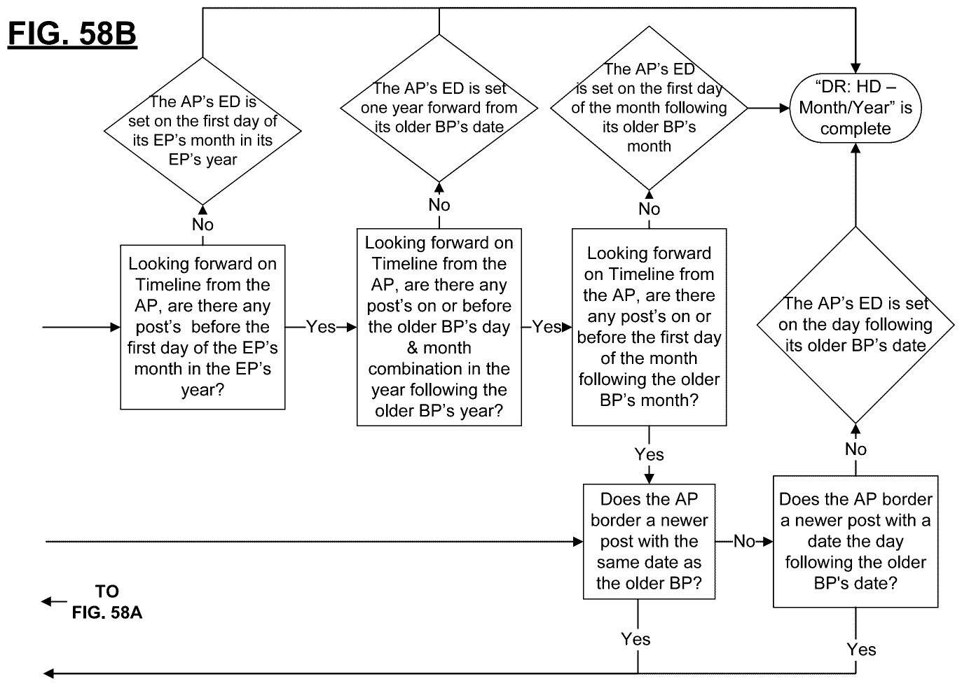

As an alternate representative flow diagram to FIGS. 56a-56b, FIGS. 58a-58b present a representative flow diagram of a Date Range variation for the new post. This presented variation has date-criteria spanning from a hard date to a month and year. A variation of this sort, with no Section in its date-criteria, may be displayed to show a partial scope of the differences between Date Ranges with and without Sections.

Following the placement of an approximated date on a Date Range post of FIG. 55, FIG. 59 depicts a very short process for providing a simple safeguard. The process of FIG. 59 simply replaces the new approximated date with a viable one if for any reason something caused the date to be placed outside of its Potential Dare Range Parameters.

FIG. 60 presents a sample representative flow diagram for a process continuing, for example, after completion of FIGS. 52a-52b or FIG. 55, depending whether the post is a Date Range post or not. This process may provide a safeguard for ensuring that the approximated date for the new post does not fall outside the Timeline parameters or beyond the approximated dates of bordering posts. For example, if the date for the new post were Jul. 7, 1994, this process may ensure a newer post's approximated date does not come before this date, while an older post's does not come after the new post.

Continuing the date approximation process of FIG. 55, FIGS. 61a-61d presents a representative flow diagram focusing on the reorganization of all Timeline posts after a new post is created. This process may space posts apart to make sure clumping of approximated dates does not occur. Considerations may be made to ensure that, if the post's approximated date has defining criteria, such as a day and month it must appear on, it will not be reorganized. Additional considerations may be made to stay in, or out, of optimal Date Range parameters, as well as defined years in Date Range posts.

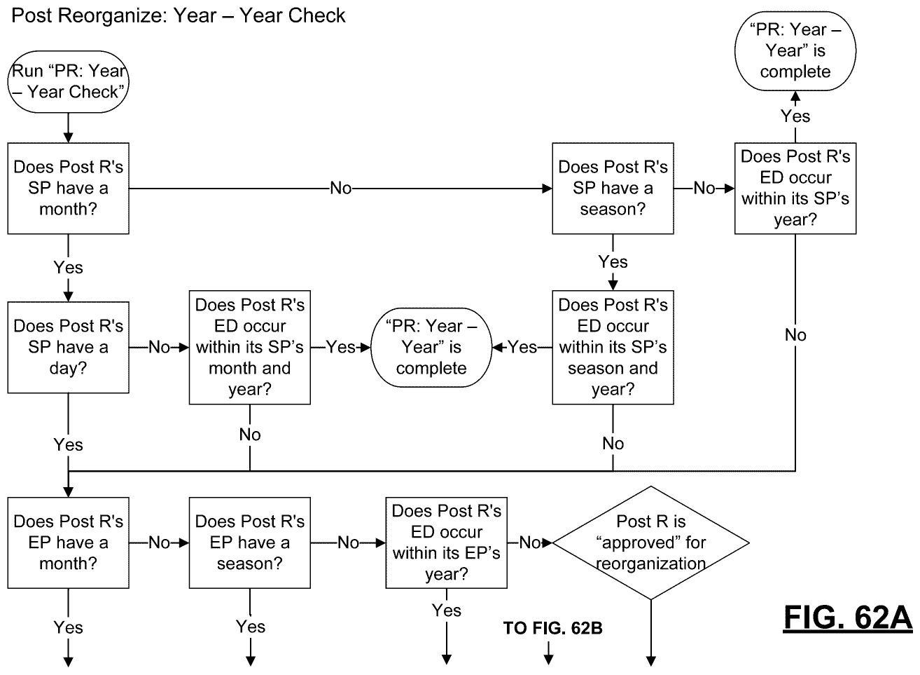

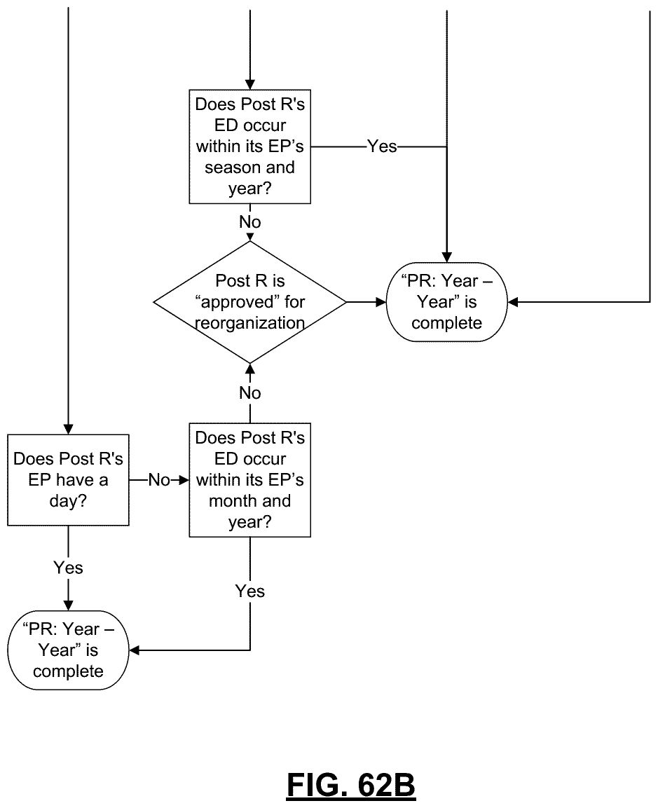

FIGS. 62a-62b present another representative flow diagram outlining a subprocess of the post reorganization process of FIGS. 61a-6d1. The process of FIGS. 62a-62b may help determine if a post may be reorganized based on where its approximated date falls in relation to its Date Range criteria, which in this case includes a year in both the starting and ending parameters.

Additionally, FIGS. 63a-63b present a sample representative flow diagram of a process for continuing from the post reorganization of the previous process. This process (of FIGS. 63a-63b) checks posts through the Timeline to make sure that if a Section is shared between posts, those posts are kept closer together. After this presented “Section checking” process of FIGS. 62a-62b is complete, the estimated date approximation of FIGS. 35a-35b may be completed, finalizing date and location specifics for the new post.

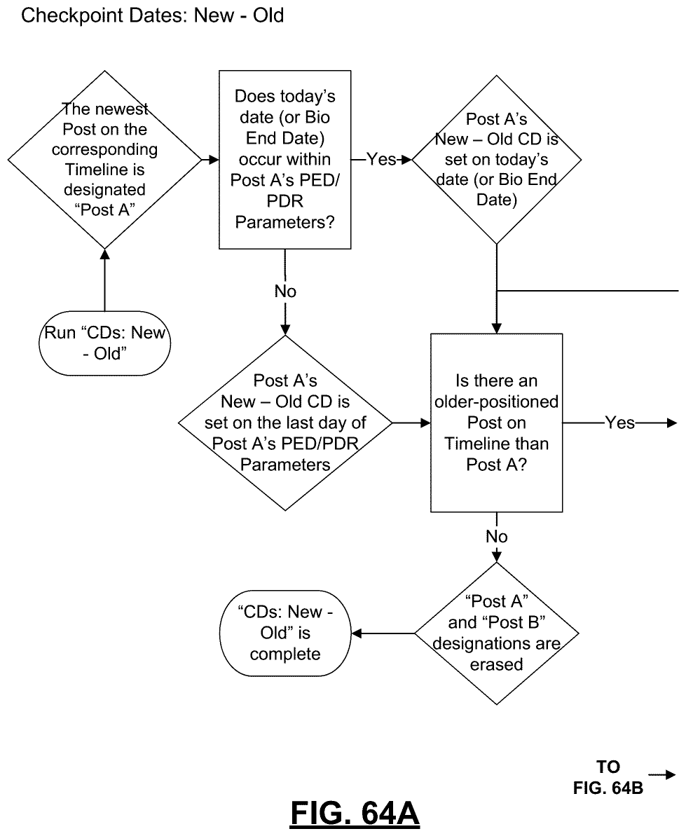

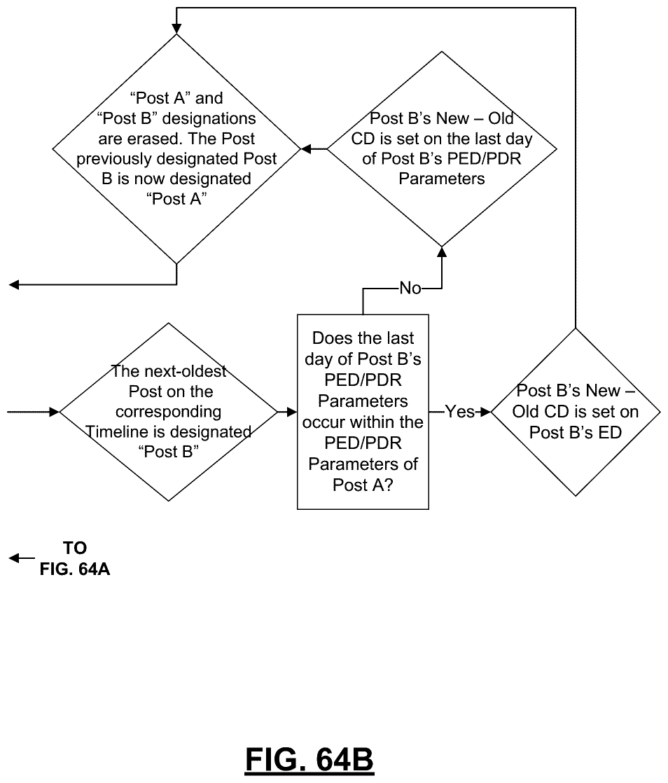

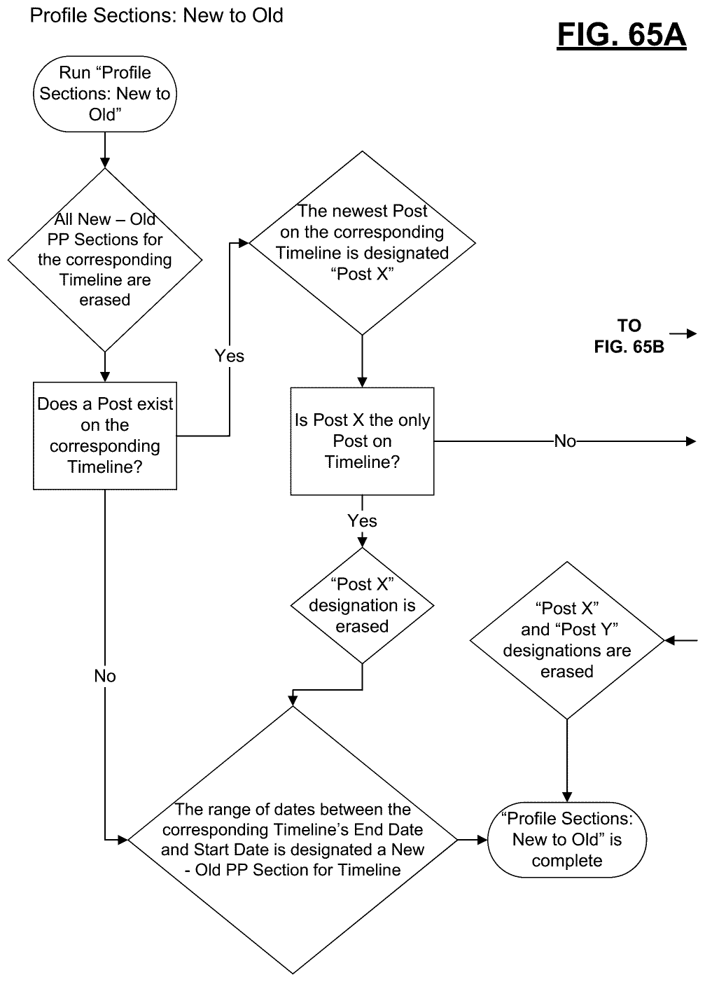

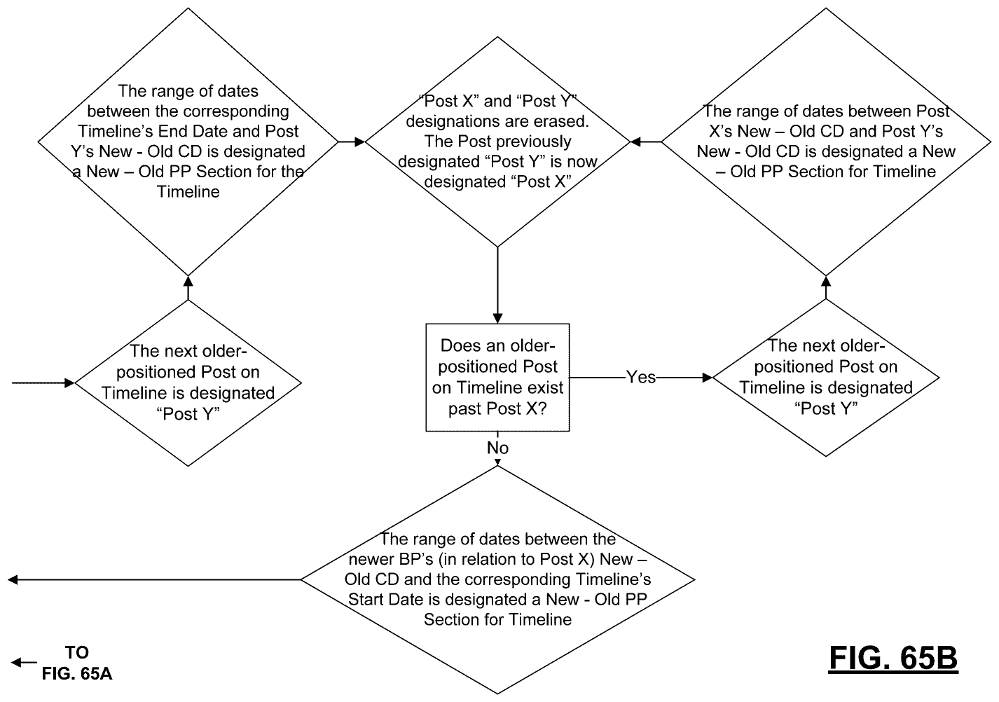

Continuing the post date control processes of FIG. 32, from the completion of the date approximation process of FIGS. 35a-35b ending at FIGS. 63a-63b, FIGS. 64a-64b present a sample representative flow diagram for a process used to facilitate the setting, creation, or updating of a unique date, hereinafter referred to as a “Checkpoint Date,” on each post on the Timeline where the new post was added. Additionally, the Checkpoint Date set on each post for which the process is carried out may be notated to be the “New to Old” variations for each corresponding post. This designation may be made due to the existence of a similar process carried out in succession with the process of FIGS. 64a-64b, with the similar process determining the “Old to New” Checkpoint Date variations for each post on the Timeline. In an example implementation, Checkpoint Dates may be used with Profile information to enhance the navigation of the Timeline, so as to provide the ability to display as much relevant Profile content as possible during interaction. For example, if the newest post on the Timeline is set to 5 years ago, the Checkpoint Date for the post may help set the newest date possible that can be used to build content for Profile Sections, as described in the following process shown in FIGS. 65a-65b.

FIGS. 65a-65b present a sample representative flow diagram used to facilitate the setting of Profile timeframes, referred to herein as “Progressive Profile Sections.” Additionally, per above, the Progressive Profile Section set on the Timeline through this process may be notated to be the “New to Old” variations for each corresponding section.

Continuing from the Checkpoint Date and Progressive Profile Section creation processes above, additional processes may be carried out to affect, update, or change other aspects of the overall system operation. For example, a post may be added to a Bio or Media page, such as to affect its organization, display, or other aspect.

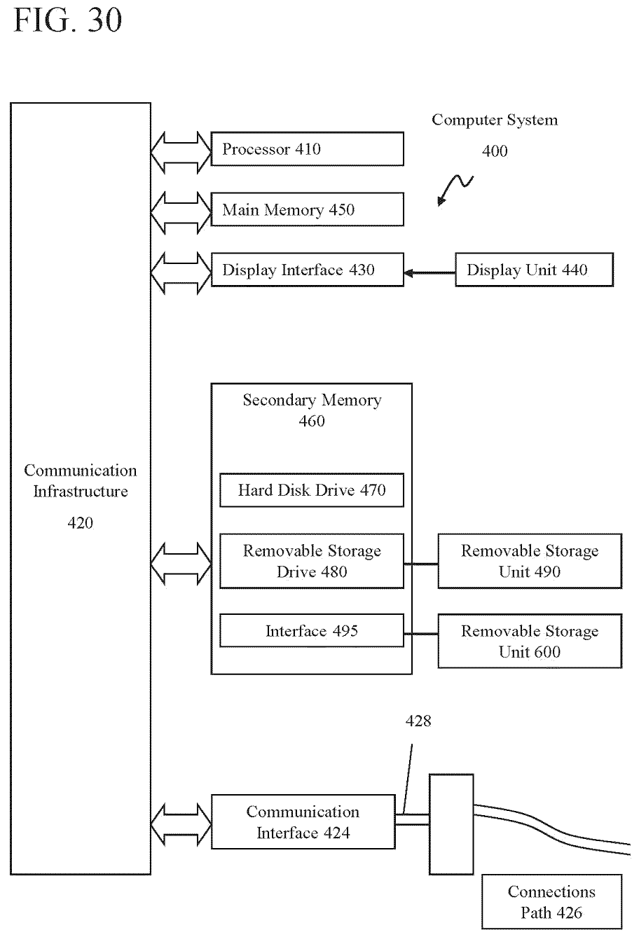

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. Various aspects of an example of such a computer system 400 are shown in FIG. 30.

One or more computer systems may 400 include one or more processors, such as processor 410. The processor 410 and/or other processors may be coupled to a communication infrastructure 420 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 400 may include a display interface 430 that forwards graphics, text, and other data from the communication infrastructure 420 (or from a frame buffer not shown) for display on a display unit 440. Computer system 400 may include a main memory 450, such as random access memory (RAM), and may also include a secondary memory 460. The secondary memory 460 may include, for example, a hard disk drive 470 and/or a removable storage drive 480, representing a floppy disk drive, a magnetic tape drive, an optical disk drive, etc. The removable storage drive 480 may read from and/or write to a removable storage unit 490 in a well-known manner. Removable storage unit 490 represents, for example, a floppy disk, magnetic tape, optical disk, etc., which may be read by and written to removable storage drive 480. As will be appreciated, the removable storage unit 490 may include a computer usable storage medium having stored therein computer software and/or data.

Alternative aspects may include secondary memory 460 and may include other similar devices for allowing computer programs or other instructions to be loaded into computer system 400. Such devices may include, for example, a removable storage unit 600 and an interface 495. Examples of such may include a program cartridge and cartridge interface (such as that found in video game devices), a removable memory chip (such as an erasable programmable read only memory (EPROM), or programmable read only memory (PROM)) and associated socket, and other removable storage units 600 and interfaces 495, which allow software and data to be transferred from the removable storage unit 600 to computer system 400.

Computer system 400 may also include a communications interface 424. Communications interface 424 may allow software and data to be transferred among computer system 400 and external devices. Examples of communications interface 424 may include a modem, a network interface (such as an Ethernet card), a communications port, a Personal Computer Memory Card International Association (PCMCIA) slot and card, wireless fidelity (wifi), cellular telephone, or other wireless interface, etc. Software and data transferred via communications interface 424 may be in the form of signals 428 which may be electronic, electromagnetic, optical, wireless, or other signals capable of being received by communications interface 424. These signals 428 may be provided to communications interface 424 via a communications path (e.g., channel) 426. This path 426 may carry signals 428 and may be implemented using wire or cable, fiber optics, a telephone line, a cellular link, a radio frequency (RF) link, wifi, and/or other communications channels. As used herein, the terms “computer program medium” and “computer usable medium” refer generally to media such as a removable storage drive 480, a hard disk installed in hard disk drive 470, and/or signals 428. These computer program products may provide software to the computer system 400. Aspects of the present disclosure are directed to such computer program products.

Computer programs (also referred to as computer control logic) may be stored in main memory 450 and/or secondary memory 460. Computer programs may also be received via communications interface 424. Such computer programs, when executed, may enable the computer system 400 to perform the features in accordance with various aspects discussed herein. In particular, the computer programs, when executed, may enable the processor 410 to perform the features in accordance with aspects of the present disclosure. Accordingly, such computer programs may represent controllers of the computer system 400.

Where aspects of the present disclosure may be implemented using software, the software may be stored in a computer program product and loaded into computer system 400 using removable storage drive 480, hard drive 470, or communications interface 424. The control logic (software), when executed by the processor 410, may cause the processor 410 to perform the functions described herein. In another aspect of the present disclosure, the system 400 may be implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the present disclosure may be implemented using a combination of both hardware and software.

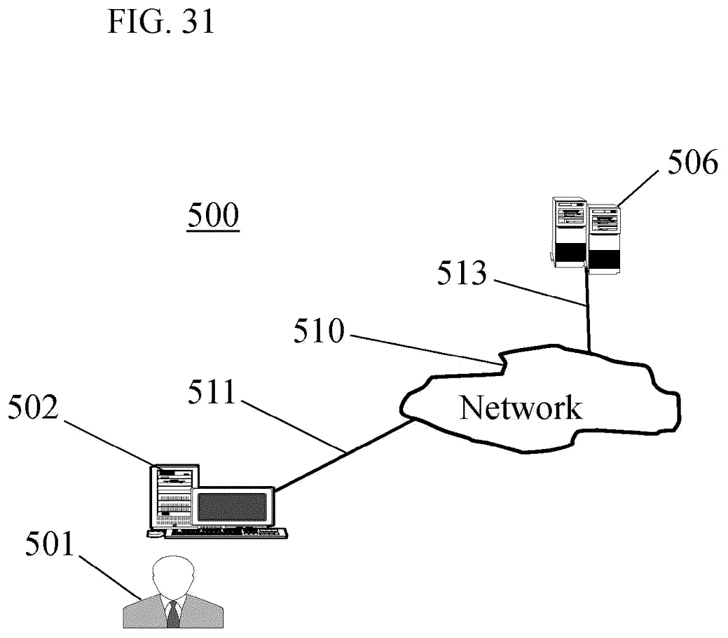

FIG. 31 is a block diagram of various example system components, for use in accordance with aspects of the present disclosure. FIG. 31 shows a communication system 500 usable in accordance with aspects hereof. The communication system 500 shown in FIG. 31 may include one or more accessors 501 (also referred to interchangeably herein as one or more “users”) and one or more terminals 502. In one aspect, data for use in accordance with aspects of the present disclosure may, for example, be input and/or accessed by accessor 501 via an input device (e.g., mouse, keyboard, and/or other selection features) of a terminal 502, such as a personal computer (PC) or computers, command issuing devices including Graphical User Interfaces (GUIs), minicomputers, mainframe computers, microcomputers, telephonic devices, or wireless devices, such as personal digital assistants (PDAs), smart phones, frequency operated button (FOB), and/or other hand-held wireless devices (optionally coupled to or via a server 506, such as one or more PCs, minicomputers, mainframe computers, microcomputers, or other devices having a processor and a repository for data and/or connection to a repository for data) that may, for example house a memory based system in accordance with aspects of the present disclosure. The user 501 may access such system at the server 506, via, for example, one or more networks 510, such as the Internet or an intranet, and couplings 511, 513. The couplings 511, 513 may include, for example, wired, wireless, or fiber optic links. In one example implementation, terminal 502 may be coupled via network 510 via coupling 511 and be therefore able to receive input data from user 501, such that the user 501 may be able to selectively control and/or carry out various operations, in accordance with aspects of the present disclosure.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A method for organizing, storing, or enhancing memories for a user, the method comprising:
providing an option to select among a plurality views or selections of memory-related content, wherein the plurality of views or selections includes a timeline based view and a selection to add new content;
if the user selects the timeline based view, prompting the user to provide date related information;
and identifying any memory-related content associated with the date related information; and
if the user selects the option to add new content, prompting the user to provide the new content and to input descriptive information associated with the new content.

2. The method of claim 1, further comprising:
providing the user with an option to select to view memory-related content.

3. The method of claim 1, wherein the plurality of views include a timeline view or a newsfeed view.

4. The method of claim 1, further comprising:
providing an option to post media content.

5. The method of claim 1, further comprising:
providing an option to search for users.

6. The method of claim 1, further comprising:
receiving or generating a notification directed to the user; and
providing an option to review the notification.

7. The method of claim 1, wherein, if the user selects the timeline based view and the user has selected the option to add new content, prompting the user for date related information relating to the new added content; and graphically positioning the new added content relative to any existing content based on date related information for the added new content and the existing content.
